(19) United States
(12) Patent Application Publication
(10) Pub. No.: US 2026/0212560 A1
(43) Pub. Date: Jul. 23, 2026

(54) METHODS AND SYSTEMS FOR PERFORMING NOVEL-VIEW SYNTHESIS

(71) Applicants: Disney Enterprises, Inc., Burbank, CA (US); ETH Zurich (Eidgendéssische Technische Hochschule Zurich), Zurich (CH)

(72) Inventors: Yang Zhang, Duebendorf (CH); Christopher Richard Schroers, Uster (CH); Xiang Zhang, Zürich (CH); Lukas Francesco Mehl, Zürich (CH); Longxiang Jiao, Zürich (CH)

(73) Assignees: Disney Enterprises, Inc., Burbank, CA (US); ETH Zürich (Eidgenössische Technische Hochschule Zürich), Zürich (CH)

(21) Appl. No.: 19/270,206

(22) Filed: Jul. 15, 2025

Related U.S. Application Data
(60) Provisional application No. 63/748,380, filed on Jan. 22, 2025.

(51) Int. Cl. G06T 11/60; G06N 3/0455; G06N 3/0895; G06T 3/18

(52) U.S. Cl. CPC G06T 11/60; G06N 3/0455; G06N 3/0895; G06T 3/18

(57) ABSTRACT

Methods and systems for performing novel view synthesis in addition to various image-to-image diffusion processes using machine learning models are disclosed. These include methods for performing inpainting-based novel view synthesis using depth maps and conditional models, video novel view synthesis using texture map inpainting, spatially consistent inpainting-based novel view synthesis using video diffusion models, and high-fidelity image-to-image diffusion using a texture conditional model. Further, methods for generating training data that can be used to train machine learning models to perform novel view synthesis are disclosed. These include symmetry exploiting methods of training data generation and methods using training pair alignment and splatting error simulations.

### CROS-REFERENCE TO RELATED APPLICATION

This application claims priority to U.S. Provisional Application No. 63/748,380 filed on Jan. 22, 2025, and entitled “High-Fidelity Novel View Synthesis With Warping-Guided Diffusion”, the contents of which are incorporated herein by reference in their entirety for all purposes.

This application is related to commonly assigned U.S. Application No.______(Attorney Docket No. 090492-P24273US2), filed on______, entitled “Method and System for Generating Training Data for Efficient and Accurate Training of Novel View Synthesis Models”, which is incorporated herein by reference in its entirety.

This application is also related to commonly assigned U.S. Application No. ______(Attorney Docket No. 090492-P24327US1), filed on______, entitled “Visually Consistent Multi-View Novel View Synthesis with Video Diffusion”, which is incorporated herein by reference in its entirety.

### BACKGROUND

The field of novel view synthesis (NVS) generally involves using input data to produce a new view of a scene, e.g., comprising a digital image or video of that scene. As an example, NVS can be used to generate a digital image showing what a scene would look like if an imaginary camera (corresponding to that scene) was moved.

Novel view synthesis can be used in various tasks, including the generation of stereo images and videos. Recent developments in virtual reality (VR) technology, including an increase in commercially available VR headsets, have led to increased interest in stereo images and stereo videos. In a stereo image (or video), two images (or videos) corresponding to slightly different camera angles are displayed to two eyes independently (e.g., from two screens located on the inside of a VR headset). The disparity between the two images or videos corresponds to the apparent displacement of objects in those images or videos when viewed from one eye or the other, which is related to the apparent distance between the objects and the observer. This is similar to the disparity of visual information that people receive when viewing objects with two eyes. As such, viewing images or videos in this manner leads to a “stereoscopic viewing effect,” allowing the brain interpret images or videos as three dimensional (3D). This can be desirable in various applications, including VR games or other media, as it can make the viewer feel like they are “immersed” in a displayed scene.

Unfortunately, many images and videos are not generated in stereo (e.g., are not shot using a two-camera setup). As a result, techniques such as stereo conversion or NVS need to be used to generate stereo image or video pairs from single images or videos. However, there are various problems with such techniques, which can be time-consuming, expensive, and tedious, and result in visual errors that may distract viewers or negatively impact visual effects. For example, disparities between generated stereoscopic images could ruin the stereoscopic viewing effect and the illusion of three-dimensional depth. As another example disparities between sequential frames of video can result in flickering or other visual artifacts, thereby ruining the illusion of motion.

Embodiments address these and other problems, individually and collectively.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

Embodiments of the present disclosure are directed to various methods and systems related to novel view synthesis (NVS). Such methods can be performed by computer systems when applicable. As described above in the Background, NVS generally involves generating visual representations (e.g., images) of scenes and/or objects from a “novel view” based on some input data, e.g., a distinct input view image.

There are various ways that NVS can be performed. Generally however, embodiments of the present disclosure relate to novel view synthesis based on “inpainting” using machine learning models (e.g., diffusion models, convolutional neural networks, etc.). In general terms, inpainting involves using a machine learning model to “fill in” the incomplete parts of an image (usually represented or comprising a “mask”, often represented using black pixels), in order to complete the image. In embodiments, these incomplete parts of the image can correspond to a “disocclusion mask”, which generally indicates parts of a scene that should be visible in a novel view, but which are not visible in an input view. These can comprise parts of a scene that become revealed (or “disoccluded”) as a result of switching from the input view to the novel view. By using machine learning models to predict or estimate the appearance of pixels within such disocclusion masks, a computer system can generate novel view images.

Many NVS methods produce novel view images with errors, which are sometimes referred to as “visual artifacts”. Such visual artifacts generally correspond to regions of generated novel view images that appear implausible to viewers, e.g., unrealistic blurring near the edge of a depicted object, collections of “flying pixels” that do not visually represent objects within novel view images, textures that do not match expected textures or lack fine detail, etc. Embodiments of the present disclosure solve some of the problems with existing NVS methods that cause such visual artifacts. These problems and some solutions provided by embodiments are summarized briefly below.

Some problems with machine learning based NVS methods can be a result of the training data used to train NVS machine learning models. Generally, machine learning models benefit from being trained using higher quality training data as well as more training data. Generally, having access to more training data usually results in higher quality training data, as high quality training data can be selected from a larger set of available options. Conversely, NVS machine learning models generally perform worse when trained using less training data and lower quality training data.

NVS machine learning models are typically trained using multi-view datasets, e.g., datasets in which objects are photographed or rendered from multiple viewpoints, as such datasets allow machine learning models to be trained to generate images corresponding to one provided viewpoint (e.g., representing the novel view) given an input image corresponding to another provided viewpoint. NVS model performance can be evaluated by comparing generated images to “ground truth” images from the multi-view dataset. Unfortunately, multi-view datasets are comparatively rare and can be costly to produce. Consequently, there is generally less training data available for NVS machine learning applications, and as a result there is less available high quality training data.

Some embodiments address this problem by providing methods to generate training data (e.g., comprising pairs of images) from single-view datasets. Such methods effectively enable NVS machine learning models to be trained using nearly any single-view dataset, rather than special purpose multi-view datasets. Single-view datasets are significantly more common than multi-view datasets, and there are large numbers of high-quality images that are readily available for training (e.g., from the Internet). As a result, such methods make the process of training NVS machine learning models more efficient and improve the performance of trained NVS machine learning models, resulting in more plausible novel view images.

In more detail, one embodiment is directed to a method for training a machine learning model to generate novel view images corresponding to warped images using a single-view dataset. The method can be performed by a computer system. The computer system can retrieve the single-view dataset, which can comprise a plurality of images. For each image, the computer system can perform depth estimation to generate a depth map corresponding to the image. For each image, the computer system can generate an occlusion mask based on a warping process and the depth map. For each image, the computer system can generate an occlusion mask based on a warping process and the depth map. For each image, the computer system can generate a masked image by masking the image with the occlusion mask. For each image, the computer system can generate a training set of images comprising the image and the masked image, thereby generating a training set of images for each image in the single-view dataset, thereby generating a plurality of training sets of images. The computer system can train the machine learning model using the plurality of training sets of images.

Even when multi-view datasets are available, conventional methods of preparing training data to train NVS machine learning models can result in poor model performance. In general terms, NVS can be performed (in part) using techniques such as “warping”, etc., which can involve, e.g., predicting the appearance of objects in a novel view image based on physical consideration, e.g., the parallax of objects resulting from the movement of an observation viewpoint. However, such techniques can rarely be used to generate a complete novel view image, as some parts of the scene may be visible in the novel view image but not in the input view image, and thus their appearance cannot be determined based on the input view image alone. As such, machine learning models can be used to predict or estimate the appearance of incomplete portions of warped or splatted images to complete the process of novel view synthesis.

For this reason, training data pairs in NVS machine learning model training can involve pairs of “masked” images and ground truth images. An NVS model can be trained to generate novel view images based on the masked input images (i.e., by “inpainting” the masked input images). These inpainted images can then be compared against the ground-truth images in order to train the model. As such, NVS machine learning model training can involve generating such image pairs, e.g., generating masked images corresponding to ground-truth images.

In general, some existing methods of generating training data can lead to “misaligned” pairs of training data images. While such training data images purportedly show the same view (one being a masked image depicting that view and the other being a ground truth image depicting that view), they are often different due to various errors in training data generation, e.g., splatting errors, different lighting conditions, image rendering errors, etc. During training, an NVS machine learning model may learn to inadvertently reproduce these errors due to the misalignment. As a result, novel view images generated using such machine learning models may have visual artifacts.

Some embodiments address this problem by providing methods for generating aligned pairs of training data images. In general terms, the optical flow between the input view images and target view images can be used to mask target view images. The target view image and the masked target view image can be used as a training data pair, reducing image discrepancies. Additionally, embodiments provide for methods of “splatting error simulation”, which can reduce the effect of splatting errors introduced during training data generation. These methods, alone or in combination, result in better performance by NVS machine learning models trained using training data generated via these methods.

In more detail, one embodiment is directed to a method for training a machine learning model to generate novel view images corresponding to warped images. This method can be performed by a computer system. The computer system can retrieve a plurality of sets of images. For each set of images, the computer system can determine an input view image and a target view image from the set of images. For each set of images, the computer system can determine an optical flow map by performing an optical flow estimation process between the input view image and the target view image. For each set of images, the computer system can determine a warping mask based on the optical flow map. For each set of images, the computer system can mask the target view image using the warping mask, thereby generating a masked target view image. For each set of images, the computer system can generate a training set of images comprising the target view image and the masked target view image, thereby generating a training set of images for each set of images, thereby generating a plurality of training sets of images. The computer system can train the machine learning model using the plurality of training sets of images.

In addition to providing methods for generating training data used to train NVS machine learning models, the present disclosure also provides machine learning model architectures and methods for generating novel view images (and novel view videos) using machine learning. For example, some embodiments of the present disclosure are directed to methods for performing novel view synthesis using a decomposed dual-branch diffusion model. The decomposed dual-branch diffusion model can comprise a pre-trained diffusion model and a conditional model configured in parallel with the pre-trained diffusion model. Such models can perform poorly for NVS inpainting due to the characteristics of disocclusion masks, which are usually shaped much differently than masks found in other inpainting tasks. Embodiments address this problem by using convolutional encoders and incorporating embeddings corresponding to disocclusion masks and depth maps. Methods and machine learning models according to embodiments result in more plausible novel view images, particularly by reducing visual artifacts near the edges of foreground objects.

In more detail, one embodiment is directed to a method for generating a novel view image corresponding to an input view image using a machine learning model comprising a pre-trained diffusion model comprising one or more diffusion model layers including an input diffusion model layer, and a conditional model comprising one or more conditional model layers. The method can be performed by a computer system. The computer system can generate a depth map based on the input view image. The computer system can warp the input view image based on the depth map, thereby generating a warped image and a disocclusion mask. The computer system can warp the input view image based on the depth map, thereby generating a warped image and a disocclusion mask. The computer system can mask the warped image using the disocclusion mask, thereby generating a warped and masked image. The computer system can generate a noisy embedding. The computer system can encode the warped and masked image, thereby generating a warped and masked embedding. The computer system can encode the depth map, thereby generating a depth map embedding. The computer system can encode the disocclusion mask, thereby generating a disocclusion mask embedding. The computer system can combine the noisy embedding, the warped and masked embedding, the depth map embedding, and the disocclusion mask embedding, thereby generating a combined embedding. The computer system can apply the combined embedding to the conditional model, thereby generating one or more conditional model layer outputs corresponding to the one or more conditional model layers. The computer system can apply the noisy embedding to the input diffusion model layer and the one or more conditional model layer outputs to the one or more diffusion model layers, thereby generating an output embedding. The computer system can decode the output embedding, thereby generating the novel view image.

As another example, some embodiments of the present disclosure are directed to methods for performing NVS using video diffusion models. Video diffusion models are typically used to generate videos and are generally configured to achieve frame-wise consistency between sequential frames of generated videos, thereby avoiding flickering or other video artifacts. Some methods according to embodiments however use video diffusion models to achieve spatial consistency (rather than temporal consistency) between multiple generated novel view images. This can be useful in stereoscopic applications (e.g., 3D movies, VR, etc.) as cross-image consistency is important for achieving stereoscopic illusions of depth.

In more detail, one embodiment is directed to a method for generating a plurality of novel view images corresponding to an input image using a video diffusion model. The method can be performed by a computer system. The computer system can generate a depth map based on the input view image. The computer system can warp the input view image using the depth map, thereby generating a plurality of warped images. The computer system can encode the plurality of warped images, thereby generating a plurality of warped image embeddings. The computer system can generate one or more noisy embeddings. The computer system can apply the plurality of warped images embeddings and the one or more noisy embeddings to the video diffusion model, thereby generating a plurality of output embeddings. The computer system can decode the plurality of output embeddings, thereby generating the plurality of novel view images.

Further, some embodiments of the present disclosure are directed to methods for performing video NVS. Because a video generally comprises a sequence of still images, NVS for video can generally be accomplished by performing NVS for each still image frame. However, this can lead to visual artifacts such as flickering due to temporal inconsistency between sequential frames. Embodiments address this by performing video NVS using a specialized mapping machine learning model.

In general terms, a computer system according to embodiments can map elements (e.g., pixels) in a video to a mapping, which can comprise a foreground mapping and a background mapping. The computer system can identify pixels in each frame that should be inpainted during NVS and can likewise map these pixels to the mapping(s) (more typically the background mapping). The computer system can then inpaint the mappings rather than (or in addition to) the individual video frames. The computer system can then generate the novel view video based on the inpainted mappings. By inpainting the mapping(s) (which are representative of the video as a whole) rather than (or in addition to) the individual video frames, the computer system achieves greater temporal consistency between novel view image frames, eliminating visual artifacts such as flickering and thereby generating more plausible novel view videos.

In more detail, one embodiment is directed to a method for generating a novel view video corresponding to an input view video comprising a plurality of image frames using a mapping machine learning model and an inpainting machine learning model. The method can be performed by a computer system. The computer system can warp each image frame of the plurality of image frames. In this way the computer system can generate a plurality of warped image frames and a plurality of disocclusion masks corresponding to the plurality of warped image frames. The computer system can train the mapping machine learning model to map pixels from the plurality of warped image frames to a texture map using the plurality of warped image frames. In this way, the computer system can generate a texture map. The computer system can generate a cumulative disocclusion mask using the plurality of disocclusion masks and the mapping machine learning model. The computer system can combine the cumulative disocclusion mask and the texture map, thereby generating a masked texture map. The computer system can generate an unmasked texture map by inpainting the masked texture map using the inpainting machine learning model. The computer system can generate the novel view video based on the unmasked texture map.

Additionally, some embodiments are directed to methods for achieving texture consistency in image-to-image diffusion (e.g., in NVS applications) with a novel “texture conditional model”. Image-to-image diffusion models often produce images that appear too smooth or glossy due to the loss of high frequency information (e.g., fine texture detail) or the presence of “hallucinated” textures. Some embodiments of the present disclosure address this problem using a texture conditional model, which can preserve fine-detail texture information from input images and inject this information into output images (e.g., novel view images) generated using a diffusion model (or another type of model). In this way, methods according to embodiments can be used to produce higher quality and more plausible novel view images and eliminate visual artifacts corresponding to hallucinated or degraded texture.

In more detail, one embodiment is directed to a method for generating one or more output images based on one or more input images using a machine learning model comprising an encoder, a diffusion model, a decoder, and a texture conditional model. The encoder can comprise one or more encoder layers and the decoder can comprise one or more decoder layers. The method can be performed by a computer system. The computer system can encode the one or more input images, thereby generating one or more input image embeddings and one or more sets of encoder features. Each set of encoder features can correspond to an input image of the one or more input images, each set of encoder features can comprise one or more encoder features corresponding to the one or more encoder layers. The computer system can generate one or more noisy embeddings. The computer system can combine each set of encoder features and a corresponding set of decoder features using the texture conditional model, thereby generating one or more sets of fused features. The computer system can apply the one or more sets of fused features to the one or more decoder layers, thereby generating one or more output images.

In addition to the methods described above (and other methods), some embodiments are directed to computer systems or other devices that can be configured to perform the methods described above or other methods. For example, one embodiment is directed to a computer system comprising one or more processors and a non-transitory computer readable medium coupled to the one or more processors. The non-transitory computer readable medium can comprise instructions that, when executed by the one or more processors, cause the one or more processors to perform the methods described above (or other methods described in the detailed description below).

### Terms

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects can facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

A “data set” may include any set of one or more “observations” or “data values.” A “data value” can include any data element. A “data element” can refer to a set of data that can be grouped into a single unit, enabling comparison between that data element and other data elements. For example, a data element can comprise a single numerical value (e.g., the speed of a vehicle in miles per hour) or could comprise multiple numerical values (e.g., 60 speed recordings of a vehicle corresponding to each minute of an hour-long period). Data elements comprising multiple data values can be organized into various forms or structures, including data vectors, data tables, and “data sequences” comprising e.g., ordered lists of data elements. A data element may comprise the input to a machine learning model, and individual data values within that data element may comprise features. A data value can comprise a “data vector,” one or more values (represented in vector form) corresponding to a data element or observation.

“Sampling” may include any process or method used to collect data values. Sampling can be used to collect data values from an existing data set. The act of sampling may result in a “sample,” one or more data values collected from the data set during sampling. Data sets can be sampled via a variety of means. For example, “random sampling” involves sampling data values from a data set randomly. A “window” or “window of data” may include any number of contiguous data elements from a data set. A “window” may be defined by a starting data value and an ending data value, such that the window contains all data values between the starting data value and ending data value (and optionally the starting data value and ending data values themselves). “Window sampling” can be used to sample data values contained within a window of data. A “stride” may refer to the rate at which a window “moves” across a sequence of data during e.g., “rolling window sampling” of that sequence of data. For example, with a stride of one, a window may move one data element “forward” in a sequence of data during each sampling operation, while with a stride of three, a window may move three data elements “forward” in a sequence of data during each sampling operation.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model (or “prediction model”) formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” (ML model) can refer to a software module configured to be run on one or more processors to provide a classification or numerical value of a property of one or more samples, or to generate something (e.g., an image) based on those one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model. Examples of unsupervised learning models include hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

The process of “training” a machine learning model may include any steps used to prepare a machine learning model to perform some task. Often training involves determining or optimizing a set of “parameters” (which characterize the machine learning model) that result in acceptable model performance. Training can be performed in a series of “training rounds” during which training data is used to update the parameters of the machine learning model, for example, based on a loss value.

A “loss value” or “error value” may include any value that indicates the deviation between a result of some process, method, or function and an expected, desired, or correct result. For example, if a machine learning model can detect anomalies in a data set comprising 100 data values, 17 of which are anomalous, if the machine learning model only detects 15 of the 17 anomalous data values, the loss value could comprise, e.g., 2 (17-15). Loss values can be used to train and evaluate the training of machine learning models, e.g., by optimizing machine learning model parameters by minimizing the loss value, using processes such as stochastic gradient descent or backpropagation.

A “hyperparameter” can include any value used to configure a machine learning model that is external to the machine learning model. Typically, a hyperparameter is set, and is not estimated or determined from the training data that is used to train the machine learning model.

A machine learning model may comprise multiple “sub-models”, “layers,” or “modules”, which may refer to parts of a larger machine learning system. For example, a machine learning model could comprise a long short-term memory layer (which itself can comprise multiple layers), in addition to an attention layer and a linear layer. Layers can sometimes be organized in series, such that the input to a machine learning system is processed by a first set of layers, which produces an output that is then processed by a subsequent set of layers, and so forth until the output of the machine learning model is produced by the final layer in the series.

An “embedding” can refer to a representation of data, usually within an “embedding space”, a theoretical space in which embeddings can be compared via vector operations. For example, an embedding can comprise a vector representation of an image, which can be used to evaluate the similarity of that image to other images, or e.g., determine whether that image contains or depicts a particular subject (e.g., a cat). Embeddings can be used within the field of machine learning, thereby enabling machine learning models to perform certain tasks, particularly tasks that are difficult or subjective. In some cases, an embedding can comprise a lower-dimensional representation of a corresponding element of data, enabling more efficient processing due to the reduced logical size of the embedding relative to the logical size of the original element of data.

An “encoder” can refer to something (e.g., a physical device, software element, component of a machine learning model, etc.) that produces output data representative of some input, usually in the form of a “code” or signal. An encoder can be used to convert data from one format to another, which may facilitate data processing. For example, a nominal data encoder can be used to convert nominal data (such as the name of a city) into a numeric code, facilitating such data to be processed using numerical methods. As another example, a physical rotary encoder can be used to convert the motion or position of a shaft or axle into electrical signals, facilitating computer-based odometry. A code (or other output of an encoder) can be used as an embedding. Some encoders can be implemented via applications of machine learning, e.g., via a “transformer” machine learning model or via another model that uses the principle of machine learning “attention.” A “decoder” can refer to something that “decodes”, e.g., reverses an encoding operation, e.g., produces some data based on an encoding or embedding representative of such data.

### BRIEF DESCRIPTION OF THE DRAWINGS

FIG. 1 shows a flowchart of a general framework for performing novel view synthesis using warping and machine learning inpainting according to some embodiments.

FIG. 2 shows an image and a corresponding warped image with a disocclusion mask.

FIG. 3 shows novel view images generated using various novel view synthesis methods, including methods according to embodiments, and further shows some summary performance statistics of such methods.

FIG. 4 shows a block diagram of a client-server system according to some embodiments.

FIG. 5 shows a flowchart of a method for generating training data from single-view datasets. Such training data can be used to train machine learning models to perform novel view synthesis.

FIG. 6 shows an exemplary image and a visualization of a corresponding depth map.

FIG. 7 shows an exemplary image, a corresponding random mask, and a randomly masked image.

FIG. 8 shows an exemplary image, a corresponding occlusion mask, and a corresponding masked image.

FIG. 9 shows a “forward” warping process applied to an input view image and a corresponding occlusion mask.

FIG. 10 shows a “reverse” warping process applied to an input view image and a corresponding disocclusion mask.

FIG. 11 shows the effect of different amount of random masking on novel view images generated using methods according to embodiments.

FIG. 12 shows a general method for generating training data pairs that can be used to train a machine learning model to perform inpainting as part of novel view synthesis.

FIG. 13 shows a warped image and novel view images generated using various methods (including methods according to embodiments) and corresponding unknown region maps and difference maps.

FIG. 14 compares the effects on novel view image generation of training machine learning models using aligned training data and training data generated using splatting error simulation.

FIG. 15 shows a flowchart of a method for generating aligned training sets of images and training sets of images with splatting error simulation according to some embodiments.

FIG. 16 shows a method for generating aligned training data pairs that can be used to train a machine learning model to perform inpainting as part of novel view synthesis.

FIG. 17 shows a method for generating aligned training data pairs with splatting error simulation that can be used to train a machine learning model to perform inpainting as part of novel view synthesis.

FIG. 18 shows a flowchart of a method for performing novel view synthesis using a video diffusion model according to embodiments.

FIG. 19 shows a block diagram of a system that can be used to perform novel view synthesis using a video diffusion model according to embodiments.

FIG. 20 shows a block diagram of a machine learning model comprising a texture conditional model according to some embodiments.

FIG. 21 shows a flowchart of a method for performing image-to-image diffusion using a texture conditional model according to some embodiments.

FIG. 22 shows an example of a degraded view that can be used to train a texture conditional model according to some embodiments.

FIG. 23 shows a flowchart of a method for training a texture conditional model using view degradation methods according to some embodiments.

FIG. 24 shows a block diagram corresponding to a method for training a texture conditional model using view degradation according to some embodiments.

FIG. 25 shows a novel view image generated using a convolutional neural network.

FIG. 26 shows a novel view image generated using a BrushNet model.

FIG. 27 shows a novel view image generated using a dual-branch diffusion model according to some embodiments.

FIG. 28 compares inpainting performance for various machine learning models (including machine learning models according to embodiments) on various warped and masked images.

FIG. 29 shows a flowchart of a method for generating a novel view image using a machine learning model comprising a conditional model and a pre-trained diffusion model according to some embodiments.

FIG. 30 shows a block diagram of a machine learning model comprising a conditional model and a pre-trained diffusion model according to some embodiments.

FIG. 31 compares novel view video frames generated using various methods including methods according to embodiments.

FIG. 32 shows a background texture map and a foreground texture map generated from a sequence of video frames.

FIG. 33 shows a flowchart of a method for generating novel view videos according to some embodiments.

FIG. 34 shows a mapping network that can be used to generate novel view video using methods according to some embodiments.

FIG. 35 shows a novel view video frame generated using a mapping machine learning model trained using a foreground reinforcement loss function according to some embodiments.

FIG. 36 shows a masked texture map and an unmasked texture map generated by inpainting the masked texture map.

FIG. 37 shows a table comparing the performance of some novel view synthesis methods according to embodiments on the RealEstate10K dataset and the DL3DV-10K dataset.

FIG. 38 compares novel view images generated using ViewCrafter, Flash3D, and methods according to embodiments.

FIG. 39 compares novel view images generated ViewCrafter, DepthSplat, and methods according to embodiments.

FIG. 40 shows a table summarizing the effects of training using training pair alignment (TPA) and splatting error simulation (SES) training data generation methods according to embodiments, as well as the effect of using a texture conditional model (TB) and texture degradation training (TD) on various novel view synthesis performance metrics.

FIG. 41 shows visual results summarizing the effects of training pair alignment, splatting error simulation, the use of a texture conditional model, and the use of texture degradation training.

FIG. 42 shows a table summarizing in-domain and cross-domain NVS performance for various novel view synthesis methods, including methods according to embodiments.

FIG. 43 compares novel view images generated using DepthSplat and methods according to embodiments.

FIG. 44 compares additional novel view images generated using DepthSplat and methods according to embodiments.

FIG. 45 compares right-view novel view images generated based on left-view images using ViewCrafter, StereoCrafter, and methods according to embodiments.

FIG. 46 shows a table comparing the performance of ViewCrafter, StereoCrafter, and methods according to embodiments on a novel view synthesis task on the Spring dataset.

FIG. 47 compares additional right-view novel view images generated based on left-view images using ViewCrafter, StereoCrafter, and methods according to embodiments.

FIG. 48 compares even more right-view novel view images generated based on left-view images using ViewCrafter, StereoCrafter, and methods according to embodiments.

FIG. 49 compares fine detail on splattered view images, ViewCrafter generated novel view images, and novel view images generated using methods according to embodiments.

FIG. 50 compares fine detail on additional splattered view images, ViewCrafter generated novel view images, and novel view images generated using methods according to embodiments.

FIG. 51 compares fine detail on even more splattered view images, ViewCrafter generated novel view images, and novel view images generated using methods according to embodiments.

FIG. 52 shows a block diagram of system 5200 for creating computer graphics imagery (CGI) and computer-aided animation that may implement or incorporate various embodiments.

FIG. 53 shows a block diagram of a computer system 5300.

### DETAILED DESCRIPTION

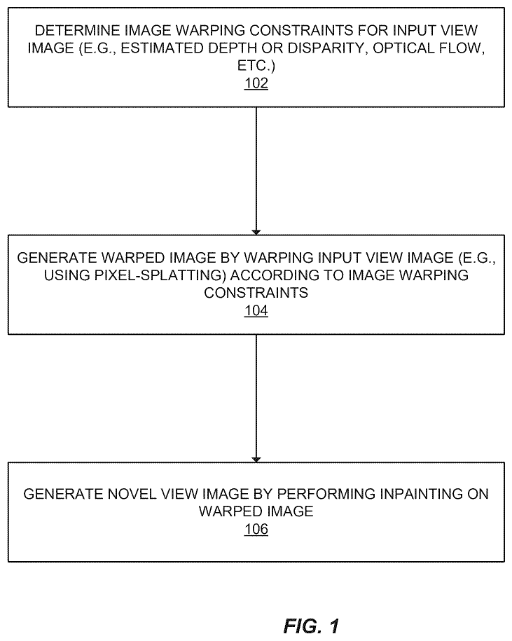

Many embodiments of the present disclosure relate to NVS methods based on inpainting warped images using machine learning models (e.g., diffusion models). As such, understanding a general summary framework for some NVS methods according to be embodiments may be helpful in understanding more detailed descriptions of embodiments presented further below. Such a framework is presented in the flowchart of FIG. 1.

In general, a computer system can warp an input view image (step 104), then inpaint the warped image to generate a novel view image (step 106). However, to do so, the computer system may need to determine “warping constraints” which can define how the input view image will be warped on the warping operation. Such warping constraints can be based on e.g., estimated depth maps or disparity map, optical flow maps, etc. Thus, at step 102, the computer system can determine these image warping constraints, e.g., by performing monocular depth estimation.

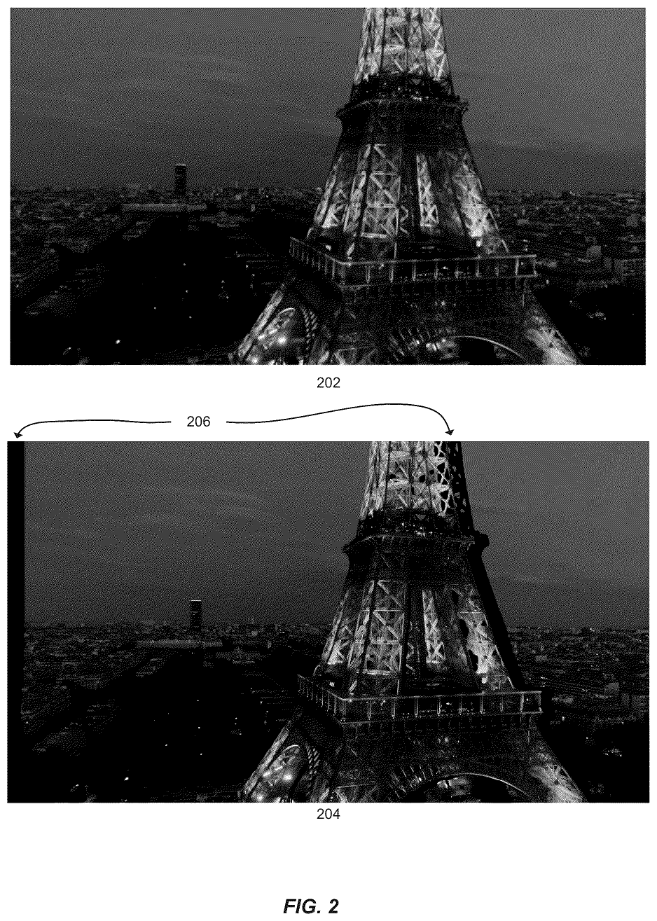

At step 104, a computer system can “warp” the input view image based on the image warping constraints to produce a warped image (e.g., using pixel-splatting or other appropriate techniques). The warped image can generally correspond to the novel view. However, the warped image may be incomplete as there may be some pixels in the warped image that have undefined color or appearance. Such pixels may correspond to (or comprise) a “disocclusion mask” and may generally correspond to objects or elements of a scene that are not visible in the input view image but would be visible in the warped image. FIG. 2 shows an input view image 202 and a corresponding warped image 204 with disocclusion mask 206.

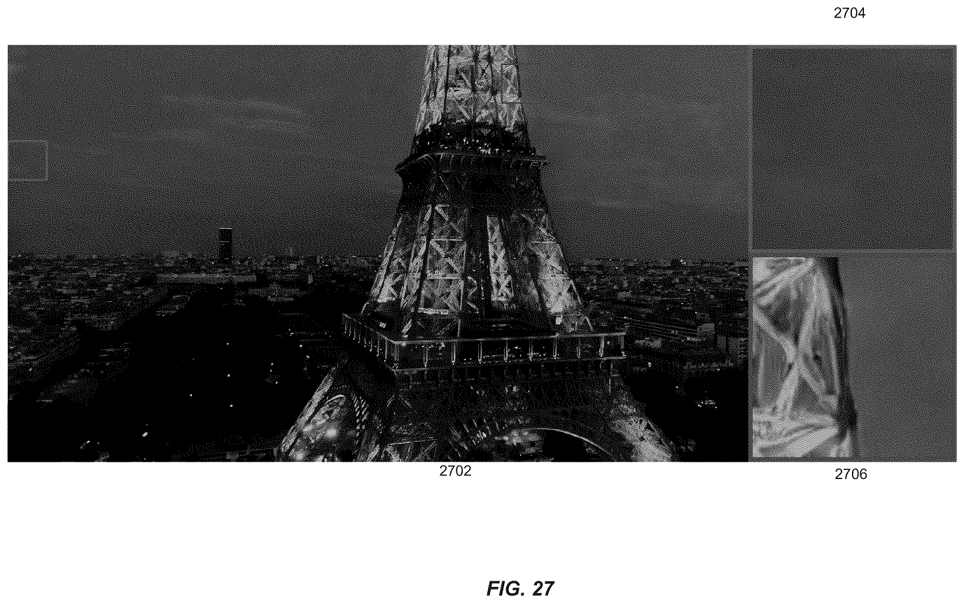

As such, at step 106 the computer system can generate a novel view image by performing inpainting on the warped image (e.g., using an inpainting model such as a diffusion machine learning model) to “fill in” the disocclusion mask. The novel view image can comprise the inpainted warped image. FIG. 27 (discussed in more detail further below) shows a novel view image 2702 generated by inpainting warped image 204 and disocclusion mask 206 of FIG. 2 using methods according to embodiments.

Inpainting in NVS is generally an ill-posed problem, as standard two-dimensional images typically can't depict objects that are obscured by other objects, thus an inpainting model cannot directly determine the appearance of the pixels in the disocclusion mask based on an input image alone. Instead, an inpainting model can rely on knowledge learned during its training (e.g., the general distributions and spatial relationships between different pixel colors learned from images in a training dataset) to estimate or predict reasonable pixels corresponding to the disocclusion mask.

Before describing methods according to embodiments in more detail, it should be understood that some terms and phrases in the description below are used for ease of exposition. For example, in reference to an image, the term “object” is used herein to refer to something depicted by that image, including things that are not typically considered objects. For example, in an image of a person standing in a field, the person, the field, some region of the field, the sky, a cloud in the sky, etc., all may be referred to as “objects”, even though such things may not be referred to as objects in common speech.

In addition, various shorthand expressions may be used herein for ease of exposition. For example, a “training pair alignment” method is described further below that can be used to generate training data. Such training data can then be used to train a machine learning model to perform inpainting for the purpose of NVS. As such, an expression such as “a machine learning model trained using training pair alignment methods according to embodiments” could be shorthand (depending on context) for a more cumbersome expression like “a machine learning model trained using training data generated using methods according to embodiments for generating training data using training pair alignment.” Similarly, an expression such as “methods according to embodiments can be used to train machine learning models to perform NVS” could be understood to mean that such methods can be used (among any other applicable methods) to train a machine learning model to perform some task or step associated with a novel view synthesis method (e.g., inpainting), and not that the machine learning models are being trained to perform every step associated with an NVS method.

More specific details about methods according to embodiments are described in more detail below. It is assumed that a potential practitioner of methods according to embodiments is already generally familiar with many NVS concepts, machine learning, diffusion models, inpainting, warping methods (such as pixel-splatting), etc. However, for ease of exposition and to better orient the reader, some of these concepts are briefly described below.

### A. Warping

Herein, a “warp” generally refers to a type of transformation, which, when applied to something (e.g., an image) produces a “warped” version of that thing (e.g., a “warped image”). An example of an image warp is the simulation of optical aberrations, e.g., warping an image by inducing barrel distortion or pincushion distortion in that image. For something (e.g., an image) that comprises a collection of elements (e.g., pixels), “warping” that thing can be accomplished by warping each element in the collection. For example, in an image comprising pixels organized in a grid, each pixel in the image may be defined by an x-coordinate, a y-coordinate, and color values. For such an image, a warp may be performed by determining a new x-coordinate and a new y-coordinate for each pixel in the grid, such that the image is “warped” by moving the pixels to their new locations within the grid.

The example above is a general description of a “pixel-splatting” operation, which is a type of warping operation applied to collections of pixels. Herein, the terms “warping” and “pixel-splatting” are used largely interchangeably, as most examples of warping operations in this disclosure are pixel-splatting operations. However, it should be understood that “warping” refers to a more general transformation and pixel-splatting refers to a specific type or class of warp. Further, it should be understood that methods according to embodiments that involve warping can be practiced using any appropriate warping operations, including warping operations other than pixel-splatting (e.g., 3D gaussian splatting). Thus, the examples of warping operations provided herein are intended to be non-limiting.

A warp can be constrained by some information, data, or theoretical consideration. As an example, in representational images, the appearance of objects in those images generally relates to the principles of optics and physical geometry, e.g., objects that are farther away from an observation point appear smaller, objects that are behind opaque objects cannot be seen, etc. The distance between objects (or e.g., pixels representing those objects), an image viewpoint, and vectors pointing to or from objects (or pixels) to the image viewpoint can be used to determine the change in appearance of objects as a result of a warping operation corresponding to a movement of the image viewpoint (e.g., due to the relative displacement of those objects). In embodiments of the present disclosure, “depth maps” (or related “disparity maps”) and optical flow maps can be used to warp images as part of NVS. However, it should be understood that warping operations performed during methods according to embodiments can be practiced using any information, data, or theoretical consideration, including those other than depth maps, disparity maps, and optical flow.

In some cases, a warp applied to a collection of elements can comprise (or be framed as) a mapping of elements from one collection of elements to another. For example, an image warp can be framed as a mapping between pixels in an original image and pixels in a warped image. In some applications of warping (e.g., NVS), multiple elements from one collection may map to the same element in the other collection, such that the second collection is smaller than the first collection. For example, consider an image of a scene with a foreground object and a background object, which are slightly offset from one another and are both visible in an input image. The image is warped to a new viewpoint to the left or right of the original viewpoint. The pixels in both the foreground object and the background object are displaced as a result of the warp, however, due to the parallax effect, the foreground object appears to be displaced more than the background object, and the foreground object occludes the background object as a result of the displacement. In such a case, both the pixels corresponding to the foreground object and the pixels corresponding to the background object are mapped to the same locations in the warped image.

### B. Disocclusion

It is often desirable that warped images are the same size as their corresponding original images. For example, in NVS, it may be desirable that a warped image is the same size as an input image, so that an input image and a novel view image (generated using the warped image) can be used as a stereo image pair. This leads to a potential issue: if the original image and the warped image comprise the same number of pixels, and multiple pixels from the input image map to the same pixel in the warped image, then there must be some pixels in the warped image that do not map to any pixels in the input image, and thus the apparent color and appearance of these pixels are unknown.

This phenomenon is generally depicted in FIG. 2, which shows an input image 202 (depicting the Eiffel Tower) and a warped image 204. A column of pixels on the left side of the warped image 204 have no corresponding pixels in the input image 202 and are displayed as solid black pixels. Likewise, some pixels on the right side of the Eiffel Tower also have no corresponding pixels in the input image and are also displayed as solid black pixels. While this phenomenon is a result of multiple pixels mapping to the same location during a warp, it also corresponds to real optical effects resulting from a changing viewpoint: any pixels in the warped image that do not correspond to pixels in the original image correspond to objects or other elements of the scene that are not visible in the original image.

As a viewpoint rotates counterclockwise around an object (e.g., the Eiffel Tower), objects on the left side of the image will come into view. Additionally, the obscured faces of the object, as well as other objects previously occluded by the object will come into view. These generally correspond to the black regions of pixels on the left side of warped image 204 and on the right side of the Eiffel Tower in warped image 204. Thus these pixels correspond to objects or scene elements that are “disoccluded” as a result of changing the viewpoint. In the present disclosure, the term “disocclusion mask” (e.g., disocclusion mask 206) can refer to data that identifies pixels in a warped image that correspond to objects or scene elements that are disoccluded as the result of a warp operation (e.g., pixel-splatting).

### C. Inpainting

Provided that an image warp has been performed based on appropriate techniques and/or constraints (e.g., those that reasonably simulate the apparent motion of objects as the result of the movement of a camera viewpoint), a warped image is “almost” a novel view image, as it does generally portray a scene from a novel viewpoint. However, a warped image is often incomplete, containing collections of pixels with unknown appearance (e.g., corresponding to a disocclusion mask). As summarized further above, in some embodiments, a computer system can generate a novel view image by “inpainting” a warped image, e.g., using a machine learning model such as a diffusion model.

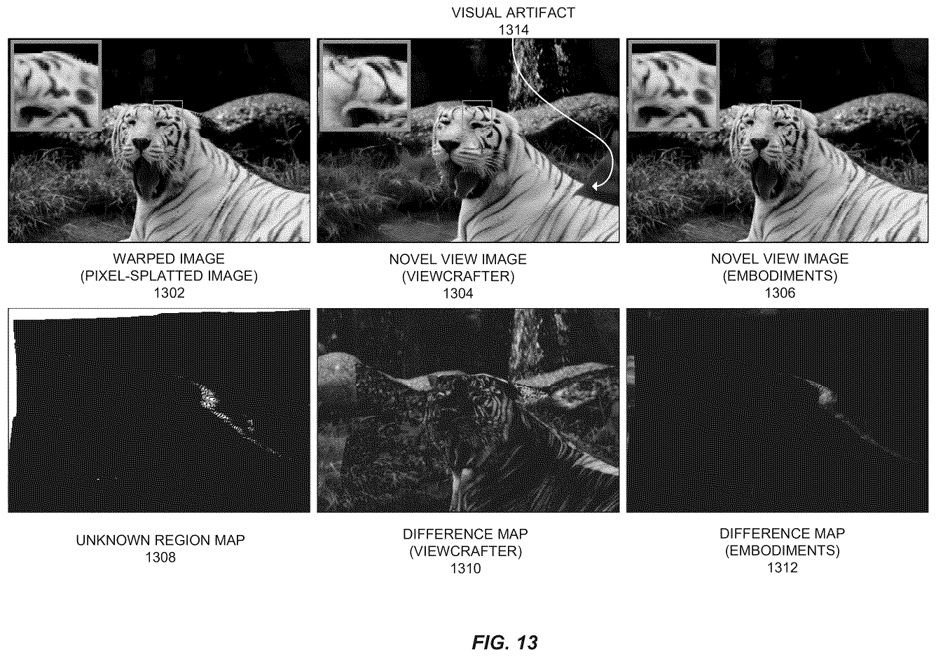

Herein, inpainting generally refers to any process that can be used to generate a complete image from an incomplete image (e.g., a masked image). In embodiments, machine learning models can be used to perform inpainting. Such machine learning models can be trained to predict the appearance of pixels in a complete image (e.g., a novel view image) based on the appearance of pixels in an incomplete image (e.g., a masked image). While it may be tempting to assume that a machine learning model would only predict the appearance of unknown pixels, e.g., those corresponding to a disocclusion mask), many inpainting models predict the appearance of an entire output image based on an input image, including pixels with already known appearance (e.g., known color, opacity, etc.), when performed improperly, inpainting can result in “hallucinated texture” and other visual artifacts, as discussed further below with reference to FIG. 13.

### D. Machine Learning

Some embodiments of the present disclosure relate to NVS performed using inpainting machine learning models (e.g., diffusion models). It is assumed that a potential practitioner of methods according to embodiments has some general knowledge of the field of machine learning, and can therefore understand, e.g., what is meant by “training a machine learning model” or has the ability to e.g., instantiate a diffusion model. However, in order to better orient the reader and introduce some terms used throughout the present disclosure, a brief summary of some machine learning related concepts is provided below.

At a high level, a machine learning model generally produces output data responsive to received input data. A machine learning model's “parameters” generally control how that machine learning model produces such output data, such that changing a machine learning model's parameters generally changes model outputs. In general terms, the process of training a machine learning model can involve determining the set of parameters that achieves the “best” performance, usually based on a loss or error function. A loss function relates the expected or ideal performance of the machine learning model to its actual performance on a training dataset. In “supervised learning”, a training data set may comprise pairs of inputs and expected or ideal outputs, sometimes referred to as the “ground-truth.” In some applications of machine learning (e.g., classification), the expected outputs may be referred to as labels. Loss functions are typically designed such that they decrease in value as the model's performance improves. As such, training a machine learning model often involves determining a set of parameters that minimizes a loss function corresponding to that model. Sometimes a random parameter estimate is generated as an initial parameter “guess”, and then a process such as gradient descent is used to iteratively refine the parameter estimate, eventually resulting in a final set of parameters associated with the machine learning model.

This iterative refinement process can be performed in a series of training “rounds”, “epochs”, or other appropriate divisions. In each round, a machine learning model's performance can be evaluated using the loss function, and the parameters can be updated based on this evaluation, e.g., with the goal of reducing the result over time. As an example, the gradient of the loss function can be determined in parameter space and can be used to reduce the value of the loss function in successive training rounds. Such a gradient corresponds to a change in model parameters that achieves the greatest immediate reduction in the loss function. By changing the model parameters based on the gradient, the loss function can be reduced during each successive training round.

The terms “reward” and “penalize” (or “punish”) are sometimes used in the context of training, often to generally describe the objectives of training or the ideal behavior of a machine learning model without needing to specific reference a loss function or any of the more technical details associated with training. Generally, a model is “rewarded” when its performance is more consistent with the expected or ideal performance (or is “acceptable” in view of the expected or ideal performance) and is “penalized” when its performance is less consistent with the expected or ideal performance (or is “unacceptable” in view of the expected or ideal performance). What exactly constitutes a “reward” or “penalty” depends on particular training processes or machine learning implementations. Generally however, in the context of training via loss function minimization, a “reward” can refer to a reduction in a loss function resulting from machine learning model performance that is consistent with ideal or desired performance, and a “penalty” can refer to an increase in the loss function resulting from machine learning model performance that is inconsistent with ideal or desired performance.

Regardless, training processes can be repeated until a terminating condition has been met, at which point training can end (although a machine learning expert could choose to continue or restart model training after a terminating condition has been met). In embodiments of the present disclosure, one type of terminating condition is a defined number of training rounds. This terminating condition can be met if the number of training rounds performed (e.g., by a computer system training the machine learning model) equals or exceeds the defined number of training rounds, at which point the iterative training process has been completed. Another type of terminating condition in embodiments is a convergence condition. This terminating condition can be met if the machine learning model parameters “converge.” In general terms, convergence is achieved when the value of the loss function, and/or the values of the model parameters change in increasingly small amounts with each successive training round. For example, a convergence condition can be achieved if the value of the loss function decreases by less than 0.1% in two successive training rounds.

It is possible to train multiple machine learning models or multiple trainable components of a machine learning model simultaneously, e.g., by updating parameter sets corresponding to those machine learning models simultaneously, e.g., using a single training dataset and/or a combined loss function. Components of a machine learning model (trainable or otherwise) may be organized into “layers” or “modules”, usually based on their relative “proximity” to either the model's inputs or outputs. The inputs to a machine learning model may be input into the first layer (e.g., the “input layer”), the outputs of the first layer input into the second layer, the outputs of the second layer input into the third layer, and so on until the output of the machine learning model is produced (e.g., by the “output layer”). As an example, an auto-encoder machine learning model may comprise an “encoder” and a “decoder” component, which may each comprise e.g., neural networks defined by their own parameter sets. The encoder component may comprise an input layer of the auto-encoder and the decoder component may comprise an output layer of the autoencoder. During autoencoder training, the encoder and decoder components may be trained simultaneously based on a loss function, e.g., such that the encoder is rewarded for generating encodings that are accurately decoded by the decoder, and such that the decoder is rewarded for accurately decoding such encodings. Similarly, it is possible to train some components of a machine at a given time and not train others. For example, one component of a machine learning model may be trained, then later its parameters may be “frozen” while another component of the machine learning model is trained.

Some machine learning models or model layers (such as the encoder component of an autoencoder), may be used to generate “embeddings” based on model inputs, also referred to herein as “encodings”, “latent space embeddings”, “latents”, etc., which can correspond to a “latent space”. An embedding can generally represent the information contained in a corresponding model input in a different form (e.g., as a point or vector in a latent space), which may facilitate further processing e.g., by subsequent layers of a machine learning model. In some cases, embeddings may have a smaller logical size (e.g., 10 times smaller, 100 times smaller, etc.) than the input data used to produce such embeddings. As such, the computational complexity of processing such embeddings (e.g., using subsequent model layers) may be lower than the computational complexity of processing the original input data, thereby improving the speed at which machine learning models produce model outputs based on such embeddings.

### II. Related Work

Having summarized some concepts related to novel view synthesis, inpainting, machine learning, etc., it may be helpful to review some related work in the field of novel view synthesis (NVS). NVS has recently attracted interest in the fields of computer vision and computer graphics in various applications like augmented/virtual reality, 3D generation, and stereo video conversion [Gao et al 2024; Mehl et al. 2024; Yu et al. 2024]. Compared with previous optimization-based NVS approaches, e.g., neural radiance field (NeRF) [Mildenhall et al. 2020] and 3D Gaussian splatting (3DGS) [Kerbl et al. 2023](which usually required dense input views and per-scene optimization), an emerging trend it to generate novel views from sparse views or even a single image in a feed-forward manner [Chen et al. 2025; Han et al. 2022; Szymanowicz et al. 2024a; Yu et al. 2024]. Due to the limited information from single views or sparse views, such NVS tasks are ill-posed and can require comprehensive scene understanding, including geometry, texture, and occlusion to be performed effectively.

Due to limited input information, early NVS approaches often adopted depth estimation methods to model scene geometry. Afterwards, inpainting approaches were used for content synthesis [Rockwell et al. 2021; Rombach et al. 2021; Wiles et al. 2020]. Such early works used various techniques to perform NVS, e.g., GAN-based inpainting for disocclusion regions [Wiles et al. 2020], VO-VAE outpainting [Rockwell et al. 2021], feed-forward neural scene prediction [Yu et al. 2021], and implicit 3D transformations [Rombach et al. 2021].

In addition, various 3D representations of scenes were designed for efficient view synthesis, including density fields [Wimbauer et al. 2023]. As another example, pixelNeRF combines convolutional networks with NeRF representation to render novel view from two images [Yu et al. 2021]. As other examples, layer-based representations, e.g., multi-plane images (MPI) [Han et al. 2022; Khan et al. 2023; Li et al. 2021; Tucker and Snavely 2020] and layered depth images (LDI) [Jiang et al. 2023; Shih et al. 2020], have been exploited for efficient rendering. Despite some progress, previous methods are often confined to specific domains. They often suffer from performance drops and struggle to generalize to complex in-the-wild scenes due to limited model capacity and limited prior knowledge of the 3D world.

Recently, some development in the field of NVS relates to diffusion-based methods and splatting-based methods for achieving feed-forward novel view synthesis from single or sparse view inputs. In general terms, diffusion-based approaches directly generate novel views via diffusion, and often produce better geometry layouts thanks to rich geometric priors. Splatting-based methods can employ pixel-splatting, point clouds, and 3D Gaussian splatting to generate novel views. Diffusion-based approaches and splatting-based approaches are summarized in more detail in the following paragraphs.

Generative diffusion models have shown promising performance in a variety of 3D vision task [Fu et al. 2025; Ke et al. 2024b; Zhang et al. 2024], including NVS [Sargent et al. 2024; Yu et al. 2024]. In order to generate high quality images or videos across a wide array of domains, diffusion models are generally trained over internet-scale databases, gaining extensive prior knowledge of the visual world [Rombach et al. 2022; Xing et al. 2025]. As a result, generative diffusion models have demonstrated strong performance in generating realistic images and videos [Rombach et al. 2022; Xing et al. 2025] with geometrically-consistent content.

Various methods for repurposing diffusion models for high-quality NVS have been explored in prior work, including semantic-preserving generative warping [Seo et al. 2024] and point-conditioned video diffusion [Yu et al. 2024]. Some previous methods involve conditional diffusion frameworks (e.g., 3D feature-conditioned diffusion [Chan et al. 2023] and viewpoint-conditioned diffusion [Liu et al. 2023]) to generate novel views for simple inputs like 3D objects [Zheng and Vedaldi 2024]. In some previous work, multi-view diffusion models are employed to synthesize high-quality novel views, which are then used to generate 3D scenes (e.g., 3D Gaussians) for novel view rendering [Liu et al. 2024; Wu et al. 2024]. Based on this, models such as ZeroNVS combine diverse training datasets to acquire zero-shot NVS performance [Sargent et al. 2024], and models such as Cat3D use efficient parallel sampling strategies for rapid generation of 3D-consistent images [Gao et al. 2024]. In addition, models such as GenWarp exploit diffusion priors to achieve semantic-preserving warping [Seo et al. 2024]. Recent works also explore the potential of video diffusion models for novel view synthesis. For instance, the ViewCrafter model is a point-conditioned video diffusion model that iteratively complete point clouds for consistent view rendering [Yu et al. 2024], and the StereoCrafter model uses a tiled processing strategy to generate stereoscopic videos with video diffusion models [Zhao et al. 2024].

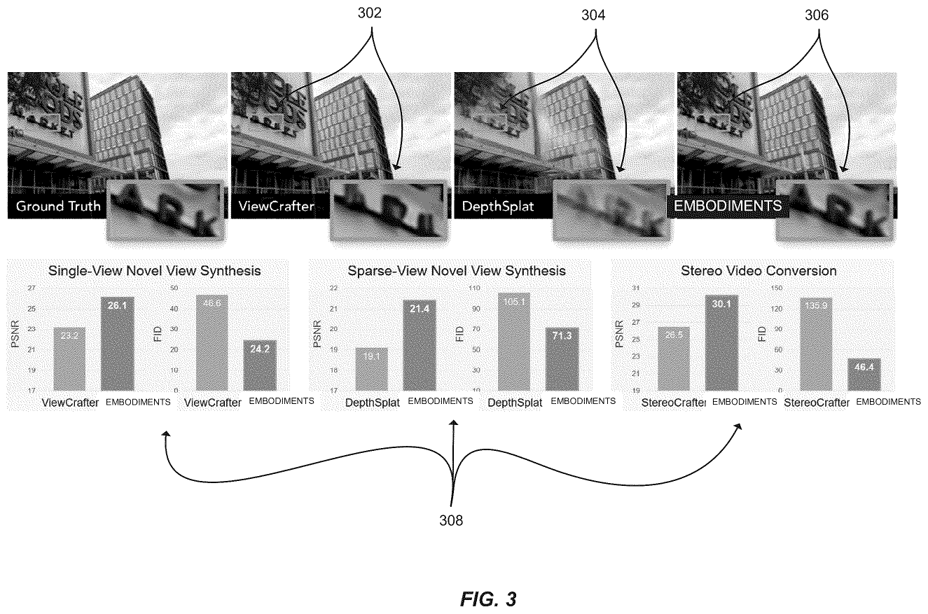

However, because of the generative nature, diffusion models often introduce hallucinated contents when generating novel views, such as inconsistent texture. Consequently, existing diffusion-based NVS methods can fail to preserve the original appearance of an input view, which potentially leads to inconsistent texture across different viewpoints. This issue is shown in detail box 302 of FIG. 3, a figure which provides a comparison of methods according to embodiments and existing methods for performing NVS. In particular, detail box 302 shows hallucinated content in a novel view generated with ViewCrafter, a NVS method that uses a diffusion model.

As described above, another trend in NVS is to render novel views using splatting-based approaches, e.g., Gaussian splatting [Chen et al. 2025; Xu et al. 2024]. For example, Flash3D employs a zero-shot depth estimator to predict 3D Gaussian positions and directly estimates the parameters of the 3D Gaussian for novel view rendering [Szymanowicz et al. 2024a]. Splatting-based NVS approaches are typically trained in a regression manner with pixel-level or feature-level constraints [Zhang et al. 2018]. As a result, they often preserve better textures compared to diffusion-based methods.

Various splatting-based NVS approaches employ depth-based warping to achieve real-time novel view synthesis [Cao et al. 2022]. Recent advances in 3DGS techniques [Kerbl et al. 2023] have led to increased attention to feed-forward Gaussian splatting methods. For example, the PixelSplat method involves estimates Gaussian parameters from neural networks and dense probability distributions, achieving efficient NVS with a pair of images [Charatan et al. 2024]. Following PixelSplat, several methods were developed for improved performance and efficiency, including cost volume encoding [Chen et al. 2025] and depth-aware transformer [Zhang et al. 2025]. Recent method DepthSplat integrates monocular features from depth models and achieves better geometry in the estimated 3D Gaussians [Xu et al. 2024]. Instead of utilizing multi-view cues, another line of work focuses on predicting Gaussian parameters from a single image. The Splatter Image method involves obtaining 3D Gaussian parameters from pure image features [Szymanowicz et al. 2024b], and Flash3D employs zero-shot depth models for generalizable single-view NVS [Szymanowicz et al. 2024a].

However, since single or sparse observations provide only limited cues for scene geometry, splatting-based methods often suffer from splatting errors, e.g., misalignment due to inaccurate depth. This can result in novel views with distorted geometry. This issue is shown in detail box 304 of FIG. 3, showing blurry distorted geometry in a novel view generated with DepthSplat, a splatting-based method.

Some embodiments of the present disclosure, described in more detail below, combine diffusion and splatting-based approaches in order to achieve geometrically-consistent and high-fidelity NVS. For example, in some embodiments, the geometric priors of diffusion models can be used to correct splatting errors, thereby resulting in higher quality novel views with consistent geometry and high-fidelity texture, as illustrated in detail box 306 of FIG. 3 and in the various reported PSNR and FID values 308.

There are various other works that are relevant to the current field of NVS, described briefly below. For example, the paper “Stereo Diffusion” [WFJB24] describes methods for generating a stereo image pair from an input image by making use of stereo pixel shifting operations in the latent space while denoising with a diffusion model. As another example, the paper “Diffuse3D” [JZL+23] describes methods related to “3D photography” involving converting an input image into layered depth images and performing diffusion inpainting on disoccluded regions. The diffusion model is made depth-aware by injecting depth information into the kernel used in denoising convolutions. As another example, the paper “Stereo Conversion with Disparity-Aware Warping, Compositing and Inpainting” [MBGS24] describes methods for generating a novel view of a frame by warping it according to its depth map and inpainting the resulting disoccluded regions via a convolutional neural network (CNN). These methods can additionally incorporate information from other frames through optical flow based warping.

### III. Overview of Methods According to Embodiments

Having summarized some relevant concepts related to embodiments, a brief overview of methods according to embodiments may be useful. Such an overview may facilitate a better understanding of methods and systems according to embodiments, as described in more detail in the following sections.

As described above, methods according to embodiments of the present disclosure all generally relate to the field of NVS. Generally, methods according to embodiments can be divided into three categories: (1) methods for generating training data that can be used to train machine learning models to perform NVS-related tasks, (2) methods for performing NVS using machine learning models, and (3) methods for using a texture conditional model to preserve texture information as part of image-to-image diffusion, e.g., for high-fidelity NVS or general-purpose inpainting. After describing a computer system that can be used to perform methods according to embodiments, the rest of this disclosure is generally structured in relation to these categories, i.e., first describing various methods for generating training data, then describing various methods for performing NVS and using a texture conditional model.

Methods according to embodiments can be practiced in combination with one another, e.g., methods for performing NVS can be performed using machine learning models trained using training data generated using methods according to embodiments. However, such methods can also be practiced independently. For example, methods for performing NVS could be performed without training a machine learning model using training data generated using methods according to embodiments. Similarly, disclosed methods for generating training data could be used to train other machine learning models to perform NVS, including machine learning models that are not disclosed herein(either explicitly or implicitly). Further, while a texture conditional model according to embodiments can be useful for generating more plausible novel view images by preserving high quality texture information from input images, such a texture conditional model is not confined to the field of NVS. Such a texture conditional model could instead be used to preserve high quality texture information in a general-purpose inpainting task. To reiterate, it should be understood that although methods according to embodiments may be described as being performed in combination with one another or in the context of NVS, some methods according to embodiments can be performed independently from one another and some methods according to embodiments can be performed outside the context of NVS.

### IV. Computer System and Client-Server Model

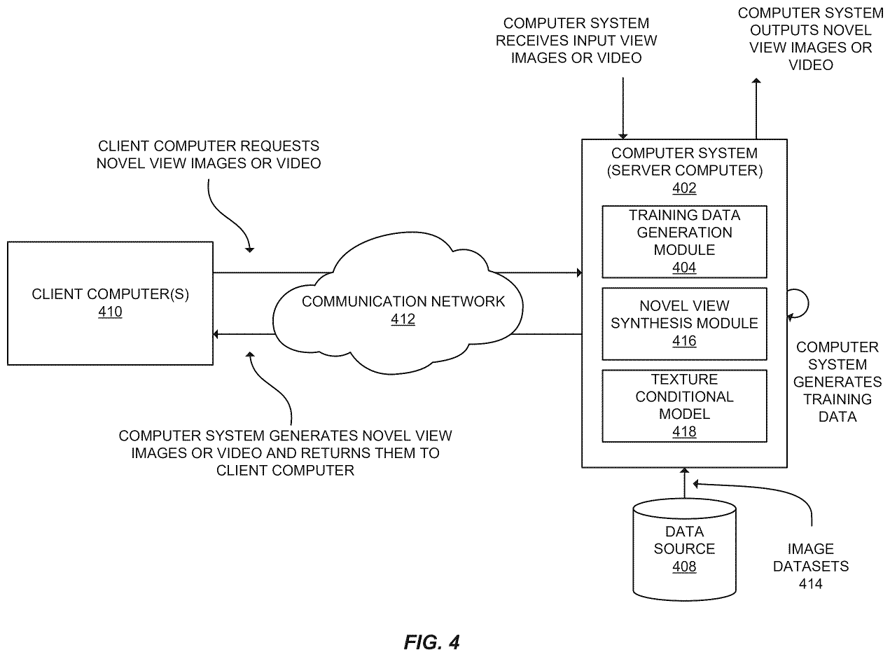

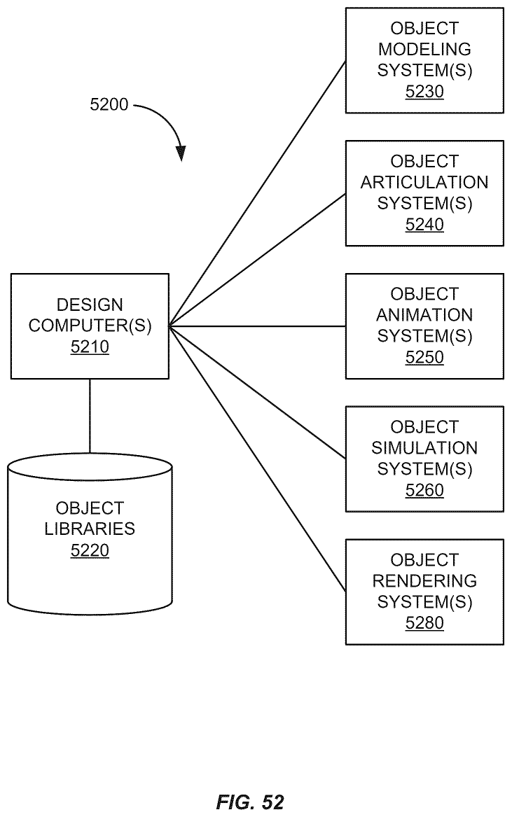

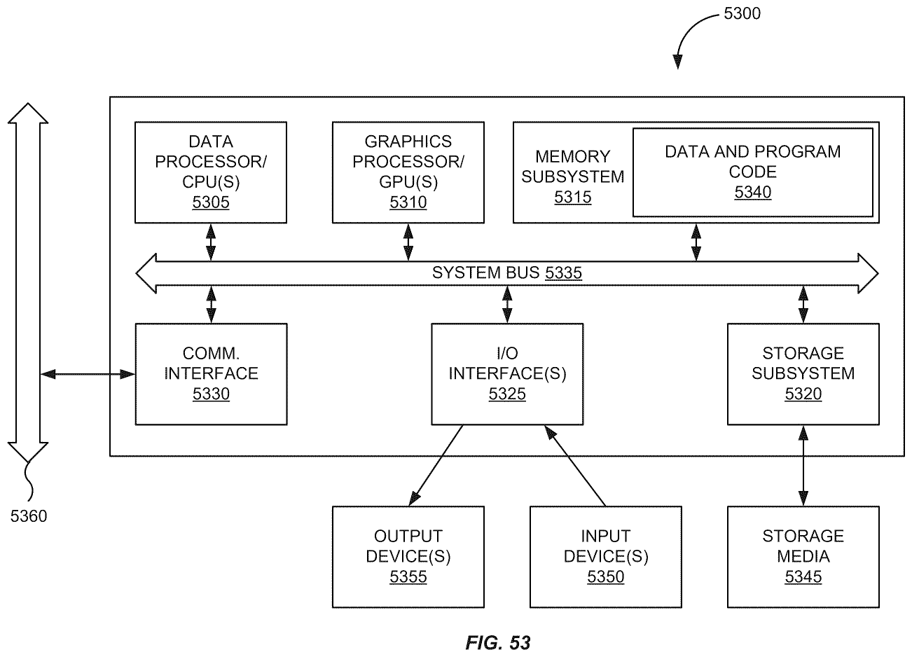

Having described some useful concepts related to embodiments of the present disclosure above, it may now be helpful to describe some systems according to embodiments, including computer systems that can implement methods according to embodiments. FIG. 4 shows a computer system 402 that can be used to perform methods according to embodiments. As described in more detail below with reference to FIGS. 52 and 53, a computer system such as computer system 402 can comprise one or more processors (not pictured) and a non-transitory computer readable medium (e.g., a hard drive) coupled to the one or more processors (also not pictured). The non-transitory computer readable medium can comprise code or instructions, executable by the one or more processors for performing methods according to embodiments described herein.

Computer system 402 can comprise various software or hardware modules. These software or hardware modules can be used by computer system 402 to perform the methods described herein. FIG. 4 depicts a training data generation module 404, a novel view synthesis module 416, and a texture conditional model 418. In general terms, the computer system can use these three modules to perform the various categories of methods according to embodiments mentioned above, e.g., (1) methods for generating training data that can be used to train machine learning models used for NVS, (2) methods for performing NVS using machine learning models, and (3) methods for using a texture conditional model to preserve texture information as part of image-to-image diffusion, e.g., for general-purpose inpainting or as part of NVS.

In general terms, computer system 408 can retrieve image datasets 414 from a data source 408 (e.g., a database, the Internet, etc.) and use training data generation module 404 to perform training data generation methods according to embodiments, including methods for generating training data pairs from single-view datasets and methods for generating aligned training pairs from multi-view datasets, e.g., using training pair alignment and splatting error simulation methods described in more detail below.

In general terms, computer system 402 can use novel view synthesis module 416 to generate novel view images and novel view videos using methods according to embodiments (e.g., using warping and diffusion-based machine learning inpainting), as well as train machine learning models for the purpose of NVS. Computer system 402 can use novel view synthesis module 416 to train machine learning models (including e.g., diffusion models and dual-branch diffusion models, as described in more detail below) using training data generated using training data generation module 404. Novel view synthesis module 416 may also include such machine learning models (which also could be stored elsewhere on computer system 402 in association with novel view synthesis module 416). Further, computer system 402 can use novel view synthesis module 416 to receive input view images or videos and generate novel view images or videos (e.g., using machine learning), which can then be output by the computer system 402 (e.g., provided to an operator of the computer system, saved to a file system on the computer system or an external file system (e.g., provided by a cloud storage system), transmitted to a client computer, etc.).

In general terms, computer system 418 can use texture conditional model 418 to perform image-to-image diffusion, thereby preserving texture information from input images that is usually lost during image-to-image diffusion. While computer system 402 can use texture conditional model 418 to preserve texture information during NVS, texture conditional model 418 can be used to preserve texture information in any image-to-image diffusion task.

It should be appreciated generally that the number of devices, entities, and components (including modules) shown in FIG. 4 were selected for simplicity of illustration and exposition. It should be understood that systems according to embodiments of the present disclosure can include more than one of each device, entity, component, computer system etc. In addition, some systems according to embodiments may include a lesser number of devices, entities, and/or components than those shown in FIG. 4. For example, computer system 402 may comprise a distributed computing system that comprises several computers collectively performing methods according to embodiments. Likewise, there may be multiple data sources 408 from which computer system 402 retrieves image datasets 414 for the purpose of training machine learning models, along with multiple communication networks 412 over which computer system 402 communicates with client computer(s) 410. As another example, computer system 402 may perform methods according to embodiments using a single monolithic software or hardware module, e.g., a single module that performs the functions of training data generation module 404, novel view synthesis module 416, and texture conditional model 418. As another example, computer system 402 may perform various functions using hardware and software modules that are not depicted in FIG. 4. For example, computer system 402 may use an operating system to manage other software and hardware components (e.g., training data generation module 404, novel view synthesis module 416, texture conditional model 418, etc.) and may use a communication interface (e.g., an Ethernet port, USB port, wireless interface, etc.) to communicate with other devices and systems over communication network 412.

As shown in FIG. 4, computer system 402 can be used to implement NVS as a service for others, e.g., on behalf of client computer(s) 410 or users of client computer(s) 410 (which may also be referred to as “requestors”). For example, a client computer 410 could comprise a personal computing system associated with a user. The user may wish to generate a stereoscopic “3D” video from one of their home videos. However, the client computer 410 may not be powerful enough to generate such a video in a reasonable amount of time. Hence, the user may use the NVS service provided by computer system 402 (which may be referred to as a “server computer”), which may be more powerful and have access to hardware enabling the rapid generation of stereoscopic videos using NVS. As another example, client computer 410 could comprise a computer terminal associated with a visual effects company. While client computer 410 may be powerful enough to perform various tasks related to the generation of visual effects for television shows, movies, videogames, etc., it may still rely on an external rendering computer (e.g., computer system 402) to generate final renders of visual effects and videos, including stereoscopic videos generated using NVS methods according to embodiments.

In such examples (and in general terms), client computer(s) 410 can generate requests requesting novel view images or videos from computer system 402 and transfer any relevant data along with such requests (e.g., input view images or videos). Computer system 402 can then generate the requested novel view images and/or novel view videos and return them to client computer(s) 410. In such cases, client computer(s) 410 and computer system 402 can communicate over a communications network 412. In embodiments, a communications network such as communication network 412 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers and devices in the system of FIG. 4 and over communication network 412 may be transmitted using a secure communication protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like. Any suitable communication protocol can be used to communicate over communication network 412, e.g., for the purpose of creating one or more communication channels. A communication channel may, in some instances, comprise a secure communication channel, which may be established in any known manner, such as through the use of mutual authentication, a session key, establishment of a Secure Socket Layer (SSL) session, etc.

In some embodiments, requests from client computer(s) 410 may contain all the information (e.g., input view images or videos) necessary for computer system 402 to generate novel view images and novel view videos. However, in other embodiments, computer system 402 may retrieve relevant data from another data source (e.g., data source 408), e.g., comprising a memory element (such as a hard drive), a database, any other data structure or storage element, the Internet, etc., in order to service requests from client computer(s) 410. As an example, a user of a client computer may request a novel view image or video be generated from an input view image or video hosted on the Internet (not on the client computer itself) and may provide a URL for that input view image or video. Computer system 402 may then retrieve that input view image or video using the provided URL, generate the corresponding novel view image, and return the novel view image to the client computer, or e.g., provide the novel view image to a server or other computer system hosting the input view image.

### V. Training Data Generation Methods

As described above, some embodiments of the present disclosure are directed to methods for generating training data that can be used to train machine learning models to perform NVS or tasks associated with NVS. More specifically, some methods according to embodiments can be used to train machine learning models to inpaint warped images (e.g., pixel-splatted images), as part of a NVS framework (also referred to as a “pipeline”) as summarized above with reference to FIG. 1. These training data generation methods can generally be divided into two categories: (A) methods for generating training data pairs from single-view datasets and (B) methods for generating aligned training data pairs from multi-view datasets using training pair alignment and splatting error simulation.

In general terms, machine learning models typically perform better when trained with more training data and higher quality training data. Unfortunately, for many NVS applications, training data is limited and there are often problems associated with the quality of available training data. Embodiments address both these problems via various methods for generating training data described herein. In very general terms, (A) methods for generating training data pairs from single-view datasets increase the availability of training data, and (B) methods for generating aligned training data pairs improve the quality of available training data. As a result, NVS models trained using training data generated using methods according to embodiments can achieve better performance on NVS tasks.

### A. Generating Training Data from Single-View Datasets

Often, training a machine learning model to perform some aspect of NVS (e.g., inpainting) is a supervised learning task. Training data thus frequently comprises paired data, e.g., an input image and a “ground-truth image”. During training, the input image (or e.g., data derived from the input image) can be input into the machine learning model to generate a training output image. The training output image can be compared to the ground-truth image in order to evaluate the machine learning model's performance, and, e.g., derive loss values which can be used to update the parameters of the machine learning model. A problem is that most image datasets are single-view (or “single-image”) datasets, not multi-view datasets, i.e., for each scene captured by an image, there is only one image of that scene or there is only one viewpoint of that scene. Such data cannot be used to train machine learning models for NVS tasks as-is, as there are no training pairs comprising input images and ground-truth images. Instead, stereoscopic or multi-view image datasets are used to train machine learning models to perform NVS tasks. In such datasets, one view of a scene can be used as an input image, and another view of that same scene can be used as a ground-truth image. Unfortunately, such stereoscopic image datasets are rarer and more costly to produce.

This problem is generally addressed by methods (A), which enable the generation of a training sets of images from a single image. Such training sets of images can be used to train a machine learning model (e.g., a diffusion model used for inpainting) to generate novel view images. These methods thus greatly increase the availability of training data, as they enable single-view datasets to be used to train NVS machine learning models.

As a high-level summary, in some methods according to embodiments, for each image in a single-view dataset, a computer system can determine an occlusion mask, which can correspond to pixels in the image that would be occluded as the result of a warping process. The computer system can then apply the occlusion mask to the image and generate a training set of images comprising the image and the corresponding masked image. In such a training set, the masked image can comprise the input to a machine learning model and the input image can comprise the ground-truth image. Such a training set of images can be used to train a machine learning model to inpaint the masked regions of the masked images. These methods are in contrast to other methods for generating training data for NVS, in which an input view image is warped to match a target image, thereby determining a disocclusion mask (not an occlusion mask), and then the warped and masked image and the target view image are used as a training data pair, e.g., as described in more detail further below with reference to methods for training pair alignment.

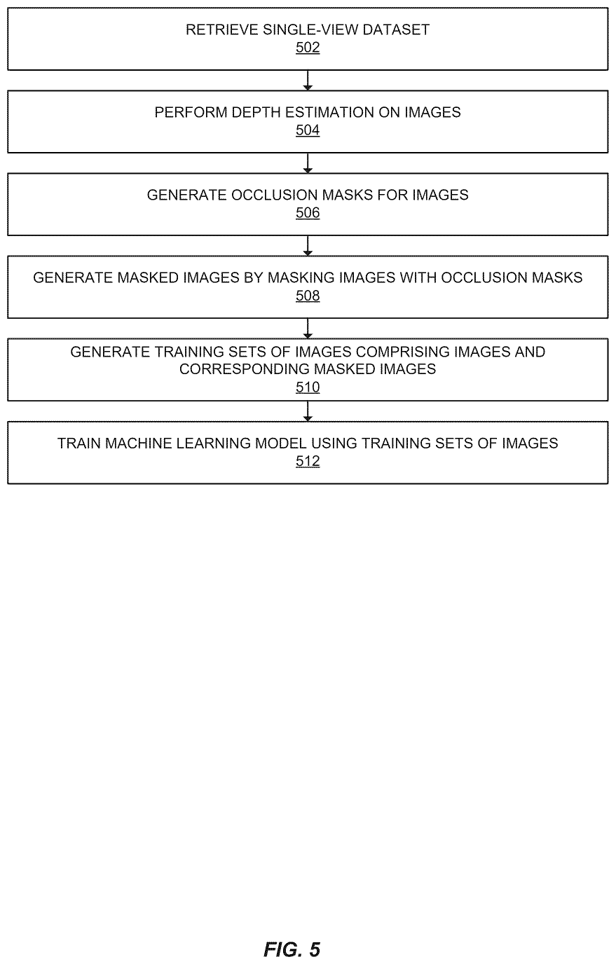

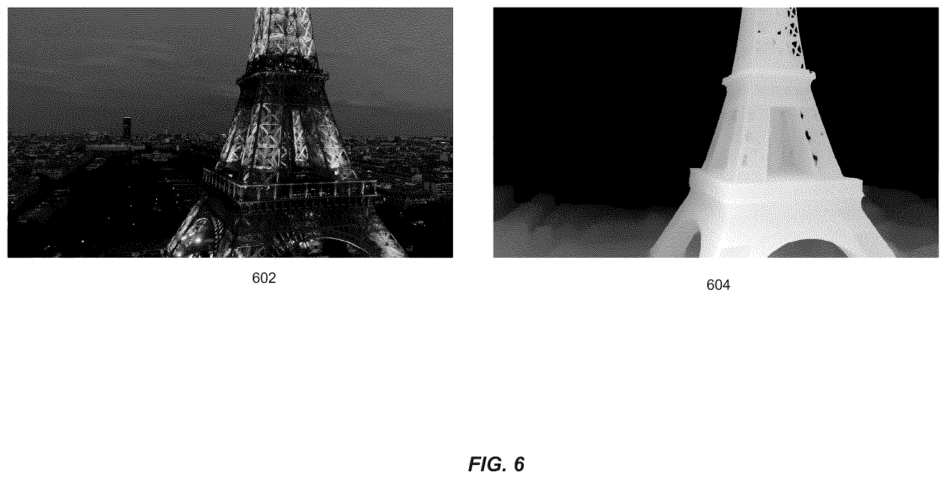

More specifically, a method for training a machine learning model to generate novel view images corresponding to warped images using a single-view dataset is described below with reference to the flowchart of FIG. 5 and with additional reference to FIGS. 6-11. The method can be performed by a computer system, e.g., as described above with reference to FIG. 4 or below with reference to FIGS. 52 and 53.

At step 502, the computer system can retrieve the single-view dataset. The single-view dataset can comprise a plurality of images. In some embodiments, no two images in the single-view dataset depict the same scene from different views. In some embodiments, the computer system can retrieve the dataset from a database, data stream, a local memory such as a hard drive, cloud storage, an I/O interface, the Internet, or any other appropriate source. In other embodiments, the computer system can comprise a server computer that provides machine learning based NVS services for client computers. In such embodiments, the computer system can receive the training data sequence from a client computer (or from any other appropriate source, e.g., a URL provided by a client computer), e.g., over a communication network such as the Internet, as described above with reference to FIG. 4.

The computer system can perform various steps (described below) for each image in the single-view dataset. In this way, the computer system can generate a plurality of training sets of images that can be used to train a machine learning model. Each training set of images can comprise an image from the single-view dataset and a masked image. The computer system can train the machine learning model to inpaint the masked images generating machine learning model outputs. The machine learning model outputs can be compared again the corresponding images (which can serve as ground-truth images) to evaluate the machine learning model's performance during training.

At step 504, for each image, the computer system can perform depth estimation on that image to generate a depth map corresponding to that image. In this way, the computer system can generate a plurality of depth maps corresponding to the plurality of images. Each depth map can indicate the “depth” of each pixel in a corresponding image, e.g., the distance (along a “Z” dimension) between each pixel and a viewpoint of the image (which may be hypothetical or imaginary, e.g., a point in space corresponding to an idealized pinhole camera). As such, a depth map according to embodiments can comprise arrays of “depth values” Z. FIG. 6 shows an example depth map visualization 604 corresponding to an image 602. In the depth map visualization 604, brighter regions are closer to the viewpoint of image 602, while darker regions are farther away from the viewpoint of image 602.

Methods according to embodiments can be practiced using various methods to generate depth maps based on input view images, e.g., using monocular depth estimation. These methods can include the use of “off-the-shelf” depth estimation models, including depth estimation models such as “MiDaS” [RLH+20], “DepthFM”, “Marigold” or “Depth Anything” [YKH+24]. In some experiments performed using embodiments of the present disclosure, using Depth Anything V2 to perform depth estimated yielded better results than MiDaS in training machine learning models to perform NVS. Models trained using training data generated using MiDaS had some warping artifacts and misalignments of disocclusion masks with object contours, which may have been the result of inaccurate depth map edges.

As described below, the computer system can use the plurality of depth maps to warp the plurality of images in order to determine a plurality of occlusion masks. Generally, when objects are viewed from a moving viewpoint, the apparent motion of objects is proportional to the distance between those objects and the viewpoint. Objects that are farther away have less apparent motion than objects that are close to the viewpoint. Similarly, when warping an image comprising a collection of pixels, pixels that are farther away from an image viewpoint are expected to move less as a result of the warp, while pixels that are closer to the image viewpoint are expected to move more as a result of the warp. Thus, depth maps can be used to guide warping processes such as pixel-splatting.

In some embodiments, the depth map can include a disparity map comprising a plurality of disparity values corresponding to a plurality of pixels in the image. In such cases, for each image, the computer system can generate an initial depth map comprising a plurality of depth values corresponding to a plurality of pixels in the image. The computer system can generate the initial depth map using the methods described above or other applicable methods (e.g., using monocular depth estimation methods). The computer system can then invert each depth value Z of the plurality of depth values based on a first disparity parameter a and a second disparity parameter b, thereby generating the plurality of disparity values d and the disparity map, e.g., according to a formula such as

$$d = a \cdot \frac{1}{z} - b ,$$

in which the first disparity parameter a and the second disparity parameter b can comprise constants chosen by practitioners of methods according to embodiments based on any number of criteria, as described in more detail below. Each disparity map can comprise an array of corresponding disparity values d.

Rather than directly warping each image using a corresponding depth map, the computer system can warp each image using a corresponding disparity map derived from a corresponding depth map. In general, as described above, the apparent motion of objects as a result of a changing viewpoint is proportional to the inverse of the distance between those objects and the viewpoint. Thus, the displacement of each pixel in an image when that image is warped based on a corresponding depth map is proportional to the inverse of a corresponding depth value. By contrast, the displacement (or the magnitude of displacement) of each pixel in an image can be (non-inversely) proportional to a corresponding disparity value in a disparity map (e.g., in accordance with the formula above). In some embodiments or applications, the first disparity parameter a and the second disparity parameter b can be chosen to keep the disparity values d in each disparity map in a reasonable range (e.g., such that pixels are not being displaced unreasonable distances). In the context of stereo images and video, such a reasonable range could be based on the eye distances (estimated, measured, based on population averages, etc.) of viewers that may later view novel view images generated using methods according to embodiments. As an example, values of the first disparity parameter a and the second disparity parameter b can be selected such that disparity maps correspond to roughly the viewpoint disparity of viewing a scene with one eye versus the other eye, such that if a viewer were to simultaneously view (e.g., using a VR headset) both an original image and a novel view image (e.g., using a VR headset), they would experience an illusion of depth resulting from the stereoscopic viewing effect.

At step 506, for each image, the computer system can generate an occlusion mask based on a warping process and the (corresponding) depth map. Each occlusion mask can correspond to (and/or identify) one or more pixel locations in a corresponding image. These pixel locations generally correspond to pixels that would be occluded as a result of a warping process. By generating an occlusion mask for each image, the computer system can determine a plurality of occlusion masks. As described above, in some embodiments the depth map can comprise a disparity map, thus in some embodiments the computer system can determine the corresponding occlusion mask based on the warping process and the disparity map.

In some embodiments, the warping process can comprise a softmax pixel-splatting operation (see e.g., [Mehl et al. 2024; Niklaus and Liu 2020]), however it should understood that other warping processes can be used in methods according to embodiments. In general terms, a warping process (such as depth-guided pixel-splatting) can produce or correspond to a “mapping” between pixels in an input image and pixels in a warped image, such that the warped image can be generated by applying the mapping to the pixels in the input image. It should be understood however that in some embodiments, an occlusion mask can be determined without actually “performing” a complete warp, i.e., without generating a warped image. Instead, as described in more detail below, the computer system can use a warping process to generate such mappings, then use such mappings to determine occlusion masks. There are various processes or methods that a computer system can use to determine an occlusion mask for each image, and various constraints or other factors can be used as part of a warping process, such as depth maps or disparity maps. It should be understood that the following examples are intended to be non-limiting and various other methods can be used to determine occlusion masks.

For example, in some embodiments, the computer system can assign each pixel in the image to a corresponding warped image pixel set of a plurality of warped image pixel sets based on the warping process and the depth map. In this way, the computer system can determine one or more corresponding warped image pixel sets. Each warped image pixel set can generally correspond to a pixel in a (hypothetical) warped image, i.e., each pixel assigned to a given warped image pixel set can generally comprise a pixel from an image that would be mapped to that pixel coordinate in the corresponding warped image. Therefore, the plurality of warped image pixel sets can generally comprise a mapping between the input image and a (hypothetical) warped image.

For example, in some embodiments, in order to assign each pixel in each image to a corresponding warped pixel set, the computer system can determine a warped pixel coordinate for each pixel based on a corresponding depth value in the depth map (or a corresponding disparity value in the disparity map). In this way the computer system can determine a plurality of warped pixel coordinates. These warped pixel coordinates can generally indicate the new location of these pixels in a warped image (if a warp were performed). The computer system can then assign each pixel to a warped pixel set corresponding to its determined warped pixel coordinates.

There are various ways that the computer system can determine these warped pixel coordinates, e.g., by determining a horizontal pixel displacement (e.g., 56 pixels left) and a vertical pixel displacement (e.g., 27 pixels down) for each pixel in the image, then determining the warped pixel coordinate by applying these horizontal and vertical pixel displacements to each pixel's original coordinate. Alternatively, a horizontal displacement and vertical displacement could be determined in some other units (e.g., meters, centimeters, etc.), which could be quantized to produce a horizontal pixel displacement and vertical pixel displacement.

In some cases, the computer system can determine the warped pixel coordinates based on a viewpoint data element corresponding to a viewpoint. The viewpoint data element can generally quantify or qualify the viewpoint corresponding to the image. In some embodiments, the viewpoint data element can comprise a virtual camera position vector indicating a position of a virtual camera in a three-dimensional virtual space and a virtual camera orientation vector indicating an orientation of the virtual camera in the three-dimensional virtual space. In some embodiments, the virtual camera position vector can comprise an x-coordinate, a y-coordinate, and a z-coordinate, e.g., corresponding to the position of a virtual camera in a three-dimensional Euclidean space. In some embodiments, the virtual camera orientation vector can comprise a polar angle and an azimuthal angle, indicating the angular orientation of the virtual camera.

In other embodiments, the viewpoint data element can comprise a virtual camera positional displacement vector indicating a spatial displacement of the virtual camera between a camera view in the image and a camera view corresponding to the viewpoint data element (and the warp), in addition to a virtual camera orientation displacement vector indicating an orientation displacement between the camera view in the image and the camera view corresponding to the viewpoint data element (and the warp). In some embodiments, the virtual camera positional displacement vector can comprise an x-displacement, a y-displacement, and a z-displacement. In some embodiments, the virtual camera orientation displacement vector can comprise a polar angle displacement and an azimuthal angle displacement.

In some cases, a pixel may be warped “out-of-bounds”, i.e., the pixel may have a warped pixel coordinate that is greater than one or more dimensions of the image (or a hypothetical warped image). For example, for a 512 by 512 image, a pixel with a warped pixel coordinate of (800, 130) is outside the bounds of the image, and would not be visible in a hypothetical warped image. As such, in some embodiments the plurality of warped image pixel sets can include an out-of-bounds warped image pixel set, and the out-of-bounds warped image pixel set can correspond to pixels that are warped outside dimensions of the image as part of the warping process.

After iterating through all the pixels in an image, each warped image pixel set may be assigned zero or more pixels from the image. A warped image pixel set assigned zero pixels generally indicates that no pixels from the image map to a corresponding pixel location in a hypothetical warped image. These pixels are generally undefined in warped images and correspond to disoccluded regions. If a warped image pixel set is assigned one pixel generally indicates that exactly one pixel from the image maps to the corresponding pixel location in a hypothetical warped image. If a warped image pixel set is assigned more than one pixel, it generally indicates that multiple pixels from the image map to a pixel coordinate in a hypothetical warped image corresponding to that warped image pixel set. This could occur if, e.g., the distance between two pixel coordinates and the difference between their disparities are equal (or approximately equal), such that when the pixels move as a result of the warp, they move to occupy the same location. However, as most two-dimensional images comprise arrays of pixels in which each pixel coordinate is occupied by exactly one pixel, warping processes generally involve resolving pixel “collisions” in warped images, e.g., scenarios in which multiple pixels map to the same warped pixel coordinate. In general terms, for each warped image pixel set comprising more than one pixel, a computer system can perform collision resolution by select one pixel assigned to that warped image pixel set to retain, and removing the rest of the pixels. In embodiments, collision resolution can be used to identify pixels in the image that do not correspond to any pixels in a warped image (i.e., the pixels which were removed), which can be used to generate the occlusion mask.

As such, in some embodiments the computer system can determine a primary pixel (sometimes referred to as a “top” pixel ptp) for each warped image pixel set, thereby determining a plurality of primary pixels. These primary pixels can comprise pixels that would be visible in warped image generated using the warping process. These can comprise, e.g., pixels with the least depth value or highest disparity value in their respective warped pixel set. Such pixels can correspond to objects in the foreground of the image that may occlude other objects (e.g., corresponding to pixels with higher depth values or lower disparity values) in a warped image as a result of a warping process. As such, in some embodiments, the computer system can determine the primary pixel for each warped image pixel set by determining (for each warped image pixel set) a pixel with a lowest corresponding depth value or a highest corresponding disparity value based on the depth (or disparity) map. The pixel with the lowest corresponding depth value or highest corresponding disparity value can comprise the primary pixel.

The computer system can then determine one or more occluded pixels based on the plurality of warped image pixel sets. The one or more occluded pixels can comprise one or more pixels from the plurality of warped image pixel sets that are not primary pixels, e.g., pixels assigned to warped image pixel sets that are not the top pixel for their respective warped image pixel set. These are pixels from the image corresponding to objects in the image that would be occluded in a corresponding warped image.

In some cases there may be additional occluded pixels in the image. As described above, such pixels may comprise pixels that would be warped “out-of-frame” in the warped image, i.e., such that one or more of their warped pixel coordinates (e.g., x-coordinate, y-coordinate) is greater than one or more dimensions of the image. Thus, in some embodiments the computer system can determine one or more additional occluded pixels based on an out-of-bounds warped image pixel set. The one or more additional occluded pixels can comprise pixels assigned to the out-of-bounds warped image pixel set as part of the warping process.

The computer system can generate the occlusion mask based on the one or more occluded pixels (and e.g., one or more additional occluded pixels). As described above, the occlusion mask can correspond to one or more pixel locations. These one or more pixel locations can comprise the pixel locations in the image corresponding to the one or more occluded pixels (and e.g., one or more additional occluded pixels) determined by the computer system.

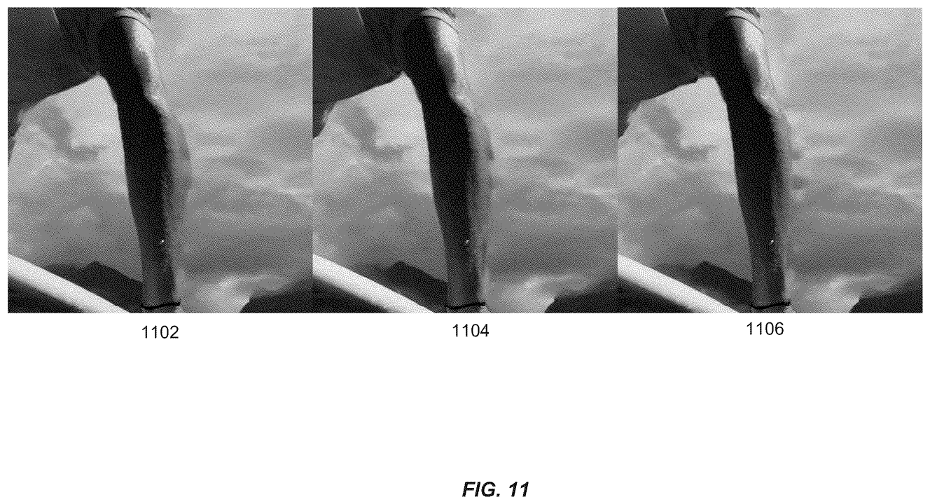

In some embodiments, the computer system can additionally add random masking to each image's occlusion mask. This random masking may enable machine learning models trained using training data generated according to embodiments to retain general inpainting capability, while still being specialized to the task of inpainting disocclusion masks as part of NVS. Experiments show that adding random masking to occlusion masks can improve inpainting quality and reduce the frequency and intensity of visual artifacts, as discussed further below with reference to FIG. 11.

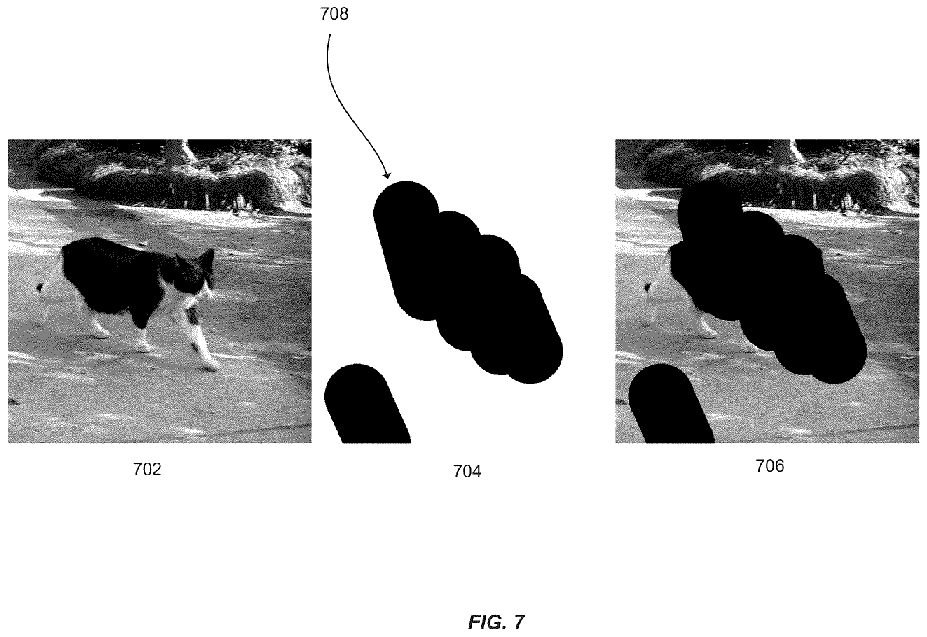

As such, in some embodiments, the computer system can determine an initial occlusion mask (for each image) based on a warping process and the depth map, e.g., as described above. The computer system can then determine a random occlusion mask, then combine the initial occlusion mask and the random occlusion mask to determine an occlusion mask (e.g., via element-wise conjunction, multiplication, addition, etc.). The computer system can use various random mask generation methods (e.g., the random mask generation method of [JLW+24]). FIG. 7 shows an example image 702, an example random mask 704 (comprising randomly distributed line masking elements of constant width, e.g., line element 708), and an example masked image 706 comprising the example image 702 masked using the example random mask 704. In some embodiments, such random masks or e.g., their masking elements can be combined with (or otherwise applied to) the occlusion masks in order to add random masking to the occlusion masks.

Referring back to FIG. 5, at step 508, for each image, the computer system can generate a masked image by masking the image with a corresponding occlusion mask. In this way, the computer system can generate a plurality of masked image corresponding to the plurality of images. There are various ways that the computer system can combine each image with its corresponding occlusion mask. As described above, each occlusion mask can correspond to one or more pixel locations in the corresponding image. As such, in some embodiments the computer system can mask each image with its occlusion mask by setting one or more pixel values associated with the one or more pixel locations in the image to a default value, e.g., associated with a default color, e.g., completely black or completely white. As an alternative, the computer system can mask each image with its occlusion mask e.g., using element-wise conjunction or other combination methods.

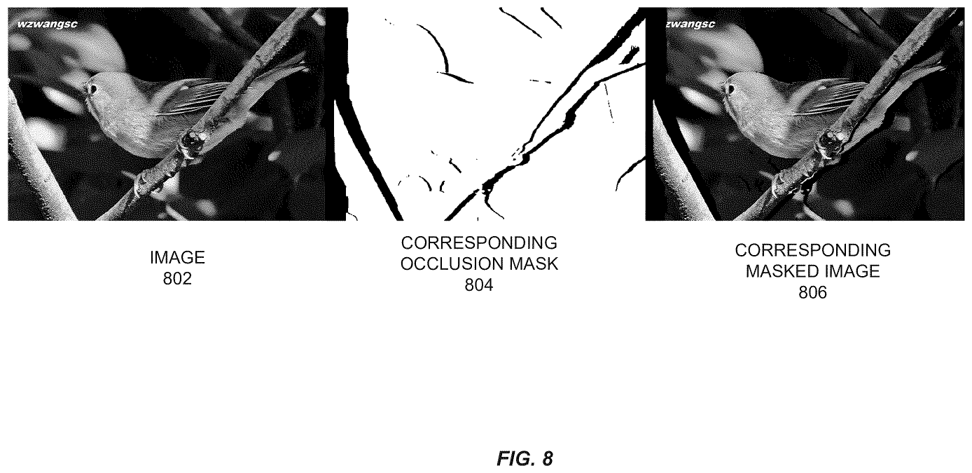

At step 510, for each image, the computer system can generate a training set of images comprising the image and a corresponding masked image, i.e., a masked image generated using any of the steps described above. The computer system can thereby generate a training set of images for each image in the single-view dataset, thereby generating a plurality of training sets of images. FIG. 8 shows an exemplary image 802, a corresponding occlusion mask 804, and a corresponding masked image 806. The image 802 and corresponding masked image 806 could comprise a training set of images. Each image can comprise a ground-truth image and the corresponding masked image can comprise an input image used to train a machine learning model. The output of the machine learning model can then be compared to the corresponding ground-truth image to evaluate the performance of the machine learning model, calculate one or more loss values, update machine learning model parameters, etc. In this way, the computer system can generate training sets of images that can be used to train a machine learning model in a supervised manner from a single-view image dataset, a training task that is generally impossible with single-view images alone.

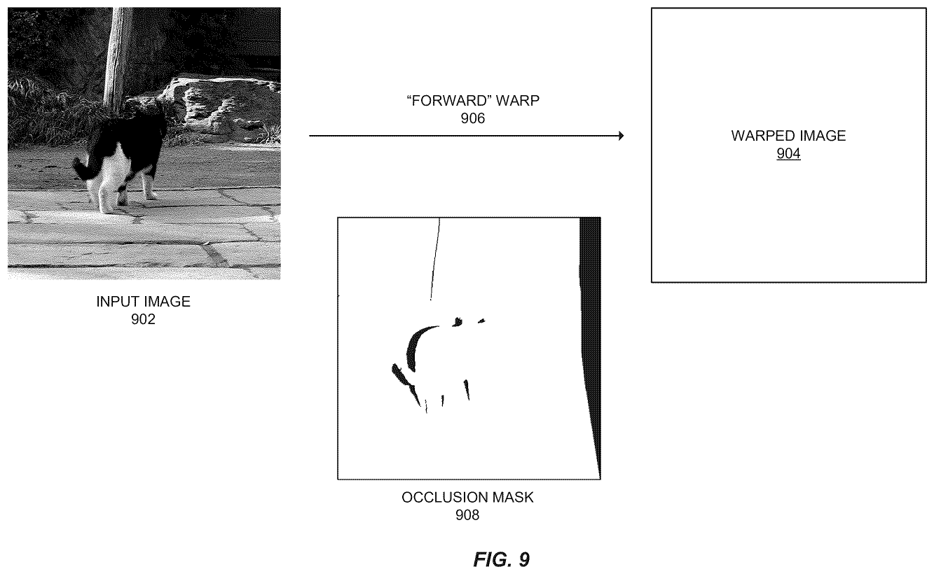

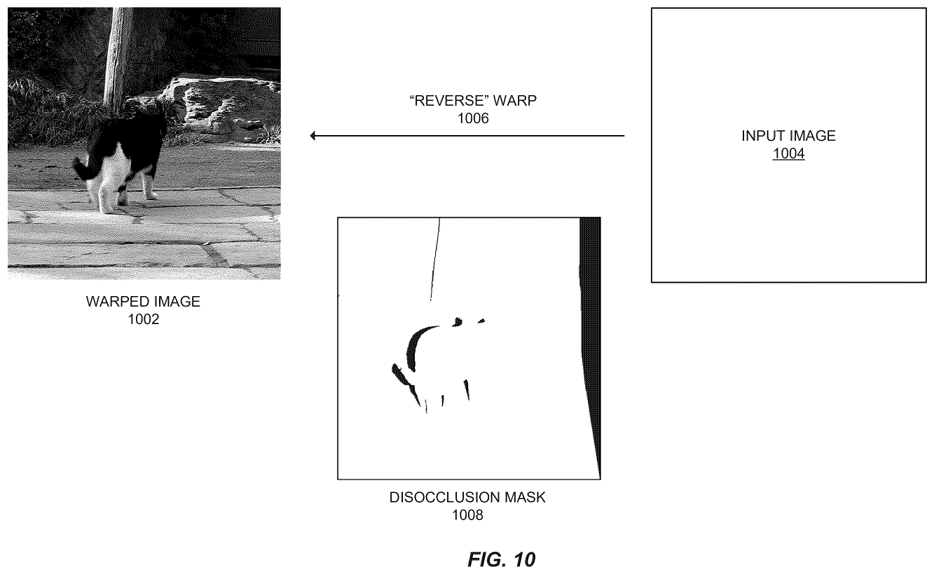

Training data generation methods according to embodiments enable supervised training by exploiting the symmetric nature of warping operations. As shown in FIGS. 9 and 10, a “forward” warp 906 can be applied to an input image 902 to create a warped image 904 (not pictured). An occlusion mask 908 can correspond to the “forward” warp 906. This occlusion mask 908 is equivalent to a disocclusion mask 1008 corresponding to the “reverse” warp 1006 from an input image 1004 (also not pictured, but equivalent to the warped image 904) to a warped image 1002 (equivalent to the input image 902). Thus, training a machine learning model to inpaint occlusion masks (e.g., using training data generated using methods according to embodiments) can achieve the same result as training that machine learning model to inpaint disocclusion masks.

In some embodiments, the computer system can generate additional masked images to include in the training set of images, e.g., in order to improve the quality of training. As such, in some embodiments, each training set of images can comprise an image, a masked image, and one or more additional masked images. In such cases, prior to training a machine learning model, the computer system can determine one or more additional occlusion masks based on one or more additional warping processes and the depth map. These additional occlusion masks could correspond to additional viewpoints and additional viewpoint data elements. The computer system can then generate the one or more additional masked images by masking the image with the one or more additional occlusion masks. The computer system can use methods similar to those described above to generate the additional occlusion masks, the additional masked images, etc.

At step 512, the computer system can train the machine learning model using the plurality of training sets of images. In this way, the method described herein with reference to FIG. 5 can be used to train a machine learning model to generate novel view images (e.g., by inpainting warped images) using a single-view image dataset, obviating the need for comparatively costly and rare multi-view image datasets.

There are various ways that a machine learning model can be trained using the plurality of training pairs of images, and general examples are provided below. As an example, in some embodiments, the computer system can generate a plurality of training model outputs by applying a plurality of masked images from the plurality of training sets of images to the machine learning model. The computer system can then determine one or more loss values based on a comparison between the plurality of training model outputs and the plurality of images. As an example, if training model outputs are similar to their corresponding (ground-truth) images, the loss values may have lower values, while if the training model outputs are dissimilar to their corresponding images, the loss values may have higher values. Afterwards, the computer system can update a parameter set of the machine learning model based on the one or more loss values (or e.g., some value derived from a combination of the one or more loss values, e.g., a combined loss value comprising a combination of the one or more loss values), thereby training the machine learning model. The computer system can use any appropriate technique to update the parameter set, e.g., using backpropagation, stochastic gradient descent, etc. In some embodiments, the machine learning model can be trained over a series of training rounds as part of an iterative training process. Thus in some embodiments, the plurality of training model outputs can be generated over the series of training rounds, the one or more loss values can be determined over the series of training rounds, and the parameter set of the machine learning model can be updated over the series of training rounds.

As a more specific example, in each training round, a batch of training sets of images can be sampled from the plurality of training sets of images. Training model outputs can be generated based on masked images from the sampled batch. Loss values can be determined based on such training model outputs and corresponding images from the sampled batch, and the parameter set of the machine learning model can be updated based on these loss values, thereby training the machine learning model. The iterative training process can be performed until a terminating condition has been met. In some embodiments, the terminating condition can comprise a defined number of training rounds, and the terminating condition can be met if a total number of training rounds performed equals or exceeds the defined number of training rounds. In other embodiments, the terminating condition can comprise a convergence condition. This terminating condition can be met if the set machine learning model parameters converge, e.g., exhibit little to no change in consecutive training rounds. If the terminating condition has not been met, the computer system can sample a new batch of training sets of images and repeat the iterative training process until the terminating condition has been. At this point, the machine learning models parameters can be fixed, and the machine learning model can be used to perform inpainting for novel view synthesis, e.g., using methods described further below or any other applicable NVS methods.

In some embodiments, the machine learning model can comprise a diffusion model (e.g., a u-net diffusion model). Diffusion models typically consist of a forward process and a reverse process [Ho et al. 2020; Song et al. 2021]. The forward process q(xₜ|x₀, t) converts data x₀~p_{data}(x) into Guassian noise x_{T}~ [symbol] (0, I) by gradually adding noise at each step t∈{1, . . . , T}, and the learned reverse process p_{θ}(xₜ₋₁|xₜ, t) transforms random Gaussian noise to a new sample with a denoising network ∈_{θ}. At each denoising step, the network Ee is supervised by

$${min}_{θ} {𝔼}_{x ∼ {p}_{d ata} , ϵ ∼ 𝒩 ( 0 , I ) , t ∼ 𝒰 ( T )} {‖ ϵ - {ϵ}_{θ} ( {x}_{t} , t ) ‖}_{2}^{2}$$

where ∈ is the Gaussian noise, and xₜ denotes the noisy sample at step t. By learning to estimate the added noise with ∈_{θ}, diffusion models are able to generate new data samples (e.g., inpainted images) via iterative denoising.

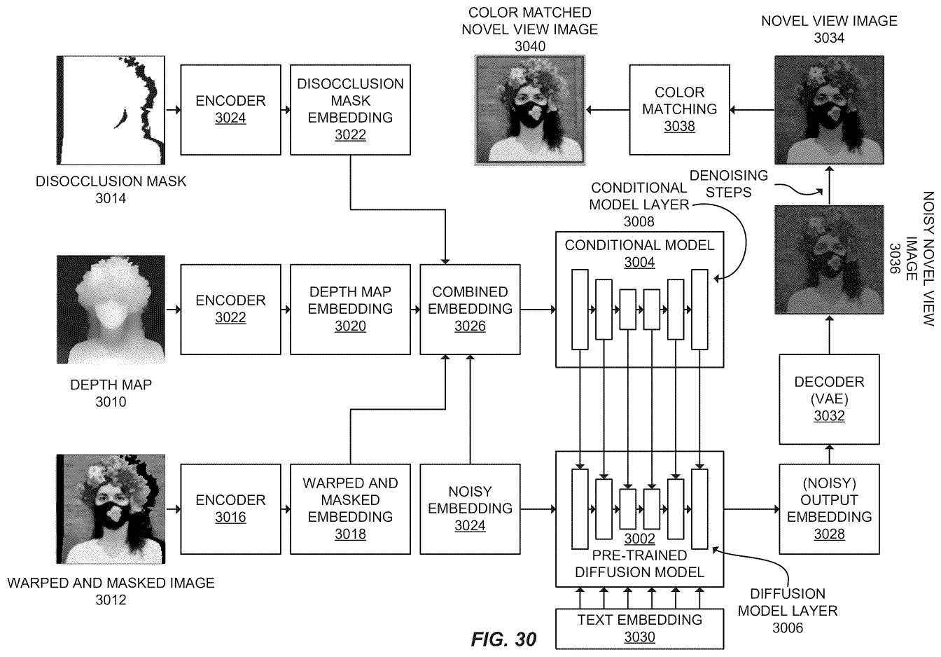

In some embodiments, the machine learning model can comprise one of the machine learning models described in more detail in the following section. Methods for training such models are described in more detail further below. In summary however, in some embodiments the machine learning model can comprise a pre-trained diffusion model defined by a set of pre-trained diffusion model parameters and a conditional model defined by a set of conditional model parameters (e.g., as depicted in FIG. 30). In such cases, the computer system may only train the conditional model, e.g., iteratively updating a set of conditional model parameters based on the plurality of training sets of images. In some embodiments, the computer system can initially set the set of conditional model parameters equal to the set of pre-trained diffusion model parameters (e.g., via model “cloning”), then train the conditional model by iteratively updating the set of conditional model parameters based on the plurality of training sets of images.

As described above, in some embodiments, images in the single-view dataset can be masked using random masks in addition to occlusion masks. Experiments show that the use of random masks in addition to disocclusion masks can reduce inpainting artifacts. FIG. 11 compares the effect of denoising the same image using machine learning models according to embodiments trained with more or less random masking (i.e., different values of a parameter p_{rand}) and the same fixed random seed. Inpainted image 1102 was generated using a machine learning model trained with p_{rand}=0. Inpainted image 1104 was generated using a machine leaning model trained with p_{rand}=0.15. Inpainted image 1106 was generated using a machine learning model trained with p_{rand}=0.3. As shown in FIG. 11, the visual artifacts on the right side of the person's arm are reduced with increasing p_{rand}.

There are various ways that random masks can be incorporated into machine learning model training. In some embodiments, the computer system can train the machine learning model for a certain number of iterations using only random masks. After this checkpoint, the computer system can train the machine learning model using disocclusion masks. In other embodiments, the computer system can mix both types of masks during training, e.g., replacing disocclusion masks with random masks with some probability p_{rand} for each training sample in each iteration. Experiments suggest that this second alternative may achieve better performance.

### B. Generating Training Data via Aligned Synthesis and Splatting Error Simulation

As described above, some embodiments are directed to methods for generating aligned training pairs from multi-view datasets using training pair alignment and splatting error simulation. Such methods generally improve the quality of training data used to train machine learning models to perform NVS tasks. As a result, NVS models trained using training data generated using methods according to embodiments can achieve better performance on NVS tasks.

Even in cases where multi-view datasets are available, there are various issues with existing methods of generating training data used to train inpainting based NVS models. As described above, training a machine learning model to perform NVS by inpainting warped images usually involves training data pairs comprising warped images (or “splatted images”) generated from an input view image and target view images (ground-truth images). Generally, given a depth map d and camera pose data (also referred to as “viewpoint data elements” as described above, e.g., indicating the relative position and orientation of viewpoint(s) used during a warping process), naive training methods often construct training data pairs {v_{tgt}, x_{tgt}} via v_{tgt}=Render(x_{src}, d, p), where Render(·) denotes a novel view rendering method (e.g., a warping process, such as a point cloud render [Yu et al. 2024]) and x_{src}, x_{tgt}, and v_{tgt} correspond to a source input view image, a target view image, and a rendered view image, respectively. Afterwards, a machine learning model can be trained to predict the target view image x_{tgt} conditioned on the rendered view image v_{tgt}. However, the conditioning rendered view image v_{tgt} often shows different texture and geometry with the target view image x_{tgt} due to several factors, e.g., different lighting and depth estimation error.

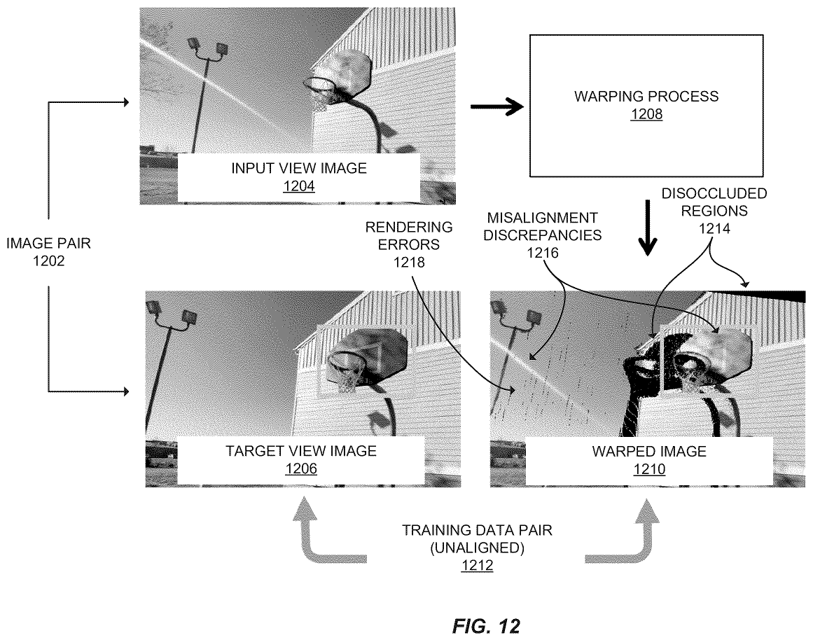

This problem is generally depicted in FIG. 12, which visually depicts a naive method for generating a training data pair using images from a multi-view image dataset. An image pair 1202 can be selected from the multi-view image dataset. The image pair can comprise two images that generally depict the same scene but from different viewpoints. One of these two images can be used as the input view image (e.g., input view image 1204), and the other image can be used as a target view image (e.g., target view image 1206). A warped image (or “splatted image”) 1210 can be generated from the input view image 1204 using a warping process 1208 (e.g., point cloud rendering). The target view image 1206 and the warped image 1210 can be used as a training data pair 1212 used to train a machine learning model. The machine learning model could be trained to generate target view images based on warped images, e.g., by inpainting disoccluded regions 1214 of warped image 1210. The target view images 1206 can be used as ground-truth images to evaluate the machine learning model's performance during training.

Unfortunately, this training data generation method can lead to unaligned training data pairs due to misalignment discrepancies between target view images and warped images, including inconsistent geometry and brightness. FIG. 12 shows misalignment discrepancies 1216, generally corresponding to a lens flare and different lighting conditions on the backboard of a depicted basketball hoop. Even though input view image 1204 and target view image 1206 generally depict the same scene, there are various discrepancies between these images which can have various causes, e.g., different lighting conditions when the images were photographed.

Training machine learning models using such “misaligned” training data pairs often results in diffusion models with sub-par NVS performance, e.g., diffusion models that produce novel view images that are inconsistent with their input view images. During training, an inpainting model may inadvertently learn to inpaint regions of warped images corresponding to misalignment discrepancies and rendering errors, which can result in random inpainting when the model is used to perform NVS after training is complete. This issue is generally shown in FIG. 13, which shows a warped image (or pixel-splatted image) 1302 and two novel view images 1304 and 1306. FIG. 13 also shows an unknown region map 1308 corresponding to warped image 1302. This unknown region map 1308 can generally correspond to regions of the warped image 1302 that were disoccluded as a result of the warping process. FIG. 13 further shows a difference map 1310 corresponding to novel view image 1304 and a difference map 1312 corresponding to novel view image 1306. Each difference map generally shows the difference between the corresponding novel view image and a ground-truth image (not pictured). Novel view image 1304 was generated using ViewCrafter methods and without using training data generated using methods according to embodiments. As shown in difference map 1310, the ViewCrafter model performed a considerable amount of inpainting throughout the entire novel view image 1304. This “hallucinated texture” has resulted in visual artifacts in the novel view image 1304, such as a discontinuity in the tiger's back (visual artifact 1314).

Some methods according to embodiments address this problem by generating pixel-aligned training pairs, as described in more detail below. These methods can enable geometrically consistent view synthesis by preventing many of the misalignment errors resulting from naive training pair generation methods, enabling precise control of target viewpoints and enforcing geometry and brightness consistency between views. Machine learning models trained using such training pairs can generate more plausible novel view images with less visual artifacts. As shown in FIG. 13, a machine learning model, trained using training data generated using methods according to embodiments, was used to generate novel view image 1306. As shown by comparison of unknown region map 1308 and difference map 1312, model inpainting was largely confined to unknown regions of warped image 1302, and there is considerably less hallucinated texture and visual artifacts in novel view image 1306.

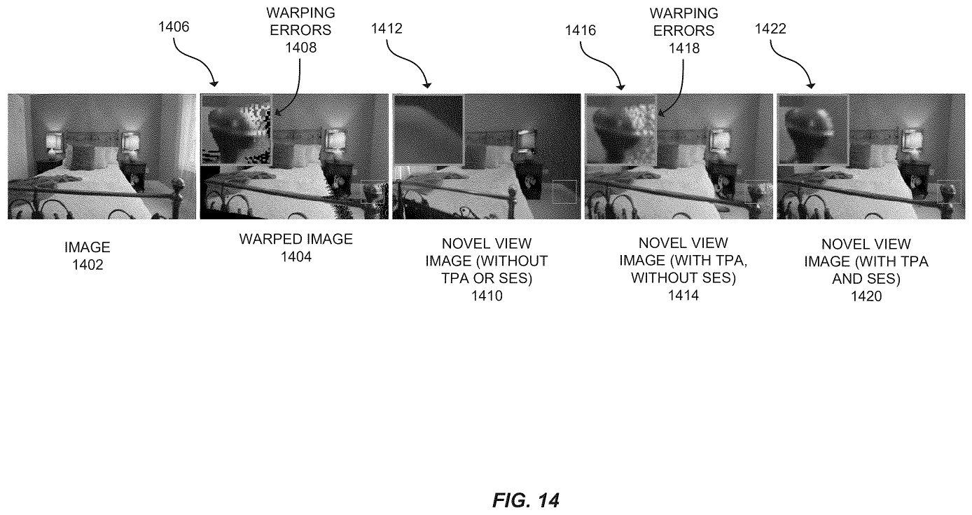

FIG. 14 generally summarizes the benefits of training data generation methods according to embodiments, including training pair alignment (TPA) and splatting error simulation (SES) methods (described in more detail further below). FIG. 14 shows an image 1402 as well as a corresponding warped image 1404, generated e.g., using depth-based pixel-splatting. As shown in detail box 1406 of warped image 1404, warped image 1404 has warping errors 1408, i.e., flying pixel errors caused by the warping process. FIG. 14 also shows a novel view image 1410 generated using a machine learning model that was not trained using training data generated using training data methods according to embodiments i.e., was trained without training pair alignment or splatting error simulation. While the contents of novel view image 1410 is generally plausible, it does not accurately reflect the geometry of the warped image, as shown by detail box 1412. FIG. 14 further shows novel view images generated using machine learning models that were trained using training data generated using training data generation methods according to embodiments, i.e., novel view image 1414 and 1420. Novel view image 1414 was generated by a machine learning model trained using aligned training data, but without splatting error simulation. As shown by detail box 1416, novel view image 1414 matches the geometry of the warped image 1404 better than novel view image 1410 but contain warping errors 1418. Novel view image 1420 was generated by a machine learning model trained using aligned training data with spatting error simulation. As shown in detail box 1422, machine learning models trained using both aligned training data and splatting error simulation can generate realistic high-fidelity novel view images without warping errors.

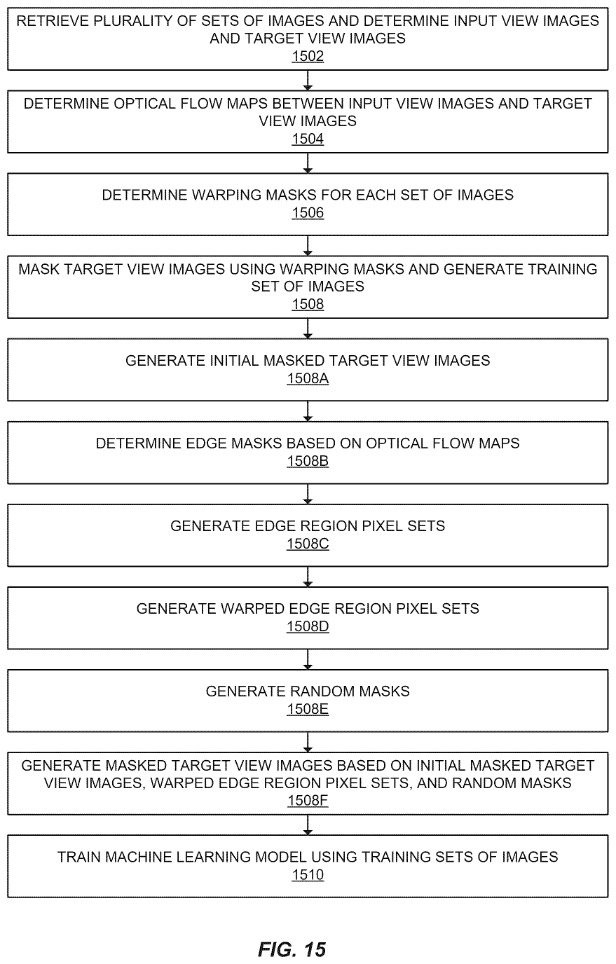

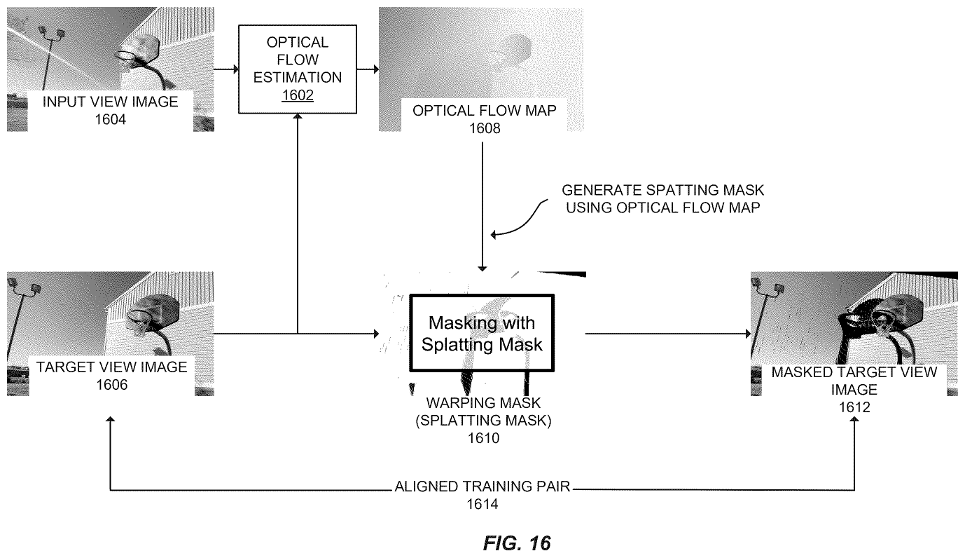

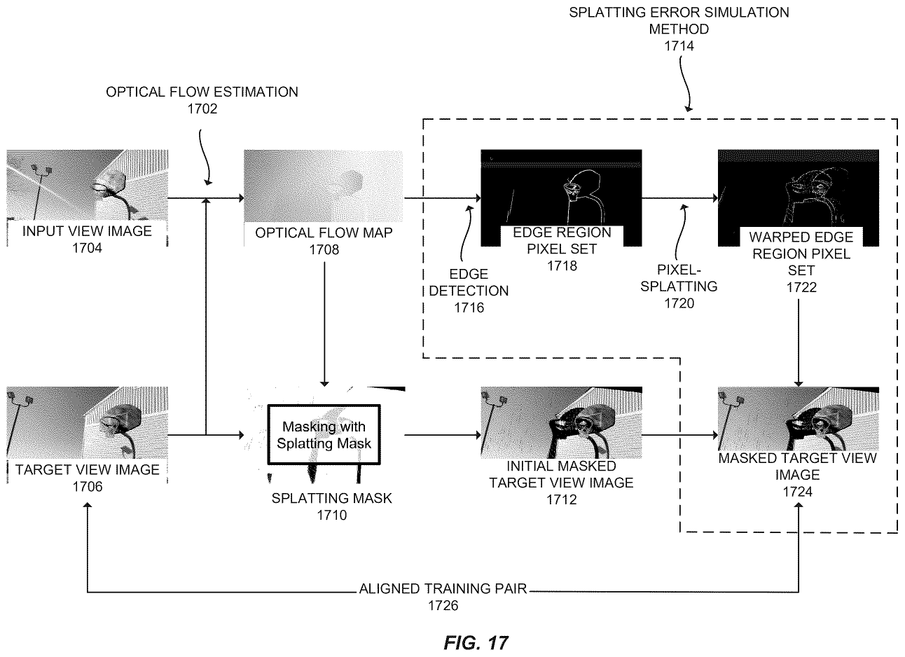

A method for training a machine learning model to generate novel view images corresponding to warped images is described below with reference to the flowchart of FIG. 15, as well as FIGS. 16 and 17. The method can be performed by a computer system, e.g., as described above with reference to FIG. 4 or below with reference to FIGS. 52 and 53. In general terms, instead of generating machine learning model conditioning from an input view image x_{src}, a computer system according to embodiments can use a target view image x_{tgt} to construct aligned training data pairs, reducing the discrepancy between masked images and ground-truth images used for training, thereby better training machine learning models to address warping errors and reducing the prevalence of hallucinated texture.

At step 1502, the computer system can retrieve a plurality of sets of images. In some embodiments, the computer system can retrieve the plurality of sets of images from a database, data stream, a local memory such as a hard drive, cloud storage, an I/O interface, the Internet, or any other appropriate source. In other embodiments, the computer system can comprise a server computer that provides machine learning based NVS services for client computers. In such embodiments, the computer system can receive the plurality of sets of images from a client computer (or from any other appropriate source, e.g., a URL provided by the client computer), e.g., over a communication network such as the Internet, as described above with reference to FIG. 4.

The plurality of sets of images can correspond to or comprise a multi-view image dataset. Each set of images can comprise multiple depictions of an object or scene from different viewpoints. For each set of images, the computer system can determine an input view image and a target view image from the set of images. FIG. 16 shows an input view image 1604 and a target view image 1606. In some cases, the computer system can determine the input view image and the target view image from each set of images based on image labels, e.g., one image in a set of images may be labeled as an input view image and each other image in a set of images may be labeled as a target view image. In other cases, the computer system can determine the input view images and the target view images arbitrarily; as long as a view transformation (e.g., an optical flow) can be determined between the input view image and the target view image, it may not matter which image is specifically selected as the input view image and which image is selected to be the target view image (assuming they are not the same image). As such, in some embodiments the computer system can determine the input view image and the target view image randomly for each set of images.

The computer system can perform various steps (described below) for each set of images in the plurality of sets of images. In this way, the computer system can generate a plurality of training sets of images that can be used to train a machine learning model. Each training set of images can comprise a target view image and a corresponding masked target view image. The computer system can train the machine learning model to inpaint the masked target view images using the corresponding images as ground-truth image to evaluate the machine learning model's performance during training.

At step 1504, for each set of images, the computer system can determine an optical flow map by performing an optical flow estimation process between the input view image and the target view image. The computer system can use any appropriate optical flow estimation process, e.g., the optical flow estimation process disclosed by Xu et al. 2023. FIG. 16 shows an optical flow map 1608 generated by using an optical flow estimation process 1602. This optical flow map 1608 shows the optical flow between input view image 1604 and target view image 1606 and could be used to warp the input view image 1604 to the target view image 1606.

At step 1506, for each set of images, the computer system can determine a warping mask mₛₚₗₐₜ (also referred to as a “splatting mask”) based on a corresponding optical flow map, e.g., via optical flow guided pixel-splatting. Similar to occlusion and disocclusion masks described above, the warping map can indicate valid (and invalid) warping regions in optical flow guided pixel-splatting, e.g., identifying which pixels would be defined and undefined in a warped image. FIG. 16 shows a warping mask 1610 that can be generated using optical flow map 1608. The computer system can use various methods or techniques to determine warping masks based on optical flow masks, e.g., similar to those described above with reference to step 506 of FIG. 5. For example, the computer system could iterate through each pixel in an input view image and assign it to a corresponding warped image pixel set based on a warping process (e.g., softmax pixel-splatting) and the optical flow map. The computer system could then determine the corresponding warping mask based on these warped image pixel sets. As an example, the computer system could determine that warped image pixel sets that are assigned zero pixels correspond to invalid splatting regions and that warped image pixel sets that are assigned one or more pixels correspond to valid splatting regions. The computer system can generate the warping mask based on these determinations.

At step 1508, for each set of images, the computer system can mask the target view image x_{tgt} using a corresponding warping mask mₛₚₗₐₜ, thereby generating a masked target view image \tilde{v}_{tgt}. In this way the computer system can generate a plurality of masked target view images corresponding to a plurality of target view images. There are various ways that the computer system can mask each target view image. For example, in some embodiments the computer system can mask the target view image using the warping mask by combining the target view image and the warping mask via element-wise multiplication or element-wise conjunction, i.e., \tilde{v}_{tgt}=x_{tgt} [symbol] mₛₚₗₐₜ. As another example, each warping mask can indicate one or more pixel locations in the target view image, and the computer system can mask each target view image with its warping mask by setting one or more pixel values associated with the one or more pixel locations in the target view image to a default value, e.g., associated with a default color, e.g., completely black or completely white. FIG. 16 shows a masked target view image 1612 comprising target view image 1606 masked using warping mask 1610.

The computer system can generate a training set of images for each set of images. Each training set of images can comprise a target view image x_{tgt} and a masked target view image \tilde{v}_{tgt} (e.g., masked using a warping mask as described above), i.e., each training set of images can comprise a tuple {x_{tgt}, \tilde{v}_{tgt}}which can be referred to as an “aligned training pair”. FIG. 16 shows an aligned training pair 1614 comprising target view image 1606 and masked target view image 1612. By generating a training set of images for each set of images, the computer system can generate a plurality of training sets of images. During training, each target view image can comprise a ground-truth image and the corresponding masked target view image can comprise an input image used to train a machine learning model. The output of the machine learning model can then be compared to the corresponding ground-truth image to evaluate the performance of the machine learning model, calculate one or more loss values, update machine learning model parameters, etc. As the masked target view images are aligned with their corresponding target view image in both geometry and texture, machine learning models trained using training sets of images generated using methods according to embodiments can learn to adhere to the conditioned view, producing consistent novel views (e.g., as shown by novel view image 1306 in FIG. 13 and as discussed above).

In some embodiments, each set of images can comprise more than two images, e.g., some sets of images can comprise three or more images showing an object or scene from three or more viewpoints. The computer system can use these additional images to generate additional masked target view images, which can be included in the training sets of images, e.g., to improve the quality of training. As such, in some embodiments, each training set of images can comprise a target view image, a masked target view image, and one or more additional masked target view images. For each set of images, the computer system can determine one or more additional target view images. The computer system can likewise determine one or more additional optical flow maps by performing an optical flow estimation process between the input view image and each additional target view image. The computer system can determine one or more additional warping masks based on the one or more additional optical flow maps and can mask the one or more additional target view images using the one or more additional warping masks, thereby generating the one or more additional masked target view images. The computer system can use any appropriate method or technique to perform optical flow estimation processes, determine additional warping masks, mask the additional target view images, etc., e.g., similar to those described above with reference to steps 1504-1508.

At this point, the computer system can train the machine learning model using the plurality of training sets of images, e.g., as described below with reference to step 1510 of the flowchart of FIG. 15. The training data generation method described above can greatly improve the consistency between input view images and novel view images generated using machine learning models trained using the plurality of training sets of images. However, model performance can be further improved by incorporating splatting error simulation into training data generation methods according to embodiments. Due to the existence of splatting errors in warped images, machine learning models can be misled by splatting errors (e.g., “flying pixel” errors), resulting in visual artifacts, which can arise from inaccuracies in transformation maps, blurred depth discontinuities, smooth transitions, or inaccurate estimation of depth edges [Shih et al. 2020]. As a result, pixels around object boundaries can be projected to incorrect positions in warped images, leading to distorted geometry and flying pixels.

To address this, in some embodiments a computer system can perform splatting error simulation methods to improve machine learning model robustness against splatting errors. These splatting error simulation methods can generally correspond to optional steps 1508A-1508F of the flowchart of FIG. 15. Splatting error simulation methods are also visualized in FIG. 17, which shows a splatting error simulation method 1714.

At step 1508A, for each set of images, the computer system can mask the target view image using the warping mask, thereby generating an initial masked target view image (as described above). FIG. 17 shows an initial masked target view image 1712, which is generally the same as masked target view image 1612 of FIG. 16. The computer system can further mask this initial masked target view image in steps 1508B-1508F (as described below) in order to simulate splatting errors.

At step 1508B, for each set of images, the computer system can determine an edge mask m_{edge} based on the optical flow map. In some embodiments, the computer system can determine the edge mask using a Sobel operator (also referred to as the Sobel-Feldman operator, a Sobel filter, etc.). FIG. 17 shows an edge detection process 1716 (e.g., a Sobel operator) applied to optical flow map 1708, thereby generating the edge mask (not pictured), which can be used to generate an edge region pixel set 1718 e_{src}, as described below with reference to step 1508C.

At step 1508C, for each set of images, the computer system can generate an edge region pixel set e_{src} by extracting a plurality of edge pixels from the input view image x_{src} using the edge mask m_{edge}. In some embodiments, the computer system can generate the edge region pixel set by combining the input view image x_{src} and the edge mask m_{edge} via element-wise multiplication or element-wise conjunction, e.g., e_{src}=x_{src}⊙m_{edge}. As described above, FIG. 17 shows an edge region pixel set 1718.

At step 1508D, for each set of images, the computer system can generate a warped edge region pixel set e_{tgt} by warping the edge region pixel set using the optical flow map, e.g., using any appropriate optical flow guided warping method. FIG. 17 shows a warped edge region pixel set 1722 generated by warping the edge region pixel set 1718 using pixel-splatting operation 1720.

At step 1508E, for each set of images, the computer system can generate a random mask mₑᵣᵣₒᵣ, which can indicate locations to simulate splatting errors in masked target view images. Various types of random masks can be used in methods according to embodiments, and the computer system can perform various random mask generation methods. As a non-limiting example, the random mask could comprise, e.g., a random binary array, and the computer system could generate the random mask by randomly assigned the binary values 0 or 1 to locations in the array based on some probability distribution. As another example, the random mask generation method could be similar to the random mask generation methods described above with reference to FIG. 7.

At step 1508F, the computer system can generate the masked target view image \hat{v}_{tgt} based on the initial masked target view image \tilde{v}_{tgt}, the warped edge region pixel set e_{tgt}, and the random mask mₑᵣᵣₒᵣ. In some embodiments, in order to generate the masked target view image, the computer system can determine a randomly masked edge region pixel set by combining the random mask mₑᵣᵣₒᵣ and the warped edge region pixel set e_{tgt}, e.g., e_{tgt}⊙mₑᵣᵣₒᵣ. The computer system can further determine an inverse random mask (1−mₑᵣᵣₒᵣ) and generate a randomly masked target view image by combining the inverse random mask and the initial masked target view image v_{tgt}, e.g., via element-wise multiplication or element-wise conjunction, e.g., \tilde{v}_{tgt}⊙(1−mₑᵣᵣₒᵣ). The computer system can then generate the masked target view image \hat{v}_{tgt} by combining the randomly masked edge region pixel set and the randomly masked target view image, e.g., additively, via element-wise disjunction, etc. Expressed in other terms, in some embodiments \hat{v}_{tgt}=e_{tgt}⊙mₑᵣᵣₒᵣ+v_{tgt}⊙(1−mₑᵣᵣₒᵣ). The masked target view image \hat{v}_{tgt} can comprise a masked image corresponding to the target view image with simulated splatting errors.

Afterwards, as described above, the computer system can generate a training set of images for each set of images. Each training set of images can comprise a target view image x_{tgt} and a masked target view image \hat{v}_{tgt}, i.e., each training set of images can comprise a tuple {x_{tgt}, \hat{v}_{tgt}}(sometimes referred to as an “aligned training pair”). FIG. 17 shows an aligned training pair 1726 comprising target view image 1706 and masked target view image 1724. By training using such training sets of images, machine learning models can learn to correct splatting errors introduced during NVS.

At step 1510, the computer system can train the machine learning model using the plurality of training sets of images. In this way, the method described herein with reference to FIG. 15 can be used to train a machine learning model to generate novel view images (e.g., by inpainting warped image) using training pair alignment and splatting error simulation, thereby reducing splatting errors and hallucinated texture, thereby improving NVS performance.

There are various ways that a machine learning model can be trained using the plurality of training pairs of images, and general examples are provided below. As an example, in some embodiments, the computer system can generate a plurality of training model outputs by applying a plurality of masked target view images from the plurality of training sets of images to the machine learning model. The computer system can then determine one or more loss values based on a comparison between the plurality of training model outputs and the plurality of target view images. As an example, if training model outputs are similar to their corresponding target view images, the loss values may have lower values, while if the training model outputs are dissimilar to their corresponding target view images, the loss values may have higher values. Afterwards, the computer system can update a parameter set of the machine learning model based on the one or more loss values (or e.g., some value derived from a combination of the one or more loss values, e.g., a combined loss value comprising a combination of the one or more loss values), thereby training the machine learning model. The computer system can use any appropriate technique to update the parameter set, e.g., using backpropagation, stochastic gradient descent, etc. In some embodiments, the machine learning model can be trained over a series of training rounds as part of an iterative training process. Thus in some embodiments, the plurality of training model outputs can be generated over the series of training rounds, the one or more loss values can be determined over the series of training rounds, and the parameter set of the machine learning model can be updated over the series of training rounds.

As a more specific example, in each training round, a batch of training sets of images can be sampled from the plurality of training sets of images. Training model outputs can be generated based on masked target view images from the sampled batch. Loss values can be determined based on such training model outputs and corresponding target view images from the sampled batch, and the parameter set of the machine learning model can be updated based on these loss values, thereby training the machine learning model. The iterative training process can be performed until a terminating condition has been met. In some embodiments, the terminating condition can comprise a defined number of training rounds, and the terminating condition can be met if a total number of training rounds performed equals or exceeds the defined number of training rounds. In other embodiments, the terminating condition can comprise a convergence condition. This terminating condition can be met if the set machine learning model parameters converge, e.g., exhibit little to no change in consecutive training rounds. If the terminating condition has not been met, the computer system can sample a new batch of training sets of images and repeat the iterative training process until the terminating condition has been. At this point, the machine learning model's parameters can be fixed, and the machine learning model can be used to perform inpainting for novel view synthesis, e.g., using methods described further below or any other applicable NVS methods.

In some embodiments, the machine learning model can comprise a diffusion model (e.g., a u-net diffusion model). Diffusion models typically consist of a forward process and a reverse process [Ho et al. 2020; Song et al. 2021]. The forward process q(xₜ|x₀, t) converts data x₀~p_{data}(x) into Guassian noise x_{T}~ [symbol] (0, I) by gradually adding noise at each step t∈{1, . . . , T}, and the learned reverse process p_{θ}(xₜ₋₁|xₜ,t) transforms random Gaussian noise to a new sample with a denoising network ∈₀. At each denoising step, the network ∈₀ is supervised by

$${min}_{θ} {𝔼}_{x ∼ {p}_{data} , ϵ ∼ 𝒩 ( 0 , I ) , t ∼ 𝒰 ( T )} {‖ ϵ - {ϵ}_{θ} ( {x}_{t} , t ) ‖}_{2}^{2}$$

where ∈ is the Gaussian noise, and xₜ denotes the noisy sample at step t. By learning to estimate the added noise with ∈_{θ}, diffusion models are able to generate new data samples (e.g., inpainted images) via iterative denoising.

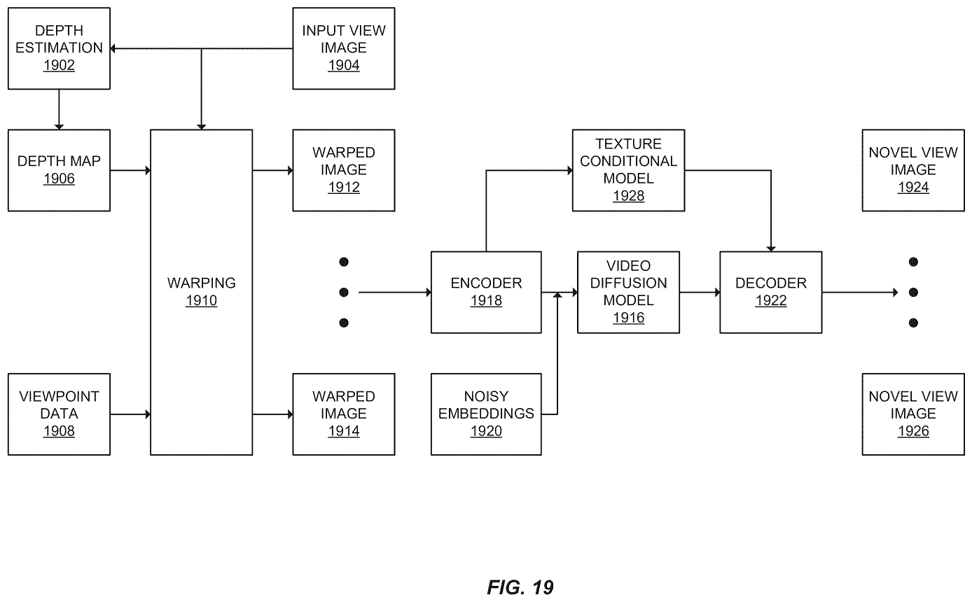

In some embodiments, the machine learning model can comprise one of the machine learning models described in more detail in the following section. Such machine learning models are described in more detail further below. In summary however, in some embodiments the machine learning model can comprise an encoder, a video diffusion model, a decoder, and a textual conditional model (e.g., as depicted in FIG. 19). The encoder can comprise one or more encoder layers and the decoder can comprise one or more decoder layers. The computer system can generate a plurality of training model outputs by applying a plurality of masked target view images from the plurality of training sets of images to the video diffusion model. The computer system can determine one or more loss values based on a comparison between the plurality of training model outputs and a plurality of target view images from the plurality of training sets of images. The computer system can update a parameter set of the video diffusion model based on the one or more loss values, thereby training the video diffusion model.

In some embodiments, the computer system can first encode each target view image of the plurality of training sets of images using the encoder, thereby generating a plurality of target view embeddings. The computer system can apply the plurality of target view embeddings to the video diffusion model to generate a plurality of output target view embeddings. The computer system can decode the plurality of output target view embeddings using the decoder to generate the plurality of training model outputs, which can then be used to update the parameter set of the video diffusion model (and potentially parameter sets of the encoder and decoder) as described above.

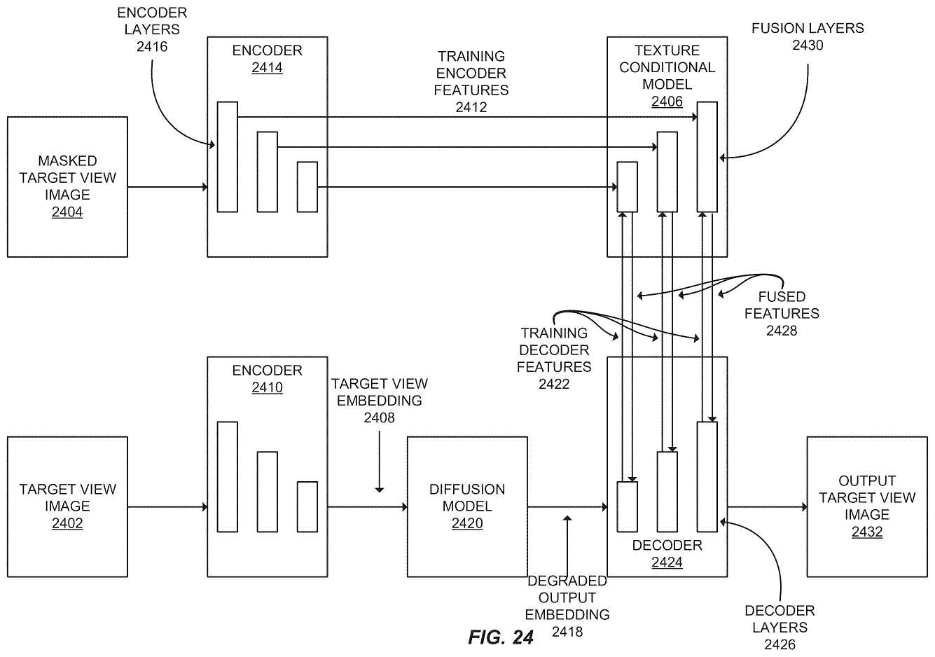

In some embodiments, training the machine learning model can comprise training the texture conditional model (i.e., with or without training the other components of the machine learning model, such as the video diffusion model). The computer system can encode each target view image of the plurality of training sets of images, thereby generating a plurality of target view embeddings. The computer system can encode each masked target view image of the plurality of training sets of images, thereby generating a plurality of sets of training encoder features corresponding to the one or more encoder layers. The computer system can apply each target view embedding of the plurality of target view embeddings to the video diffusion model, which can be configured to generate degraded embeddings. In this way the computer system can generate a plurality of degraded output embeddings. The computer system can apply each degraded output embedding of the plurality of degraded output embeddings to the decoder, thereby generating a plurality of sets of training decoder features corresponding to the one or more decoder layers. The computer system can combine the plurality of sets of training decoder features and the plurality of sets of training encoder features using the texture conditional model, thereby generating a plurality of sets of fused features. The computer system can apply the plurality of sets of fused features to the one or more decoder layers, thereby generating a plurality of output target view images. The computer system can determine one or more loss values by comparing the plurality of output target view images and the plurality of target view images corresponding to the plurality of training sets of images. In some embodiments, the one or more loss values can comprise an absolute difference loss value and a perceptual loss value. The computer system can update a parameter set of the texture conditional model based on the one or more loss values, thereby training the texture conditional model. Methods or processes for training texture conditional models according to embodiments are described in more detail further below with reference to FIG. 24.

### VI. Performing Novel View Synthesis Using Machine Learning

As described above, some embodiments of the present disclosure are directed to methods for performing NVS using machine learning models. Such methods can generally follow the framework described above with reference to FIG. 1, e.g., first a computer system can determine warping constraints (e.g., a depth map) using techniques such as depth estimation. The computer system can use these warping constraints to warp an input view image to generate a warped image (or “splatted image”), e.g., using pixel-splatting. The computer system can then use a machine learning model to inpaint the warped image, thereby generating a novel view image.

These methods can generally be divided into four categories: (A) methods for generating multiple visually consistent novel view images using a video diffusion model, (B) methods for performing image-to-image diffusion using a texture conditional model, (C) methods for generating novel view images using a dual-branch diffusion model and depth maps, and (D) methods for generating novel view videos using a mapping machine learning model. It should be noted that while methods for performing image-to-image diffusion can be used to improve the quality of novel view images generated using methods according to embodiments, they can also be applied to more general image-to-image diffusion applications to improve the quality of generated images.

In general terms, these methods can address various problems that can arise during NVS. By repurposing a video diffusion model (generally used to achieve temporal consistency between generated images), methods (A) can be used to generate novel view images that are more spatially consistent between multiple viewpoints. This can be useful for generating 3D stereoscopic images (e.g., for VR applications) in which the illusion of 3D requires visual consistency between images displayed to users. By using a texture conditional model, a computer system performing methods (B) can improve image-to-image diffusion results by mitigating texture hallucination. By using a dual-branch diffusion model and depth maps, machine learning models according to methods (C) can generate higher quality novel view images by adapting pre-trained inpainting models to the specific task of NVS. By using mapping machine learning models, methods (D) can be used to generate consistent texture between sequential frames of novel view video, reducing the number and intensity of flickering and other visual artifacts. As such, these methods can generally improve performance on NVS tasks, as discussed in more detail in the Experiments and Visual Results section further below.

### A. Generating Visually Consistent Novel View Images Using Video Diffusion

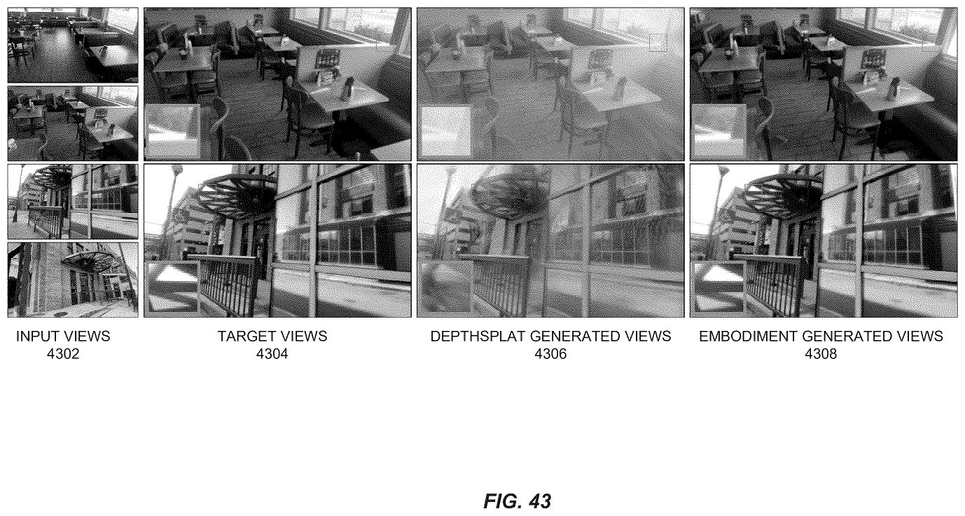

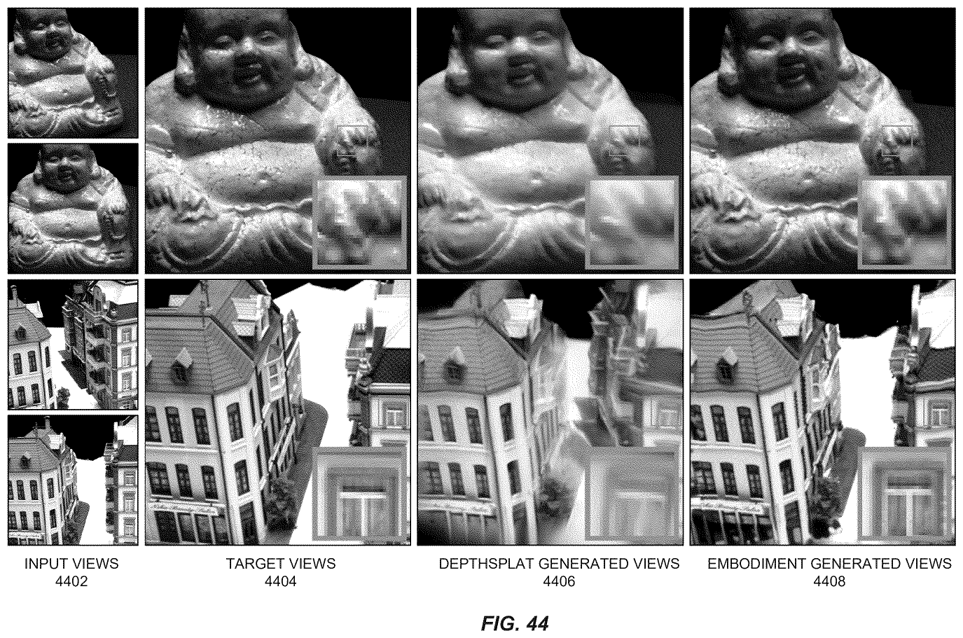

As described above, some embodiments are directed to methods for generating multiple visually consistent novel views using a video diffusion model. As described further above, there are various challenges associated with generating high-fidelity novel view images from single or sparse input views. Splatting-based methods often employ pixel-splatting, point clouds, and 3D Gaussian splatting to generate novel views. However, due to limited geometric cues, novel view images generated using splatting-based approaches often have splatting errors and distorted geometry. While 3D Gaussians can theoretically model complex visual effects (e.g., view-dependent appearance), estimating accurate Gaussian parameters (such as opacity) from limited observations remains a challenge. In addition, the estimation errors of Gaussian parameters often result in artifacts and cloudy effects (floaters) in novel views, yielding worse visual results than pixel-splatting (see e.g., FIGS. 43 and 44, discussed in the Experiments and Visual Results section further below). Diffusion-based approaches directly generate novel view images via diffusion and generally produce more plausible geometry, but their generative nature can result in hallucinated texture in generated novel view images.

Some methods according to embodiments however, related to using a pixel-splatting-guided approach to generate novel view images using a video diffusion model, leveraging the strengths (and addressing the weaknesses) of splatting-based approaches and diffusion based-approaches. When input observations are limited, warped (e.g., pixel-splatted) images often exhibit disocclusion regions that vary across different viewpoints. However, by training on large-scale video datasets, a generative video diffusion model according to embodiments can gain a deep understanding of visual elements such as geometry and texture. By leveraging video diffusion priors, methods according to embodiments can be used to generate realistic and consistent scenes across multiple novel view images. The innovative use of pixel-splatting-guided video diffusion models to generate spatially-consistent novel view images (as opposed to temporally-consistent video) enables the generation of novel view images with consistent geometry and high-fidelity details. With about 2.5 days of training on a single GPU, machine learning models according to embodiments deliver state-of-the-art performance in single-view NVS and various zero-shot scenarios across different NVS tasks. As described in more detail below in the Experiments and Visual Results section, methods according to embodiments perform well in single-view NVS, sparse-view NVS, and stereo video conversion, demonstrating strong cross-domain and cross-task performance, even when trained specifically for single-view NVS tasks, as shown in FIG. 3 (see e.g., detail box 306 and the various reported PSNR and FID values 308).

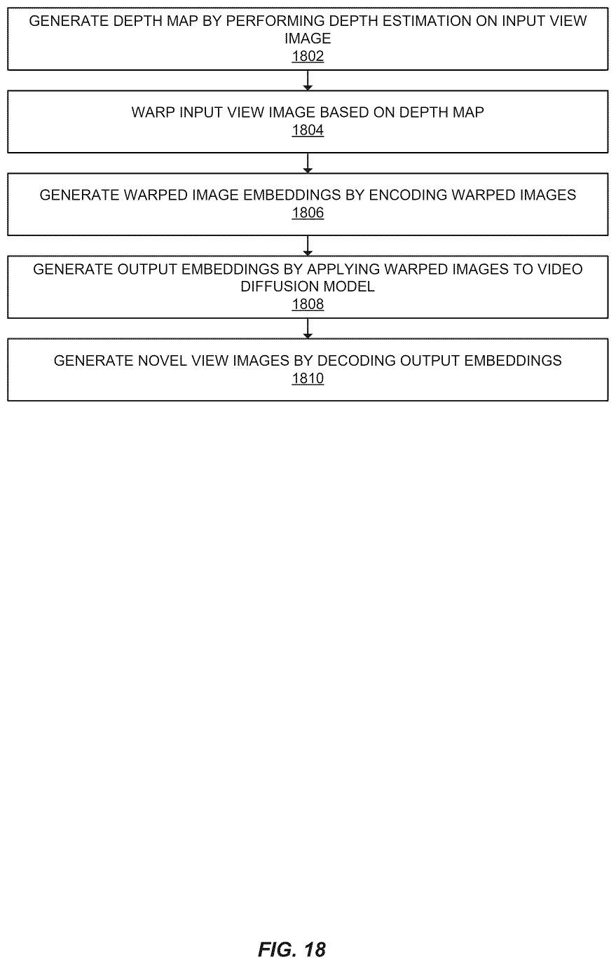

A method for generating a plurality of novel view images corresponding to an input view image using a video diffusion model is described below with reference to the flowchart of FIG. 18 and the block diagram of FIG. 19. The method can be performed by a computer system, e.g., as described above with reference to FIG. 4 or below with reference to FIGS. 52 and 53.

At step 1802, the computer system can generate a depth map based on the input view image. As described above, the depth map can indicate the “depth” of each pixel in the input view image, e.g., the distance between that pixel and a viewpoint for the image (e.g., a point in space corresponding to an idealized pinhole camera). In some embodiments, the computer system can perform a depth estimation process (e.g., a monocular depth estimation process) in order to generate the depth map. FIG. 19 shows a depth map 1906 generated from an input view image 1904 using a depth estimation process 1902. Various “off-the-shelf” depth estimation methods can be used in methods according to embodiments, including depth estimation models such as MiDaS, DepthFM, Marigold, and Depth Anything.

In some embodiments, the depth map can comprise a disparity map comprising a plurality of disparity values corresponding to a plurality of pixels in the input view image. In such embodiments, the computer system can generate an initial depth map using a depth estimation process (e.g., a monocular depth estimation process), and the initial depth map can comprise a plurality of depth values corresponding to the plurality of pixels in the input view image, e.g., as described above. The computer system can then invert each depth value Z of a plurality of depth values based on a first disparity parameter a and a second disparity parameter b, thereby generating the plurality of disparity values d and the disparity map, e.g., according to a formula such as

$$d = a \cdot \frac{1}{z} - b ,$$

in which the first disparity parameter a and the second disparity parameter b can comprise constants chosen by practitioners of methods according to embodiments based on any number of criteria, as described in more detail further above. Each disparity map can comprise an array of corresponding disparity values d.

At step 1804, the computer system can warp the input view image using the depth map, thereby generating a plurality of warped images. The computer system can use any appropriate warping process to warp the input view image, as described further above, e.g., performing a softmax pixel-splatting operation in the input view image (see e.g., [Mehl et al. 2024; Niklaus and Liu 2020]), which can resolve splatting collisions and assign pixel importance based on the depth map, give higher blending weights to foreground objects, preserve the geometric layout of objects in the input view image, etc. In some embodiments, the computer system can generate a plurality of view transformation maps using the depth map and viewpoint data, which can be used to project pixels from the input view image to the plurality of warped images. FIG. 19 shows a warping process 1910 performed on input view image 1904 using depth map 1906 and viewpoint data 1908, thereby generating warped images 1912-1914. Each of these warped images can correspond to a different viewpoint of a plurality of viewpoints corresponding to viewpoint data 1908. As described above, rather than directly warping each image using a corresponding depth map, the computer system can warp each image using a corresponding disparity map derived from a corresponding depth map.

In some embodiments, the computer system can warp the input view image by assigning each pixel in the input view image to a corresponding warped image pixel set of a plurality of warped image pixel sets based on the warping process and the depth map. In this way, the computer system can determine one or more corresponding warped image pixel sets. Each warped image pixel set can generally correspond to a pixel in a warped image, i.e., each pixel assigned to a given warped image pixel set can generally comprise a pixel from an image that would be mapped to a pixel coordinate in the corresponding warped image. Therefore, the plurality of warped image pixel sets can generally comprise a mapping between the input view image and the plurality of warped images. In some embodiments, in order to assign each pixel in each image to a corresponding warped pixel set, the computer system can determine a warped pixel coordinate for each pixel based on a corresponding depth value in the depth map (or a corresponding disparity value in the disparity map). In this way the computer system can determine a plurality of warped pixel coordinates. These warped pixel coordinates can generally indicate the new location of these pixels in a warped image. The computer system can then assign each pixel to a warped pixel set corresponding to its determined warped pixel coordinates.

After iterating through all the pixels in the input view image, each warped image pixel set may be assigned zero or more pixels from the image. A warped image pixel set assigned zero pixels generally indicates that no pixels from the image map to a corresponding pixel location in a warped image. These pixels are generally undefined in warped images and correspond to disoccluded regions, which can be inpainted by the video diffusion model in order to perform NVS (e.g., as described below). If necessary, the computer system can determine a plurality of disocclusion masks based on the warped image pixel sets, e.g., by iterating through the warped image pixel sets and identifying warped image pixel sets that are assigned zero pixels from the image.

As described above, if a warped image pixel set is assigned more than one pixel, it generally indicates that multiple pixels from the input view image map to a pixel coordinate in a warped image corresponding to that warped image pixel set. However, as most two-dimensional images comprise arrays of pixels in which each pixel coordinate is occupied by exactly one pixel, warping processes generally involve resolving pixel “collisions” in warped images, e.g., scenarios in which multiple pixels map to the same warped pixel coordinate. In general terms, for each warped image pixel set comprising more than one pixel, a computer system can perform collision resolution by select one pixel assigned to that warped image pixel set to retain, removing the rest of the pixels.

As such, in some embodiments the computer system can determine a primary pixel (sometimes referred to as a “top” pixel ptp) for each warped image pixel set, thereby determining a plurality of primary pixels. These primary pixels can comprise pixels that would be visible in the plurality of warped images generated using the warping process. These can comprise, e.g., pixels with the least depth value or highest disparity value in their respective warped image pixel set. Such pixels can correspond to objects in the foreground of the input view image, which may occlude other objects (e.g., corresponding to pixels with higher depth values or lower disparity values) in a warped image as a result of a warping process. As such, in some embodiments, the computer system can determine the primary pixel for each warped image pixel set by determining (for each warped image pixel set) a pixel with a lowest corresponding depth value or a highest corresponding disparity value based on the depth (or disparity) map. The pixel with the lowest corresponding depth value or highest corresponding disparity value can comprise the primary pixel.

As described above (and depicted in FIG. 19), in some embodiments, the computer system can warp the input view image using the depth map and a plurality of viewpoint data elements corresponding to a plurality of viewpoints. Each warped image of the plurality of warped images can correspond to a viewpoint of the plurality of viewpoints. For example, if there are five viewpoint data elements, the computer system could generate five warped images. As described above, viewpoint data elements can generally quantify or qualify the viewpoint corresponding to the image. In some embodiments, each viewpoint data element can comprise virtual camera position vector indicating a position of a virtual camera in a three-dimensional virtual space and a virtual camera orientation vector indicating an orientation of the virtual camera in the three-dimensional virtual space. In some embodiments, each virtual camera position vector can comprise an x-coordinate, a y-coordinate, and a z-coordinate, e.g., corresponding to the position of a virtual camera in a three-dimensional Euclidean space. In some embodiments, each virtual camera orientation vector can comprise a polar angle and an azimuthal angle, indicating the angular orientation of a corresponding virtual camera.

In other embodiments, each viewpoint data element can comprise a virtual camera positional displacement vector indicating a spatial displacement of the virtual camera between a camera view in the input view image and a camera view corresponding to the viewpoint data element (and the warp), in addition to a virtual camera orientation displacement vector indicating an orientation displacement between the camera view in the input view image and the camera view corresponding to the viewpoint data element (and the warp). In some embodiments, each virtual camera positional displacement vector can comprise an x-displacement, a y-displacement, and a z-displacement. In some embodiments, each virtual camera orientation displacement vector can comprise a polar angle displacement and an azimuthal angle displacement.

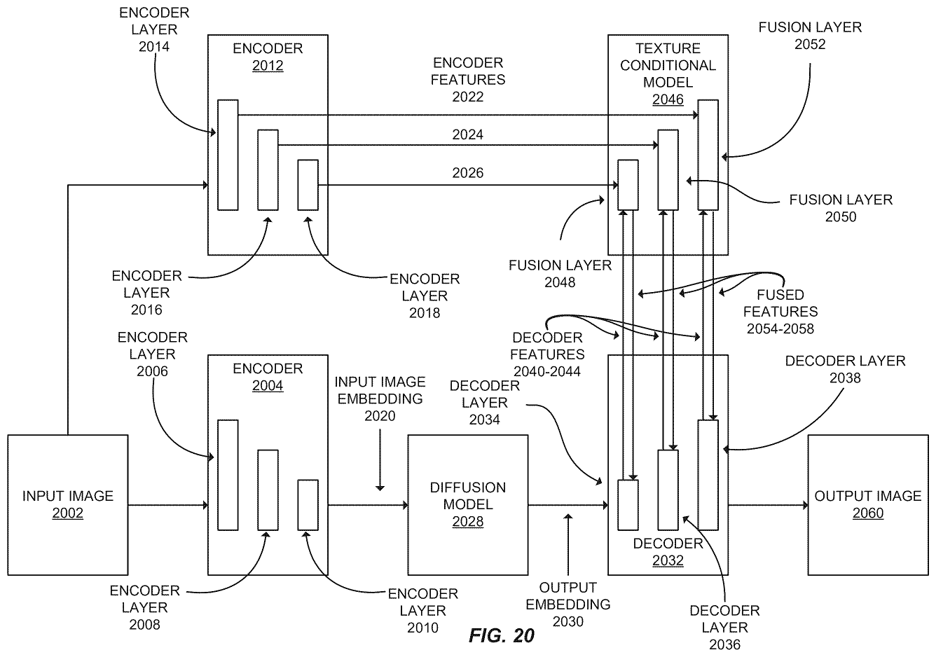

At step 1806, the computer system can encode the plurality of warped images x∈ [symbol] , thereby generating a plurality of warped image embeddings z∈ [symbol] . In some embodiments, the warped image embeddings can be concatenated together to produce a combined embedding Z=Cat({z}). In some embodiments, the computer system can encode each warped image by applying the warped image to an encoder, thereby encoding the plurality of warped images. FIG. 19 shows an encoder 1918. In some embodiments, the encoder can comprise one or more encoder layers. In general terms, each encoder layer may encode features of the plurality of warped images at different feature scales. As such, in some embodiments, the computer system can use the encoder to generate a plurality of sets of encoder features when encoding the plurality of warped images. Each set of encoder features can correspond to a warped image of the plurality of warped images and each set of encoder features can comprise one or more encoder features corresponding to the one or more encoder layers. In other words, for each warped image, the computer system can generate an encoder feature for each encoder layer. FIG. 20 (described in more detail further below) shows a machine learning model comprising encoders 2004 and 2012 and encoder layers 2006-2010 and 2014-2018. As described in more detail further below, these encoder features can be used to inject high-fidelity texture information from the plurality of warped images into generated novel view images, thereby reducing texture hallucination and improving novel view image quality. The computer system can use a texture conditional model for this purpose. FIG. 19 shows a texture conditional model 1928.

At step 1808, the computer system can generate a plurality of output embeddings by applying the plurality of warped image embeddings to the video diffusion model (FIG. 19 shows a video diffusion model 1916). As described above, diffusion models typically consist of a forward process and a reverse process [Ho et al. 2020; Song et al. 2021]. The forward process q(xₜ|x₀, t) converts data x₀~p_{data}(x) into Guassian noise x_{T}~ [symbol] (0, I) by gradually adding noise at each step t∈{1, . . . , T}, and the learned reverse process p_{θ}(xₜ₋₁|xₜ, t) transforms random Gaussian noise to a new sample with a denoising network ∈_{θ}. At each denoising step, the network ∈_{θ} is supervised by

$${min}_{θ} {𝔼}_{x ∼ {p}_{data} , ϵ ∼ 𝒩 ( 0 , I ) , t ∼ 𝒰 ( T )} {‖ ϵ - {ϵ}_{θ} ( {x}_{t} , t ) ‖}_{2}^{2}$$

where ∈ is the Gaussian noise, and xₜ denotes the noisy sample at step t. By learning to estimate the added noise with Ee, diffusion models are able to generate new data samples (e.g., inpainted images) via iterative denoising.

As such, in some embodiments the computer system can generate one or more noisy embeddings (FIG. 19 shows noisy embeddings 1920). The computer system can apply the plurality of warped image embeddings and the one or more noisy embeddings to the video diffusion model to generate the plurality of output embeddings. In some embodiments, the computer system can concatenate the plurality of warped image embeddings and the one or more noisy embeddings, thereby generating a combined embedding. The computer system can then apply the combined embedding to the video diffusion model, thereby generating the plurality of output embeddings. In some embodiments, applying the combined embedding to the video diffusion model can generate a combined output embedding that the computer system can then decompose into the plurality of output embeddings.

At step 1810, the computer system can decode the plurality of output embeddings, thereby generating a plurality of novel view images. In some embodiments, the computer system can decode the plurality of output embeddings by applying the plurality of output embeddings to a decoder comprising one or more decoder layers. FIG. 19 shows novel view images 1924-1926 and decoder 1922.

In some embodiments, the computer system can use a texture conditional model to inject texture high fidelity texture information from the plurality of warped images into the plurality of novel view images. Like the encoder, the decoder can additionally comprise one or more decoder layers, e.g., as depicted in FIG. 20, which can be used to generate sets of decoder features. In some embodiments, the computer system can combine sets of encoder features and sets of decoder features to create “fused features”, which can be decoded to generate the plurality of novel view images.

As such, in some embodiments, the computer system can apply the plurality of output embeddings to the decoder, thereby generating a plurality of sets of decoder features. Each set of decoder features can correspond to a warped image of the plurality of warped images, and each set of decoder features can comprise one or more decoder features corresponding to the one or more decoder layers. In other words, for each output embedding, the computer system can generate a decoder feature for each decoder layer. The computer system can then combine each set of encoder features (generated using the encoder, e.g., at step 1806 described above) and a corresponding set of decoder features using a texture conditional model, thereby generating a plurality of sets of fused features. The computer system can apply the plurality of sets of fused features to the one or more decoder layers, thereby generating the plurality of novel view images.

In some embodiments, the video diffusion model can be trained using training data generated using training data generation methods according to embodiments, e.g., using aligned synthesis and splatting error simulation methods according to embodiments. When trained in this manner, the video diffusion model can be used to generate geometrically aligned image contents and correct potential distortions caused by warping errors.

As such, in some embodiments the computer system can train the video diffusion model prior to the steps described above (e.g., prior to generating the depth map at step 1802). There are various ways that the video diffusion model can be trained, e.g., as described above with reference to FIG. 15. As an example, the computer system can retrieve a plurality of training sets of images (e.g., generated using training data generation methods according to embodiments, retrieved from a stereoscopic image database, etc.). Each training set of images can comprise a target view image and a masked target view image. The computer system can generate a plurality of training model outputs by applying a plurality of masked target view images from the plurality of training sets of images to the video diffusion model. The computer system can determine one or more loss values based on a comparison between the plurality of training model outputs and a plurality of target view images from the plurality of training sets of images. The computer system can update a parameter set of the video diffusion model based on the one or more loss values, thereby training the video diffusion model. In some embodiments, the video diffusion model can be trained over a series of training rounds as part of an iterative training process. Thus in some embodiments, the plurality of training model outputs can be generated over the series of training rounds, the one or more loss values can be determined over the series of training rounds, and the parameter set of the machine learning model can be updated over the series of training rounds.

### B. Image-to-Image Diffusion Using Texture Conditional Model

As described above, some embodiments are directed to methods for performing image-to-image diffusion using a texture conditional model. Although image-to-image diffusion models can generate relatively high-quality images, generated novel view images can contain hallucinated textures that are inconsistent with input images. In NVS methods according to embodiments, one potential solution is to preserve textures from input view images by utilizing warped images (e.g., splatted views). However, directly blending splatting views and diffusion model outputs is difficult because splatted views often contain aliasing artifacts such as jagged edges, and may further exhibit blurred details due to resampling, which can degrade the quality of diffusion model outputs. However, by using a texture conditional model, embodiments of the present disclosure can mitigate texture hallucination in generated images. While a texture conditional model can be used to improve the quality of novel view images generated using methods according to embodiments (e.g., as described above with reference to FIGS. 18 and 19), it should be understood that methods according to embodiments for performing image-to-image diffusion using a texture conditional model can be applied to various image-to-image diffusion tasks other than NVS.

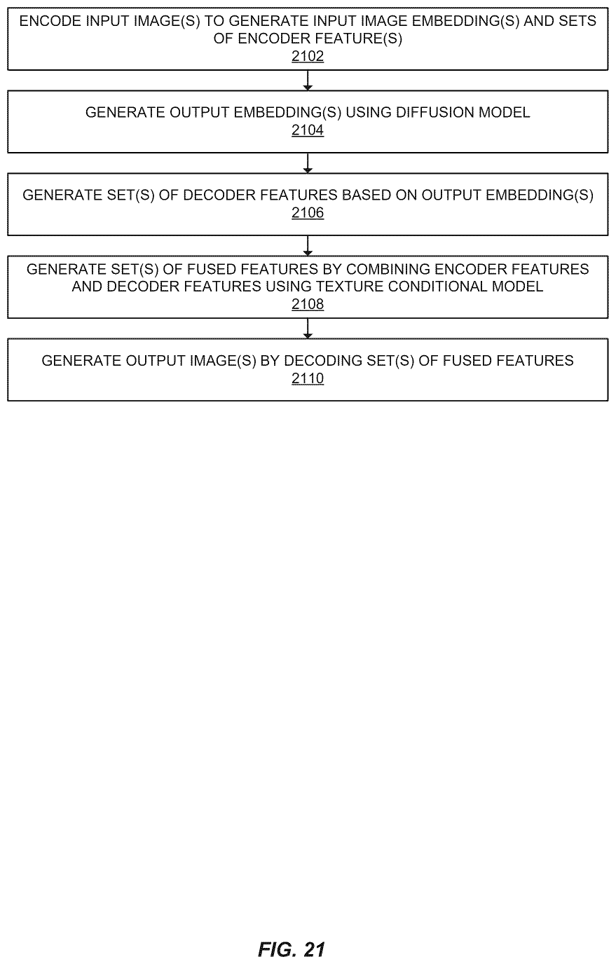

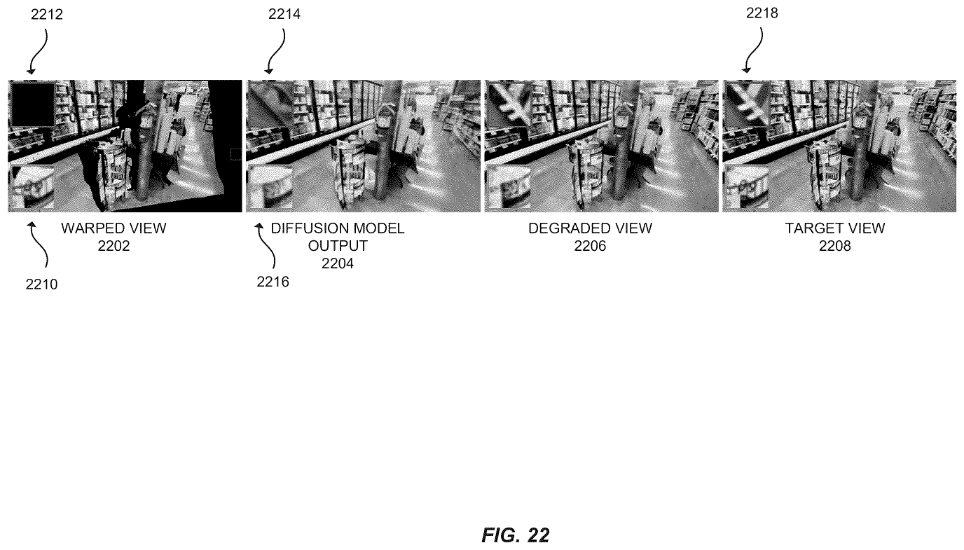

A method for generating one or more output images based on one or more input images using a machine learning model comprising an encoder, a diffusion model, a decoder and a texture conditional model is described below with reference to the block diagrams of FIG. 20 and the flowchart of FIG. 21. Further, a method for training a texture conditional model is described with reference to the flowchart of FIG. 22 and the block diagram of FIG. 24. Such methods can be performed by a computer system, e.g., as described above with reference to FIG. 4 or below with reference to FIGS. 52 and 53.

Referring to FIG. 20, in summary, rather than directly constructing an output image 2060 by decoding an output embedding 2030 (generating using diffusion model 2028) using a decoder 2032, a computer system according to embodiments can adaptively combine (or “fuse”) encoder features 2022-2026 and decoder features 2040-2044 using texture conditional model 2046. The resulting fused features 2054-2058 can then be decoded using decoder 2032 to generate output image 2060. Because the encoder features 2022-2026 generally correspond to the appearance (or “texture”) of the input image 2002, and because the decoder features 2040-2044 generally correspond to the appearance (or texture) of the output image 2060, the texture conditional model 2046 effectively enables the computer system to “inject” texture detail from the input image 2002 into the output image 2060. As a result, the appearance and texture of the output image 2060 can more closely match the appearance and texture of the input image 2002, particularly for “fine-grained” or high-frequency texture detail. This can be particularly useful in NVS applications involving diffusion models, which often have trouble recreating high-frequency texture detail due to texture hallucinations or blurring effects.

Feature fusion according to embodiments is “adaptive” because the texture conditional model can be trained to place more or less emphasis on encoder features and decoder features, e.g., “weighing” encoder features more heavily during some fusion operations and weighing decoder features more heavily in other fusion operations. In general terms, a texture conditional model 2046 can primarily rely on encoder features 2022-2026 when those encoder features are of higher quality (e.g., correspond to regions of warped image 2002 that do not have warping errors) and/or similar decoder features of are lower quality (e.g., corresponding to regions of output image 2060 with texture hallucination). Likewise, the texture conditional model 2046 can primarily rely on decoder features 2040-2044 when those decoder features are of higher quality (e.g., corresponding to regions of output image 2060 without texture hallucinations) and/or similar encoder features are of lower quality (e.g., corresponding to regions of input images that have errors).

Referring to FIG. 21, at step 2102, the computer system can encode one or more input images, thereby generating one or more input image embeddings and one or more sets of encoder features. The computer system can generate the one or more input image embeddings and the one or more sets of encoder features using an encoder. Herein, let

$${f}_{enc}^{i}$$

represent an i-th scale encoder feature, e.g., referring to FIG. 20, the output of encoder layer 2014 can comprise a first scale encoder feature 2022

$${f}_{enc}^{1} ,$$

while the output of encoder layer 2016 can comprise a second scale encoder feature 2024

$${f}_{enc}^{2} ,$$

and the output of encoder layer 2018 can comprise a third scale encoder feature 2026

$${f}_{enc}^{3} .$$

Each set of encoder features can correspond to an input image of the one or more input images. Each set of encoder features can comprise one or more encoder features corresponding to one or more encoder layers. For example, encoder 2004 of FIG. 20 comprises three encoder layers 2014-2018 from which a computer system can generate three encoder features 2022-2026. Each encoder layer of the one or more encoder layers can correspond to a different feature scale of one or more feature scales. Likewise, each encoder feature can correspond to a feature scale of one or more feature scales. In general terms, each encoder layer can encode successively “more general” detail from the input image.

At step 2104, the computer system can use the diffusion model to generate one or more output embeddings. In some embodiments, the diffusion model can comprise a U-Net diffusion model. In some embodiments, the diffusion model can comprise a video diffusion model. In some embodiments, the computer system can generate one or more noisy embeddings and combine the one or more input image embeddings and the one or more noisy embeddings to generate one or more combined embeddings (e.g., via concatenation). The computer system can apply the one or more combined embeddings to the diffusion model, thereby generating one or more output embeddings. FIG. 20 shows an output embedding 2030 generated by applying input image embedding 2020 to diffusion model 2028.

At step 2106, the computer system can apply the one or more output embeddings to the decoder, thereby generating one or more sets of decoder features. Each set of decoder features can correspond to an input image of the one or more input images. Each set of decoder features can comprise one or more decoder features corresponding to one or more decoder layers. Each decoder layer of the one or more decoder layers can correspond to a different feature scale of the one or more feature scales. Likewise, each decoder feature in each set of decoder features can correspond to a feature scale of the one or more feature scales. Herein let

$${f}_{dec}^{i}$$

represent an i-th scale decoder feature, e.g., the output of decoder layer 2034 can comprise a third scale decoder feature

$${f}_{dec}^{3} ,$$

while the output of decoder layer 2036 can comprise a second scale decoder feature

$${f}_{dec}^{2}$$

and the output of decoder layer 2038 can comprise a first scale encoder feature

$${f}_{dec}^{1} .$$

In general terms, each decoder layer can decode successively more detail from the one or more output embeddings.

At step 2108, the computer system can combine each set of encoder features and a corresponding set of decoder features using the texture conditional model, thereby generating one or more sets of fused features. In some embodiments the texture conditional model can comprise one or more fusion layers that the computer system can use to combine the sets of encoder features and decoder features and generate one or more sets of fused features

$${f}_{fuse}^{i} = {Fuse}_{i} ( {f}_{enc}^{i} , {f}_{dec}^{i} ) .$$

Each fusion layer of the one or more fusion layers can correspond to a different feature scale of one or more feature scales. In some embodiments, each fusion layer can comprise a sequence of two or more residual blocks or one or more self-attention blocks, although it should be understood that more advanced fusion layer architectures can be used to achieve better performance. In some embodiments, for each encoder feature in each set of encoder feature, the computer system can determine a corresponding decoder feature in a corresponding set of decoder features. The computer system can then generate a fused feature by combining that encoder feature and the corresponding decoder feature using a corresponding fused feature. By performing this process for each set of encoder features, the computer system can generate one or more sets of fused features.

Step 2108 may be better understood with reference to FIG. 20. The machine learning model of FIG. 20 generally corresponds to three feature scales. Encoder 2012 comprises three encoder layers 2014-2018. Likewise, decoder 2032 comprises three decoder layers 2034-2036 and texture conditional model 2046 comprises three fusion layers 2048-2052. A computer system can use fusion layers 2048-2052 to fuse encoder features and decoder features from corresponding feature layers. For example, the computer system can use fusion layer 2052 to merge encoder feature 2022 (generated using encoder layer 2014) and decoder feature 2044 (generated using decoder layer 2038), thereby generating fused feature 2058. Likewise, encoder feature 2024 and decoder feature 2042 can be merged using fusion layer 2050 (generating fused feature 2056) and encoder feature 2026 and 2040 can be fused using fusion layer 2048 to generate fused feature 2054.

At step 2110, the computer system can apply the one or more sets of fused features to the one or more decoder layers, thereby generating one or more output images. As depicted in FIG. 20, the computer system can input each fused feature 2054-2058

$${f}_{fuse}^{i}$$

into a corresponding decoder layer 2034-2038 of the decoder 2032, thereby generating the output image 2060. By performing multi-scale fusion in this manner, a computer system according to embodiments can effectively aggregate fine-grained features to achieve higher-quality image synthesis, thereby reducing texture hallucination.

As described above, the use of a texture conditional model can be applied to various image-to-image diffusion tasks, including NVS. For example, In some embodiments the one or more images can comprise a plurality of warped images corresponding to an input view image, and the one or more output images can comprise a plurality of novel view images corresponding to the input view image, e.g., as depicted in FIG. 19, which shows the use of a video diffusion model 1916 and a texture conditional model 1928 to generate novel view images 1924-1926 based on warped images 1912-1914. As such, the computer system can perform various steps prior to encoding the one or more input view image. For example, in some embodiments the computer system can generate a depth map based on the input view image. The computer system can then warp the input view image using the depth map, thereby generating the plurality of warped images. The computer system can use various methods to generate depth maps and warp the input view image, e.g., as described in more detail above.

In some embodiments, the computer system can train the diffusion model and the texture conditional model prior to performing the steps described above. The computer system can use any of the various training processes describe herein, e.g., by retrieving training data comprising pairs of images and masked images, applying the masked images to the machine learning model in the manner described above (e.g., by encoding the masked images to generate a masked image embeddings, applying the masked image embeddings to a diffusion model, applying encoder features to the texture conditional model, etc.) thereby generating training model outputs, determining one or more loss values by comparing the training model outputs to the images from the training data, and updating a parameter set of the diffusion model and the texture conditional model based on the one or more loss values. Such a training process could be performed over a series of training rounds, e.g., one or more loss values can be determine over the series of training rounds, the parameter set of the diffusion model and the texture conditional model can be updated over the series of training rounds, etc.

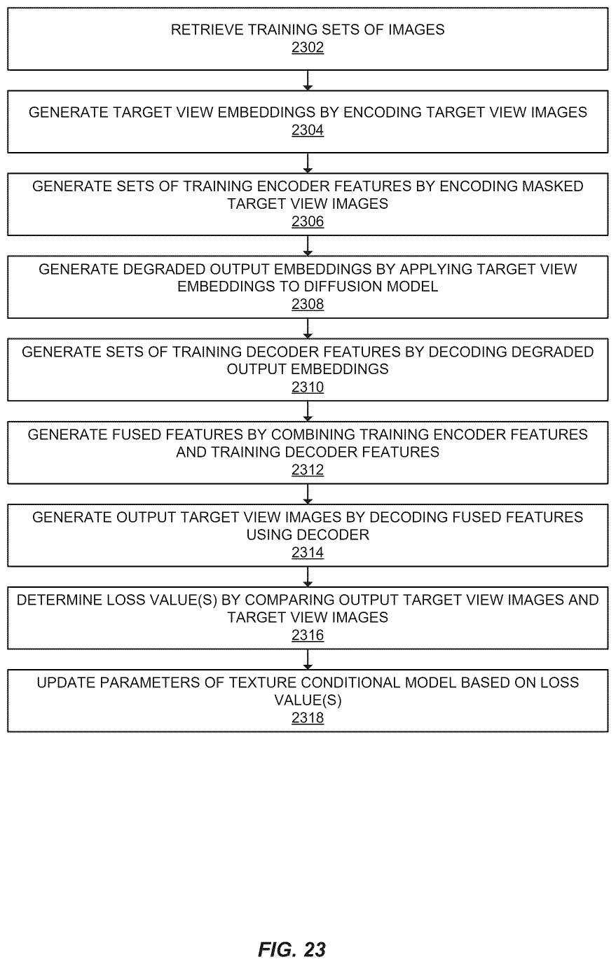

However, training in this manner can result in sub-par training performance due to differences between generated novel view images and ground-truth images (e.g., non-masked images from training data pairs) in disoccluded regions. Some embodiments address this by providing for methods of training texture conditional models using texture degradation, described in more detail below with reference to the flowchart of FIG. 23 and block diagram of FIG. 24. In general, the computer system can use the diffusion model to intentionally degrade the texture of ground-truth images using the diffusion model, thereby simulating a degraded view with hallucinated texture. The texture conditional model can then be trained using the degraded view. In this way, the texture conditional model can be trained to address texture hallucination through adaptive feature fusion.

Texture degradation methods according to embodiments may be better understood with reference to FIG. 22, which shows a warped view 2202, a diffusion model output 2204, a degraded view 2206, and a target view 2208. As shown in the figure, the warped view 2202 generally shows more accurate texture (see e.g., zoom-in region 2210), but also contains unknown regions (see e.g., zoom-in region 2212). As described herein, a diffusion model can generate reasonable content for the unknown regions (see e.g., zoom-in region 2214), but can hallucinate unrealistic texture (see e.g., zoom-in region 2216). As such, using diffusion model outputs for texture conditional model training can lead to sub-optimal training performance due to the inconsistent contents in the unknown regions (compare e.g., the contents of zoom-in region 2214 corresponding to diffusion model output 2204 and the contents of zoom-in region 2218 comprising the ground-truth contents of target view 2208).

By contrast, better training performance can be achieved using degraded views. As shown in FIG. 22, degraded view 2206 has similar content as the target view 2208, while imitating the effects of texture hallucination in diffusion model outputs. By training using degraded views instead of diffusion model outputs, texture conditional models according to embodiments learn to better rely on generated contents for unknown regions while maintaining the ability to detect hallucinated textures. As a result, texture conditional models according to embodiments can detect and address warping errors and hallucinated textures, e.g., in the context of NVS or in other image-to-image diffusion tasks.

In more detail, with reference to FIG. 23, at step 2302, the computer system can retrieve a plurality of training sets of images. Each training set of images can comprise a masked target view image and a target view image. Such training sets of images can be generated using training data generation methods described herein, e.g., using training pair alignment and splatting error simulation, as described above. FIG. 24 shows a target view image 2402 and a masked target view image 2404 which can be used to train texture conditional model 2406

At step 2304, the computer system can encode each target view image of the plurality of training sets of images, thereby generating a plurality of target view embeddings, e.g., using an encoder. FIG. 24 shows a target view embedding 2408 generated by encoding target view image 2402 using encoder 2410.

At step 2306, the computer system can encode each masked target view image of the plurality of training sets of images, thereby generating a plurality of sets of training encoder features corresponding to one or more encoder layers. FIG. 24 shows training encoder features 2412 generated using an encoder 2414 comprising encoder layers 2416.

At step 2308, the computer system can apply each target view embedding of the plurality of target view embeddings to the diffusion model. The diffusion model can be configured to generate degraded embeddings. In this way, the computer system can generate a plurality of degraded output embeddings. These degraded output embeddings can simulate texture hallucinations, enabling the texture conditional model to learn to address texture hallucination through adaptive feature fusion. FIG. 24 shows degraded output embedding 2418 generated by applying target view embedding 2408 to diffusion model 2420.

At step 2310, the computer system can apply each degraded output embedding of the plurality of degraded output embeddings to a decoder, thereby generating a plurality of sets of training decoder features corresponding to one or more decoder layers. FIG. 24 shows training decoder features 2422 generated by applying degraded output embedding 2418 to a decoder 2424 comprising decoder layers 2426.

At step 2312, the computer system can combine the plurality of sets of training decoder features and the plurality of sets of training encoder features using the texture conditional model, thereby generating a plurality of sets of fused features. FIG. 24 shows a set of fused features 2428 generated by combining training encoder features 2412 and training decoder features 2422 via the fusion layers 2430 of texture conditional model 2406.

At step 2314, the computer system can apply the plurality of sets of fused features to the one or more decoder layers, thereby generating a plurality of output target view images. FIG. 24 shows an output target view image 2432 generated by applying fused features 2428 to decoder layers 2426.

At step 2316, the computer system can determine one or more loss values by comparing the plurality of output target view images and a plurality of target view images corresponding to the plurality of training sets of images. In some embodiments, the one or more loss values can comprise an absolute difference loss value (e.g., an [symbol] loss [symbol] and a perceptual loss [symbol] [Zhang et al. 2018]. That is, a combined loss value [symbol] can comprise a combination of the absolute difference loss value [symbol] and the perceptual loss [symbol] , e.g., [symbol] , where α is a hyperparameter. In some implementations of methods according to embodiments, α=0.1 was used in order to train a texture conditional model.

At step 2318, the computer system can update a parameter set of the texture conditional model based on the one or more loss values, thereby training the texture conditional model. As described above, such a process can be performed e.g., iteratively and over a series of training rounds.

### C. Generating Novel View Images Using Dual-Branch Diffusion and Depth Maps

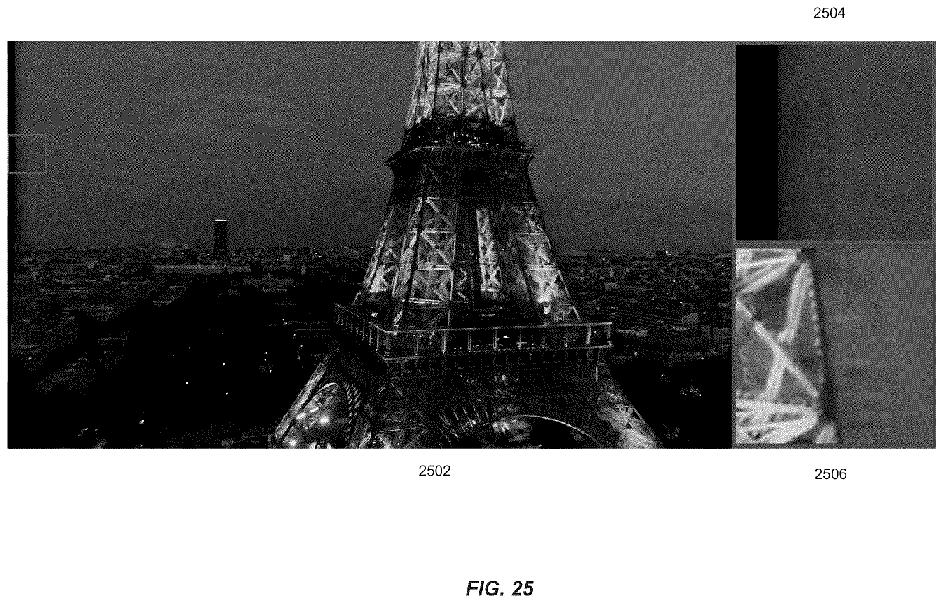

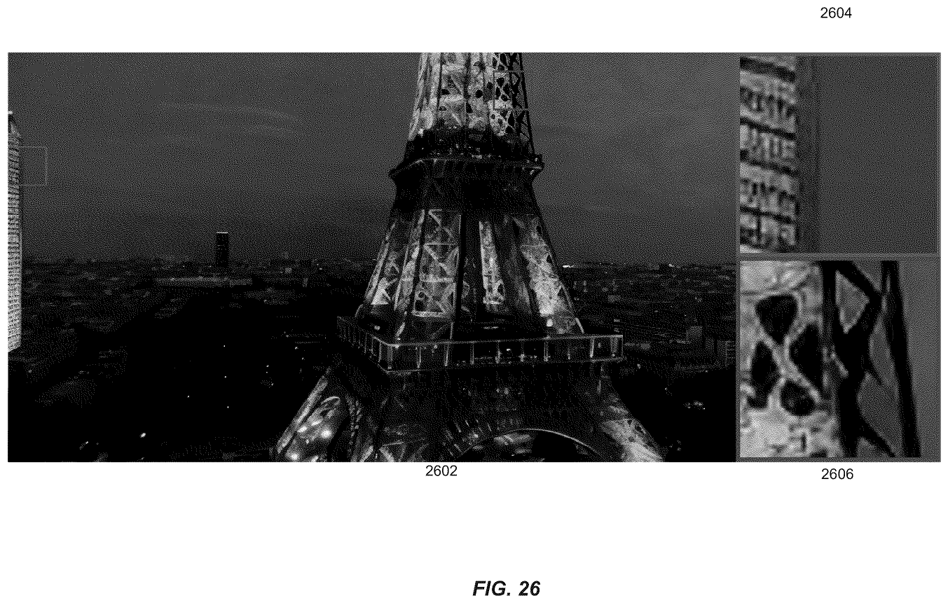

As described above, some embodiments of the present disclosure are directed to methods for generating novel view images using a dual-branch diffusion model and depth maps. Such a dual-branch diffusion model can comprise a pre-trained machine learning model and a conditional model. In general terms, the conditional model can fine-tune the pre-trained diffusion model, improving its performance on inpainting-based NVS tasks. This is evidenced by FIGS. 25-28, which compare the performance of methods according to embodiments and various other methods on an NVS task. FIGS. 25-27 show novel view images corresponding to warped and masked image 204 of FIG. 2. FIG. 25 shows a novel view image 2502 inpainted using a convolutional neural network, FIG. 26 shows a novel view image 2602 inpainted using the BrushNet model, and FIG. 27 shows a novel view image 2702 inpainted using methods according to embodiments. As shown in the figures and discussed below, methods according to embodiments generally produced the highest quality novel view images with the least visual artifacts.

As stated above, FIG. 25 shows a novel view image 2502 generated by performing inpainting with a convolutional neural network (CNN), along with two zoom-in regions 2504 and 2506. As shown in zoom-in region 2504, the dark column on the lefthand side of the inpainted image 2502 is blurred rather than filled in with realistic pixel texture. Some embodiments address this problem by using a diffusion model to perform inpainting rather than a convolutional neural network. Generally, CNNs can be effective for images with small disparity values and narrow occlusion mask, but do not work well for images in which larger regions of pixels are inpainted, e.g., during NVS.

Another approach is to use a diffusion model and a conditional model (such as BrushNet) to perform inpainting for NVS. FIG. 26 shows a novel view image 2602 generated by performing inpainting using BrushNet, along with two zoom-in-regions 2604 and 2606. As shown in FIG. 26, BrushNet can produce unsatisfactory results when performing inpainting for NVS, as it is designed for general-purpose inpainting, and not for specialized NVS inpainting tasks. In many NVS scenarios, disocclusion masks will often comprise a “column” on one side of the image and narrow regions along the edges of foreground objects. This pattern is generally shown in disocclusion mask 206 of FIG. 2. However this pattern is different from patterns found in training data for general-purpose inpainting, which often include foreground or background masks, segmentation masks, randomized masked, etc. General inpainting models, such as BrushNet, can make the mistake of inpainting the disocclusion mask based on objects in the foreground, rather than the background. This is shown in zoom-in region 2604, in which BrushNet hallucinated a large tower along the edge of the novel view image 2602. Likewise, in zoom-in region 2606, BrushNet filled in the gridwork-shaped part of the disocclusion mask along the Eiffel tower's edge as crisscrossing iron beams, rather than inpainting the disocclusion masks based on the background sky texture. As such, neither zoom-in region shows realistic inpainting content. Further, BrushNet can sometimes ignore parts of the disocclusion mask when inpainting, leaving masked areas black. Inpainting models such as BrushNet are generally designed to inpaint large masks (rather than narrow disocclusion regions). Small or narrow masked areas may be eliminated during downsampling operations performed by models such as BrushNet, causing such models to fail to inpaint such regions.

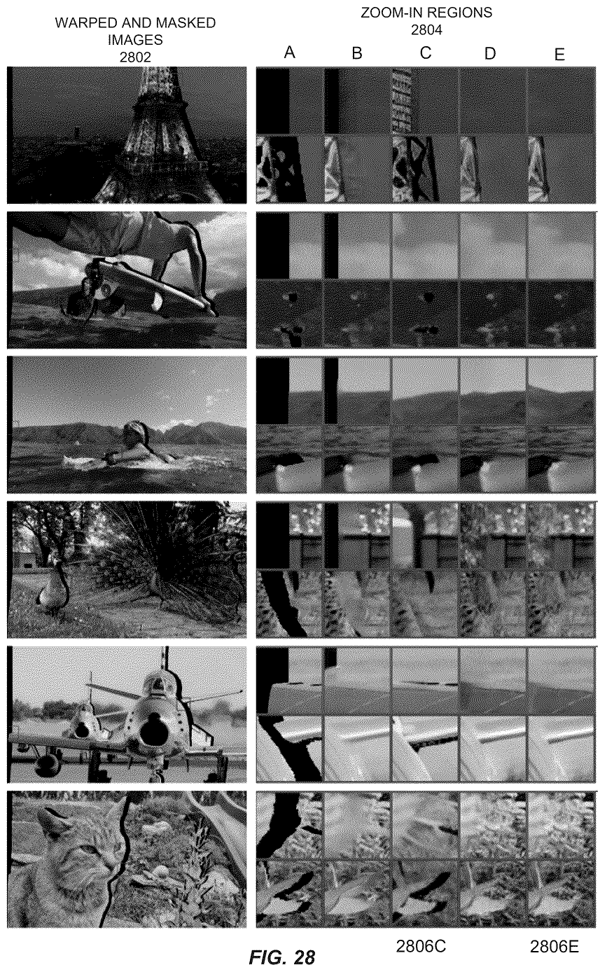

Methods according to embodiments achieve better results than both CNN-based inpainting and using inpainting models like BrushNet. FIG. 27 shows a novel view image 2702 generated using methods according to embodiments along with zoom-in regions 2704 and 2706, which both show fairly realistic inpainted texture. Further, FIG. 28 compares inpainting results for various warped and masked images 2802 based on the contents of zoom-in regions 2804. Zoom-in regions 2804A show the contents of a corresponding warped and masked image without inpainting. Zoom-in regions 2804B show the results of inpainting using a convolutional neural network. Zoom-in regions 2804C show the results of inpainting using a BrushNet model. Zoom-in regions 2804D show the results of inpainting using methods according to embodiments using machine learning models trained without random masks (p_{rand}=0). Zoom-in regions 2804E show the results of inpainting using methods according to embodiments and machine learning models according to embodiments trained with random masks (p_{rand}=0.4). As shown by FIG. 28, machine learning models and methods according to embodiments achieved the best performance, particularly in cases which involved inpainting small regions of the disocclusion mask, which were often missed by BrushNet (compare e.g., zoom-in region 2806C and 2806E).

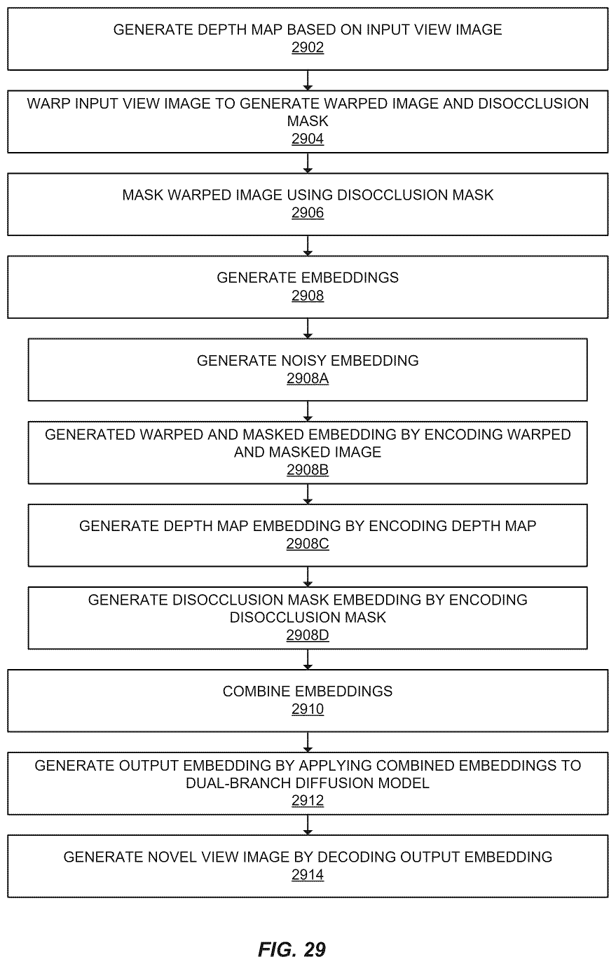

More specifically, a method for generating a novel view image corresponding to an input view image using a machine learning model comprising a pre-trained diffusion model and a conditional model is described below with reference to the flowchart of FIG. 29 and the diagram of FIG. 30, which shows a machine learning model comprising a pre-trained diffusion model 3002 and a conditional model 3004. The method can be performed by a computer system, e.g., as described above with reference to FIG. 4 or below with reference to FIGS. 52 and 53. The machine learning model can be referred to as a “decomposed dual-branch diffusion model” and can have an architecture similar to both ControlNet [ZRA23] and BrushNet [JLW+24]. In general terms, the conditional model 3004 can “fine-tune” the pre-trained diffusion model 3002, improving performance on NVS inpainting tasks. Various pre-trained diffusion models can be used with embodiments of the present disclosure. In some implementations of methods according to embodiments, Stable Diffusion 1.5 was used as a pre-trained diffusion model.

Both the conditional model 3004 and pre-trained diffusion model 3002 can comprise machine learning models with multiple model layers. The pre-trained diffusion model 3002 can comprise one or more diffusion model layers (see e.g., exemplary diffusion model layer 3006), which can include an input diffusion model layer. The pre-trained diffusion model 3002 can be defined by a set of pre-trained diffusion model parameters, e.g., set during training. The conditional model 3004 can comprise one or more conditional model layers (see e.g., conditional model layer 3008). The conditional model 3004 can be defined by a set of conditional model parameters. In some embodiments, the conditional model 3004 and pre-trained diffusion model 3002 can each use a “U-Net” architecture. In some embodiments, the conditional model 3004 can be initialized as a “clone” of the pre-trained diffusion model 3002, e.g., such that the parameters associated with each layer of the conditional model 3004 can be copied from the parameters of each corresponding layer of the pre-trained diffusion model 3002. The conditional model 3004 and pre-trained diffusion model 3002 can be configured to interface in a layer-to-layer manner, e.g., such that the output of each layer of the conditional model 3004 comprises an input to a corresponding layer of the pre-trained diffusion model 3002. This can be accomplished in a variety of ways, including the use of zero-convolution adaptors.

Referring to FIG. 29, at step 2902, the computer system can generate a depth map based on the input view image. As described above, the depth map can indicate the “depth” of each pixel in the input image, e.g., the distance (along a “Z” dimension) between each pixel and a viewpoint of the image. Methods according to embodiments can be practiced using various methods to generate depth maps based on input view images, e.g., using monocular depth estimation. These methods can include the use of “off-the-shelf” depth estimation models, including depth estimation models such as “MiDaS” [RLH+20], “DepthFM”, “Marigold” or “Depth Anything” [YKH+24]. FIG. 30 shows a depth map 3010 generated based on an input view image (not pictured, although a warped and masked image 3012 corresponding to such an input view image is pictured).

In some embodiments, the depth map can comprise a disparity map comprising a plurality of disparity values corresponding to a plurality of pixels in the image. As described above, the computer system can generate an initial depth map comprising a plurality of depth values corresponding to a plurality of pixels in the input view image. The computer system can generate the initial depth map using the methods described above or other applicable methods (e.g., using monocular depth estimation methods). The computer system can then invert each depth value Z of the plurality of depth values based on a first disparity parameter a and a second disparity parameter b, thereby generating the plurality of disparity values d and the disparity map, e.g., according to a formula such as

$$d = a \cdot \frac{1}{z} - b ,$$

in which the first disparity parameter a and the second disparity parameter b. The disparity map can comprise an array of corresponding disparity values d.

At step 2904, the computer system can warp the input view image based on the depth map, thereby generating a warped image and a disocclusion mask. As described above, in some embodiments, the computer system can warp the input view image based on the depth map using softmax pixel-splatting. In general terms, as described above, the computer system can warp the input view image by generating a mapping between pixels in the input view image and pixels in the warped image. As an example, the computer system can assign each pixel in the input view image to a corresponding warped image pixel set of a plurality of warped image pixel sets based on the depth map. In this way, the computer system can determine one or more corresponding warped image pixel sets. Each warped image pixel set can generally correspond to a pixel in the warped image, i.e., each pixel assigned to a given warped image pixel set can generally comprise a pixel from the input view image that would be mapped to that pixel coordinate in the corresponding warped image. Therefore, the plurality of warped image pixel sets can generally comprise a mapping between the input image and the warped image.

In some embodiments, in order to assign each pixel in the input view image to a corresponding warped pixel set, the computer system can determine a warped pixel coordinate for each pixel based on a corresponding depth value in the depth map (or a corresponding disparity value in the disparity map). In this way the computer system can determine a plurality of warped pixel coordinates. These warped pixel coordinates can generally indicate the new location of these pixels in the warped image. The computer system can then assign each pixel to a warped pixel set corresponding to its determined warped pixel coordinates. As described above, there are various ways that the computer system can determine these warped pixel coordinates, e.g., determining horizontal and vertical pixel displacements, etc.

In some cases, the computer system can determine the warped pixel coordinates based on a viewpoint data element corresponding to a viewpoint. The viewpoint data element can generally quantify or qualify the viewpoint corresponding to the input view image or the warped image. In some embodiments, the viewpoint data element can comprise a virtual camera position vector indicating a position of a virtual camera in a three-dimensional virtual space and a virtual camera orientation vector indicating an orientation of the virtual camera in the three-dimensional virtual space. In some embodiments, the virtual camera position vector can comprise an x-coordinate, a y-coordinate, and a z-coordinate, e.g., corresponding to the position of a virtual camera in a three-dimensional Euclidean space. In some embodiments, the virtual camera orientation vector can comprise a polar angle and an azimuthal angle, indicating the angular orientation of the virtual camera.

In other embodiments, the viewpoint data element can comprise a virtual camera positional displacement vector indicating a spatial displacement of the virtual camera between a camera view in the input view image and a camera view corresponding to the viewpoint data element (and the warped image), in addition to a virtual camera orientation displacement vector indicating an orientation displacement between the camera view in the input view image and the camera view corresponding to the viewpoint data element (and the warped image). In some embodiments, the virtual camera positional displacement vector can comprise an x-displacement, a y-displacement, and a z-displacement. In some embodiments, the virtual camera orientation displacement vector can comprise a polar angle displacement and an azimuthal angle displacement.

In some cases, a pixel may be warped “out-of-bounds”, i.e., the pixel may have a warped pixel coordinate that is greater than one or more dimensions of the input view image (the corresponding warped image). For example, for a 512 by 512 input view image, a pixel with a warped pixel coordinate of (800, 130) is outside the bounds of the warped image, and would not be visible in the warped image. As such, in some embodiments the plurality of warped image pixel sets can include an out-of-bounds warped image pixel set, and the out-of-bounds warped image pixel set can correspond to pixels that are warped outside dimensions of the warped image as part of the warping process.

After iterating through all the pixels in the input view image, each warped image pixel set may be assigned zero or more pixels from the input view image. A warped image pixel set assigned zero pixels generally indicates that no pixels from the input view image map to a corresponding pixel location in the warped image, or, in other words, correspond to a warped pixel coordinate that does not correspond to any pixels in the input view image. These pixels are generally undefined in warped images and correspond to disoccluded regions. As such, the computer system can generate the disocclusion mask based on these “empty” warped image pixel sets. As such, in some embodiments, in order to generate the disocclusion mask, the computer system can determine one or more warped pixel coordinates that do not correspond to a plurality of pixels in the input view image. These one or more warped pixel coordinates can comprise the disocclusion mask. FIG. 30 shows a disocclusion mask 3014 generated using depth map 3010 and corresponding to warped and masked image 3012.

As described above, if a warped image pixel set is assigned more than one pixel, it generally indicates that multiple pixels from the input view image map to a pixel coordinate in the warped image corresponding to that warped image pixel set. As most two-dimensional images comprise arrays of pixels in which each pixel coordinate is occupied by exactly one pixel, warping processes generally involve resolving pixel “collisions” in warped images, e.g., scenarios in which multiple pixels map to the same warped pixel coordinate. As such, in some embodiments the computer system can determine a primary pixel (sometimes referred to as a “top” pixel pₜₒₚ) for each warped image pixel set, thereby determining a plurality of primary pixels. These primary pixels can comprise pixels that would be visible in the warped image. As such, in some embodiments the warped image can comprise the plurality of primary pixels. The plurality of primary pixels can comprise, e.g., pixels with the least depth value or highest disparity value in their respective warped pixel set. Such pixels can correspond to objects in the foreground of the image that may occlude other objects (e.g., corresponding to pixels with higher depth values or lower disparity values) in a warped image as a result of a warping process. As such, in some embodiments, the computer system can determine the primary pixel for each warped image pixel set by determining (for each warped image pixel set) a pixel with a lowest corresponding depth value or a highest corresponding disparity value based on the depth (or disparity) map. The pixel with the lowest corresponding depth value or highest corresponding disparity value can comprise the primary pixel.

At step 2906, the computer system can mask the warped image using the disocclusion mask, thereby generating a warped and masked image. There are various ways that the computer system can mask the warped image with the disocclusion mask. As described above, each disocclusion mask can correspond to one or more pixel locations (i.e., the one or more warped pixel coordinates) in the warped image. As such, in some embodiments the computer system can mask the warped image with the disocclusion mask by setting one or more pixel values associated with the one or more pixel locations in the warped image to a default value, e.g., associated with a default color, e.g., completely black or completely white. As an alternative, the computer system can mask the warped image with the disocclusion mask e.g., using element-wise conjunction or other combination methods. As described above, FIG. 30 shows a warped and masked image 3012, generated by masking an input view image (not pictured) using disocclusion mask 3014.

At step 2908, the computer system can generate various embeddings. These embeddings can be input into the pre-trained diffusion model and the conditional model in order to generate the novel view image. FIG. 30 shows a warped and masked embedding 3018, a depth map embedding 3020, and a disocclusion mask embedding 3022, which are combined with a noisy embedding 3024 to generate a combined embedding 3026. Generation of the various embeddings is described below with reference to steps 2908A-2908D.

As described above, image diffusion models typically use a learned reverse process to transform random Gaussian noise into an embedding which can be decoded and denoised to generate an output image. As such, at step 2908A, the computer system can generate a noisy embedding for a current diffusion step. FIG. 30 shows a noisy embedding 3024. The noisy embedding can have various dimensions. For example, in one implementation of methods according to embodiments used to generate novel view images corresponding to 512×512 input view images, noisy embeddings were generated with dimensions 64×64×4.

At step 2908B, the computer system can encode the warped and masked image, thereby generating a warped and masked embedding. The computer system can encode the warped and masked image by applying the warped and masked image to an encoder (which can comprise one or more encoder layers). In some embodiments, the computer system can encode the warped and masked image using a variational autoencoder (VAE) encoder. FIG. 30 shows warped and masked image 3012 encoded using encoder 3016 to generate warped and masked embedding 3018. The warped and masked embedding can have various dimensions. For example, in one implementation of methods according to embodiments used to generate novel view images corresponding to 512×512 input view images, warped and masked embeddings were generated with dimensions 64×64×4.

At step 2908C, the computer system can encode the depth map, thereby generating a depth map embedding. The computer system can encode the depth map by applying the depth map to an encoder (which can comprise one or more encoder layers). FIG. 30 shows a depth map embedding 3020 generated by encoding depth map 3010 using encoder 3022. In some embodiments, the computer system can encode the depth map using a convolutional encoder comprising a convolutional layer (e.g., a convolution sub-block), a rectified layer (e.g., a ReLU activation sub-block), and a max pooling layer (e.g., a max pooling sub-block). In some embodiments, convolutional encoders may not use pretrained weights and instead may be trained alongside the conditional model during model fine-tuning. The use of depth information during inpainting can improve the quality of novel view images generated by the dual-branch diffusion model. Further, the use of convolutional encoding (as opposed to e.g., downsampling) can avoid information loss issues that can prevent disoccluded regions from being inpainted, e.g., as described above with reference to zoom-in regions 2806C and 2806E of FIG. 28. The depth map embedding can have various dimensions. For example, in one implementation of methods according to embodiments used to generate novel view images corresponding to 512×512 input view images, depth map embeddings were generated with dimensions 64×64×4.

In some embodiments, the computer system can first warp the depth map, generating a warped depth map, then encode the warped depth map, thereby generating the warped depth map embedding. The computer system can perform various other further processing steps on the depth map prior to encoding it. For example, the computer system can inpaint disoccluded regions in the depth map using e.g., a method disclosed in [MBGS24].

At step 2908D, the computer system can encode the disocclusion mask, thereby generating a disocclusion mask embedding. The computer system can encode the disocclusion mask by applying the disocclusion mask to an encoder (which can comprise one or more encoder layers). In some embodiments, the computer system can encode the disocclusion map using a convolutional encoder comprising a convolutional layer, a rectified layer, and a max pooling layer. FIG. 30 shows a disocclusion mask embedding 3022 generated by encoding disocclusion mask 3014 using encoder 3024. The disocclusion mask embedding can have various dimensions. For example, in one implementation of methods according to embodiment used to generate novel view images corresponding to 512×512 input view images, disocclusion mask embeddings were generated with dimensions 64×64×4.

At step 2910, the computer system can combine the noisy embedding, the warped and masked embedding, the depth map embedding, and the disocclusion mask embedding, thereby generating a combined embedding. In some embodiments, the computer system can concatenate these embeddings together to combine them. FIG. 30 shows a combined embedding 3026, generated by combining disocclusion mask embedding 3022, depth map embedding 3020, warped and masked embedding 3018, and noisy embedding 3024. The combined embedding can have various dimensions. As described above, in one implementation of methods according to embodiments used to generate novel view images corresponding to 512×512 input view images, the four embeddings described above each had dimensions 64×64×4, and the combined embedding generated by concatenating these embeddings had dimensions 64×64×16.

At step 2912, the computer system can apply the embeddings to the dual-branch diffusion model in order to generate an output embedding. The computer system can apply the combined embedding to the conditional model, thereby generating one or more conditional model layer outputs corresponding to the one or more conditional model layers. The computer system can apply the noisy embedding to the input diffusion model layer (of the pre-trained diffusion model) and the one or more conditional model layer outputs to the one or more diffusion model layers, thereby generating an output embedding. FIG. 30 shows an output embedding 3028 (which may be noisy) generated using conditional model 3004 and pre-trained diffusion model 3002. In some embodiments, the pre-trained diffusion model and conditional model may comprise U-Net diffusion models. The conditional model layers and the diffusion model layers can interface in a layer-to-layer manner, e.g., via zero-convolution adaptors. In this way, the computer system can apply the one or more conditional model layer outputs to the one or more diffusion model layers. In some embodiments, the computer system can further apply a text embedding to the one or more diffusion model layers in addition to the one or more conditional model layer outputs. Such a text embedding can enable a user of the computer system to textually describe desired qualities of the novel view image, e.g., “HD”, “High Quality”, etc. FIG. 30 shows a text embedding 3030.

At step 2914, the computer system can decode the output embedding to generate the novel view image. In some embodiments, the computer system can decode the output embedding using a decoder comprising one or more decoder layers. In some embodiments, the decoder can comprise variational autoencoder (VAE) decoder, e.g., corresponding to a VAE encoder used to encode the warped and masked image (as described above). FIG. 30 shows a decoder 3032 and a novel view image 3034.

In some embodiments, various additional steps may be performed to generate the novel view image. For example, the novel view image produced by decoding the output embedding may be noisy, and a series of denoising steps may be performed to remove the noise from the novel view image. Further, a color matching process may be performed in order to match the color of the novel view image to the color of the input view image, e.g., by matching the mean and standard deviation for each novel view image channel (e.g., red, green, blue, as well as gamma values) to the mean and standard deviations for the input view images. FIG. 30 shows a noisy novel view image 3036 that has been denoised to produce novel view image 3034. A color matching process 3038 is performed on novel view image 3034 to produce color matched novel view image 3040. Other operations, such as e.g., blending the non-inpainted regions of the input view image into the novel view image can be performed in order to achieve greater image consistency.

Methods for generating novel view images described herein can also be used to generate novel view video, as a video generally comprises a sequence of image frames. As such, in some embodiments the input view image can comprise an image frame in an input view video, which can comprise one or more additional image frames. Likewise, the novel view image can comprise a novel view image frame in a novel view video. The computer system can generate one or more additional depth maps based on the one or more additional image frames. The computer system can warp the one or more additional image frames based on the one or more additional depth maps, thereby generating one or more additional warped images and one or more additional disocclusion masks. The computer system can mask each additional warped image using a corresponding disocclusion mask, thereby generating one or more additional warped and masked images. The computer system can generate one or more additional noisy embeddings. The computer system can encode the one or more additional disocclusion masks, thereby generating one or more disocclusion mask embeddings. The computer system can combine each additional noisy embedding with a corresponding warped and masked embedding, a corresponding additional disocclusion mask embedding, and a corresponding depth map embedding, thereby generating one or more additional combined embeddings. The computer system can apply the one or more additional noisy embeddings to the input diffusion model layer and the one or more sets of additional conditional model layer outputs to the one or more diffusion model layers, thereby generating one or more additional output embeddings. The computer system can decode the one or more additional output embeddings, thereby generating one or more additional novel view image frames. The computer system can generate the novel view video by combining the novel view image frame and the one or more additional novel view image frames. The computer system can use various methods or processes described herein to e.g., generate one or more additional depth maps, warp the one or more additional image frames, etc.

In some embodiments, the machine learning model can be trained using training data generated using training data generation methods according to embodiments, e.g., using training data generated from single-view datasets, as described above with reference to FIG. 5. As such, in some embodiments the computer system can train the machine learning model prior to the steps described above (e.g., prior to generating the depth map at step 2902). There are various ways that the machine learning model can be trained, e.g., as described above. As an example, the computer system can retrieve a plurality of sets of training images (e.g., generated using training data generation methods according to embodiments). Each training set of images can comprise an image and a corresponding masked image. The computer system can generate a plurality of training model outputs by applying a plurality of masked images from the plurality of training sets of images to the machine learning model. The computer system can determine one or more loss values based on a comparison between the plurality of training model outputs and the plurality of images. The computer system can update a parameter set of the conditional model based on the one or more loss values, thereby training the conditional model (thereby training the machine learning model). In some embodiments, the conditional model can be trained by iteratively updating the set of conditional model parameters based on a training dataset over a series of training rounds. Thus in some embodiments, the plurality of training model outputs can be generated over the series of training rounds, the one or more loss values can be determined over the series of training rounds, and the parameter set of the conditional model can be updated over the series of training rounds. During training, the parameter set of the pre-trained diffusion model can be frozen while the conditional model is trained. In some embodiments, the conditional model can be initialized as a “clone” of the pre-trained diffusion model during training, e.g., such that the parameters associated with each layer of the conditional model can be copied from the parameters of each corresponding layer of the pre-trained diffusion model before being iteratively updated over a series of training rounds.

### D. Generating Novel View Video Using Mapping Machine Learning Model

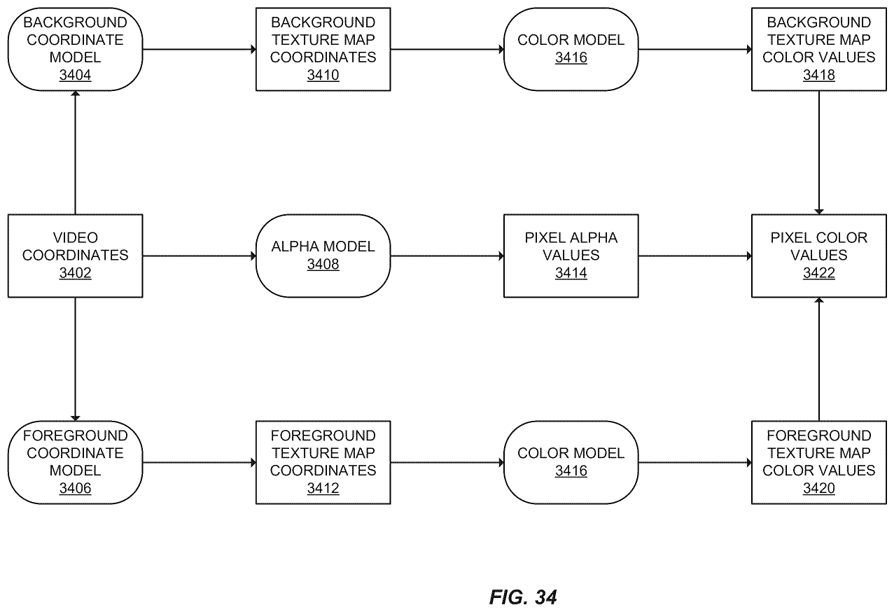

As described above, some embodiments of the present disclosure are directed to methods for generating novel view videos corresponding to input view videos. Such methods could be used to, e.g., generate a stereo video pair for a 3D movie from a video shot on a single camera setup. As described above, a computer system can perform methods for generating novel view images using a dual-branch diffusion model (e.g., as described above) for each image frame in an input view video, thereby generating a novel view video. However, this can result in novel view videos with flickering or other visual artifacts due to a lack of temporal consistency between image frames. As such, the present disclosure provides additional methods for generate novel view videos, e.g., using a mapping machine learning model, as described further below with reference to FIG. 34. Such methods can result in novel view videos with greater temporal consistency between frames, resulting in smoother and more aesthetically pleasing video.

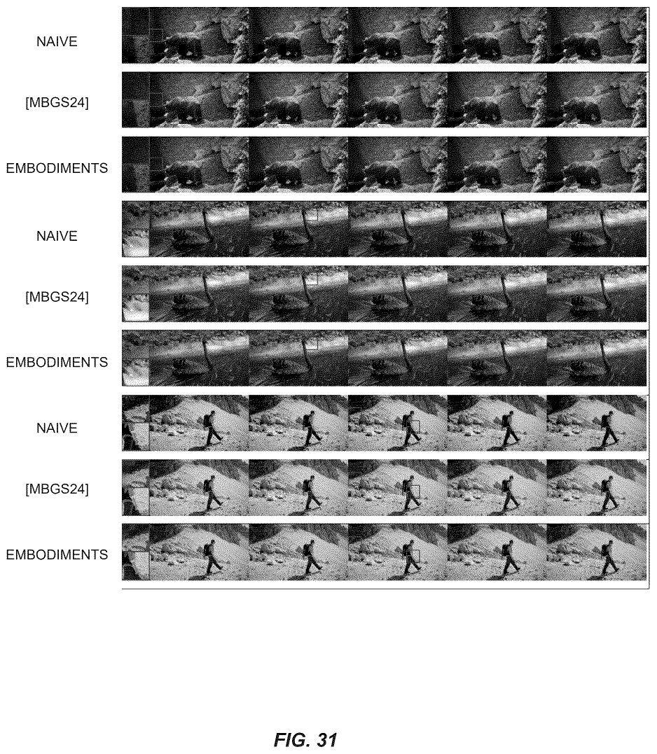

In general terms, rather than (or addition to) warping and inpainting image frames corresponding to an input view video, thereby generating a novel view video, a computer system can use a mapping machine learning model to generate a texture map corresponding to a warped video as a whole, along with a cumulative disocclusion mask. The computer system can then inpaint the cumulative disocclusion mask to complete the texture map, which can then be used to construct the novel view video. In this way the computer system can use information from all the input view video frames to construct the novel view video, thereby improving temporal consistency between frames in the novel view video. FIG. 31 compares frames of novel view videos generated using video novel view synthesis methods according to embodiments, novel view synthesis methods involving just framewise inpainting (“naive”) and a method provided by [MBGS24].

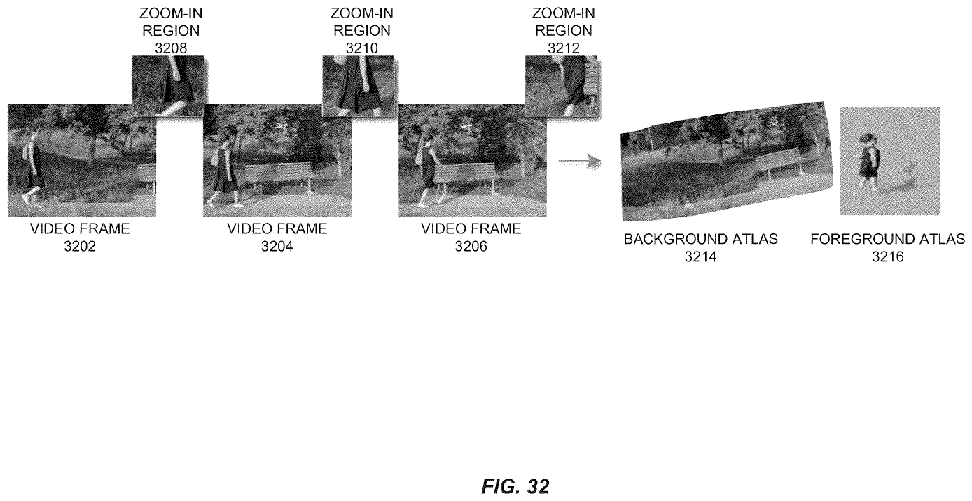

In some embodiments, the mapping network can comprise a “Layered Neural Atlas” (as presented in [KOWD21]) and the texture map can comprise a “foreground atlas” (generally corresponding to objects in the foreground of the input view video) and a “background atlas” (generally corresponding to objects in the background of the input view video). FIG. 32 (adapted from [KOWD21]) shows an example of three video frames 3202-3206 (and corresponding zoom-in regions 3208-3212) and background atlas 3214 (or “background texture map”) and foreground atlas 3216 generated from video frames 3202-3206.

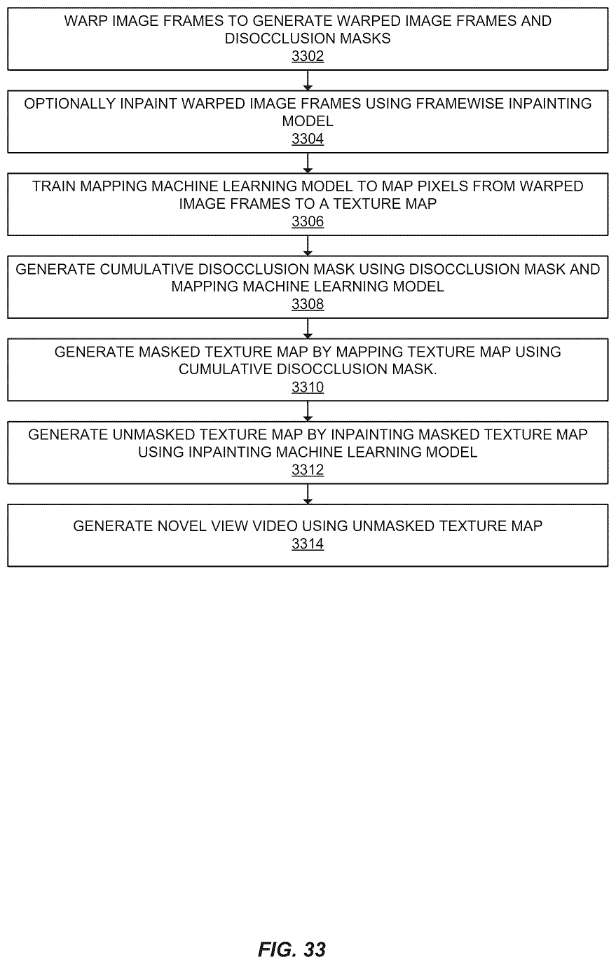

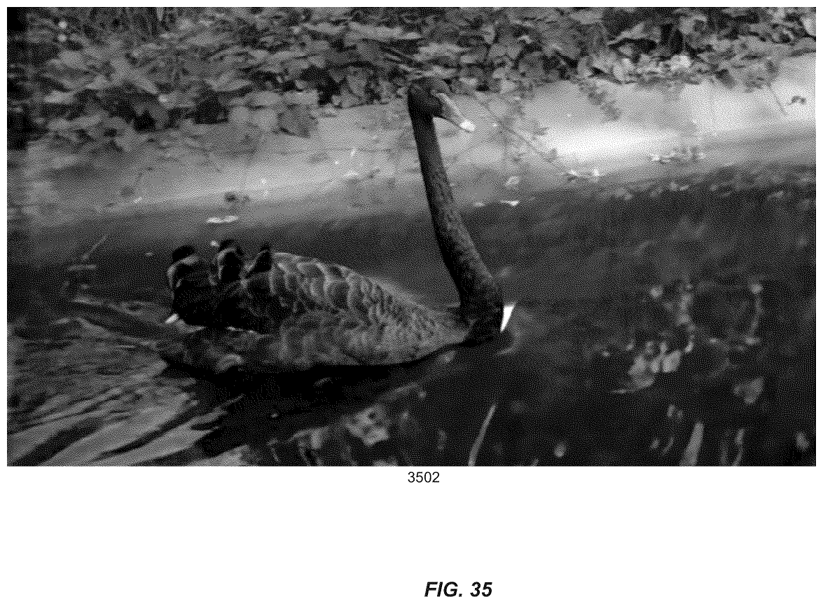

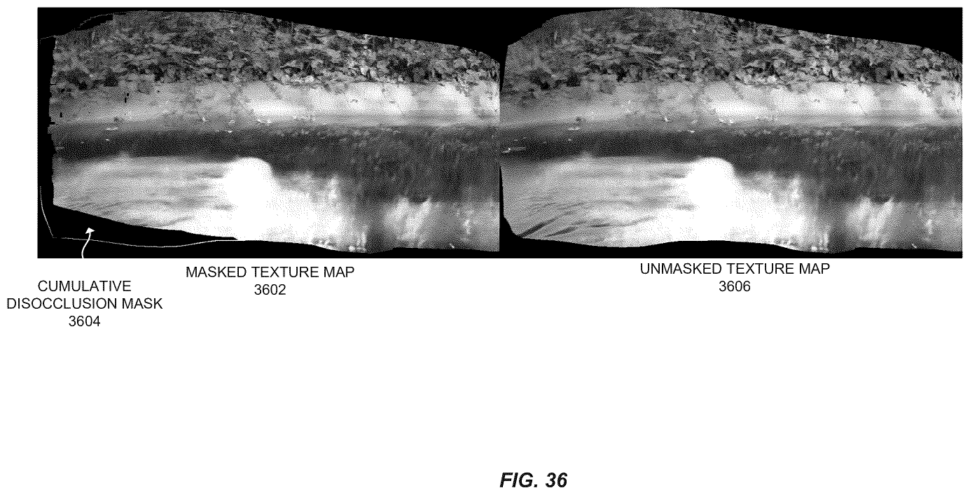

More specifically, a method for generating novel view video corresponding to an input view video using a mapping machine learning model and an inpainting machine learning model is described below with reference to the flowchart of FIG. 33 and the mapping machine learning model diagram of FIG. 34, with some additional reference to FIGS. 35 and 36. The novel view video can comprise a plurality of image frames and the method can be performed by a computer system, e.g., as described above with reference to FIG. 4 or below with reference to FIGS. 52 and 53.

At step 3302, the computer system can warp each image frame of the plurality of image frames. In this way the computer system can generate a plurality of warped image frames and a plurality of disocclusion masks corresponding to the plurality of warped image frames. In some embodiments, for each image frame, the computer system can generate a depth map based on the image frame, then warp that image frame based on the depth map, thereby generating a corresponding warped image frame and a corresponding disocclusion mask. In this way the computer system can generate the plurality of warped image frames and the plurality of disocclusion masks.

The computer system can use various methods to generate depth maps, warp image frames, generated warped image frames, generate occlusion masks, etc., e.g., as described above. For example, the computer system can generate depth maps for each image frame using various off-the-shelf depth estimation model such as MiDaS, DepthFM, Marigold, Depth Anything, etc. In some embodiments, each depth map can comprise a disparity map, which the computer system can generate by inverting a corresponding depth map. As another example, the computer system can warp each image frame using softmax pixel splatting, and/or assigning each pixel in each warped image frame to a corresponding warped pixel set, from which the computer system can determine a primary pixel (or a “top” pixel pₜₒₚ), constructing the plurality of warped image frames from these determined primary pixels. As described above, the computer system could determine, for each warped image pixel set, a pixel with a lowest corresponding depth value or a highest corresponding disparity value based on a corresponding depth map. The primary pixel can comprise the pixel with the lowest corresponding depth value or highest corresponding disparity value.

Likewise, the computer system can use various methods to determine the plurality of disocclusion masks, e.g., by iterating through each warped image pixel set and identify warped image pixel sets that have been assigned zero pixels. The computer system can construct the plurality of disocclusion masks based on these identified warped image pixel sets. In some embodiments, each disocclusion mask can comprise a plurality of disocclusion mask tuples. Each disocclusion mask tuple can comprise an x-coordinate, a y-coordinate, and a frame number. The frame number can identify the image frame (e.g., the 5^{th} image frame) corresponding to a given disocclusion mask and the x-coordinate and y-coordinate can identify the location of a masked pixel in the disocclusion mask.

At optional step 3304, in some embodiments, the computer system can perform framewise inpainting on the plurality of warped image frames using a framewise inpainting model. The computer system can use any appropriate inpainting model to inpaint the warped image frames, e.g., machine learning models according to embodiments, a CNN-based inpainting model, BrushNet, etc. In some cases, it may be advantageous to use non-diffusion based inpainting models to perform framewise inpainting, as diffusion models may inject hallucinated texture that may interfere with later texture map inpainting.

At step 3306, the computer system can train the mapping machine learning model to map pixels from the plurality of warped image frames to a texture map, thereby generating the texture map. Step 3306 may be better understood with reference to the exemplary mapping machine learning model of FIG. 34.

In some embodiments, the mapping machine learning model can comprise a background coordinate model M_{b}, a foreground coordinate model M_{f}, an alpha model Mₐ, and a color model A, and the texture map can comprise a foreground texture map and a background texture map. The foreground texture map can correspond to objects in the foreground of the input view video and the background texture map can correspond to objects in the background of the input view video. The computer system can use these machine learning models to learn pixel mappings between pixels in the warped image frames and the texture map (e.g., the foreground texture map and the background texture map). FIG. 34 shows a mapping machine learning model comprising background coordinate model 3404, foreground coordinate model 3406, alpha model 3408, and color model 3416. In some embodiments, the background coordinate model, foreground coordinate model, alpha model, and color model can comprise neural networks, i.e., the foreground coordinate model comprises a foreground neural network, the background coordinate model comprises a background neural network, the alpha model comprises an alpha neural network, and the color mode comprises a color neural network.

The background coordinate model M_{b} 3404 can take video coordinates 3402 as an input. Such video coordinates can comprise 3-tuples (x, y, t), corresponding to the two-dimensional location (x, y) of a pixel from the warped image frames and its frame number (t). The background coordinate model can output background texture map coordinates 3410. Such background texture map coordinates 3410 can comprise 2-tuples of UV coordinates (u_{bg}, v_{bg}) corresponding to the location of a pixel (corresponding to video coordinates 3402) on the background texture map. Similarly, the foreground coordinate model 3406 can take video coordinates 3402 as an input, and output foreground texture map coordinates 3412. Such foreground texture map coordinates 3412 can comprise 2-tuples of UV coordinates (u_{fg}, v_{fg}) corresponding to the location of a pixel (corresponding to video coordinates 3402) on the foreground texture map. Notably, each pixel in the input view video can be mapped to both the foreground texture map and the background texture map. Similarly, the alpha model Mₐ 3408 can take video coordinates 3402 as an input and output pixel output values 3414. These pixel alpha values can be used to blend the foreground texture map and the background texture map together, e.g., as part of generating the novel view video. The mapping network can further comprise a color model A 3416, which can take the background texture map coordinates (u_{bg}, v_{bg}) 3410 as an input and produce background texture map color values I_{bg} 3418, i.e., indicating the colors of pixels mapped to the background texture map. Likewise, the color model A 3416 can take the foreground texture map coordinates (u_{fg}, v_{fg}) 3412 as an input and produce the foreground texture map color values I_{fg} 3420, i.e., indicating the colors of pixels mapped to the foreground texture map.

In some embodiments, training the mapping machine learning model in step 3306 can comprise training the foreground coordinate model, the background coordinate model, the alpha model, and the color model. In some embodiments, the computer system can train the foreground coordinate model, the background coordinate model, the alpha model, and the color model in a concurrent self-supervised training process based on a combined loss function [symbol] , The combined loss function can comprise a combination of various other loss functions. As an example, the combined loss function can comprise a combination of a color loss function [symbol] a local rigidity loss function [symbol] an optica flow loss function [symbol] , a sparsity loss function [symbol] , an alpha loss function [symbol] , a global rigidity loss function [symbol] , and a foreground loss function [symbol] . These loss functions and their uses for training the mapping machine learning model are described below.

In some embodiments, in each training iteration, the computer system can sample random coordinates from the input view video and reconstruct their pixel color values using the mapping machine learning model. The foreground coordinate model M_{b}, background coordinate model M_{f}, alpha model Mₐ, and color model A can be optimized based on various loss functions and their combinations as described herein.

In general terms, the color loss function [symbol] can measure how well pixel color values and image gradients are reconstructed. The local rigidity loss function [symbol] can reward the mapping machine learning model for generating texture maps that are locally rigid, preserving the structure of objects depicted in the warped image frames. The optical flow loss function [symbol] can reward the mapping machine learning model for mapping corresponding pixels in consecutive frames (determined using optical flow) to the same locations in the texture map. The sparsity loss function [symbol] can be used to penalize the machine learning model for mapping pixels in the input view image to non-black values in both the foreground and background atlas, thereby preserving pixel sparsity.

In some embodiments, the combined loss function [symbol] can comprise a combination of the color loss function [symbol] , the local rigidity loss function [symbol] , the optical flow loss function [symbol] and the sparsity loss function [symbol] i.e. [symbol] . In other embodiments, the combined loss function can additionally include a bootstrapping loss function [symbol] i.e., [symbol] . This bootstrapping loss function can be used in the early iterations of training (also referred to as a “bootstrapping phase”), e.g., the first 10,000 training iterations. In some embodiments, the bootstrapping loss can comprise a combination of an alpha loss [symbol] and a global rigidity loss [symbol] , i.e. [symbol] . In general terms, the alpha loss function [symbol] can reward the mapping machine learning model for generating alpha values that match segmentation masks from the plurality of warped image frames. In general terms, the global rigidity loss [symbol] can reward the mapping machine learning model for generating globally rigid texture maps.

Various other combined loss functions can be used in methods according to embodiments. For example, the color loss function [symbol] can be modified such that the computer system calculates a modified color loss function

$${ℒ}_{color}^{′}$$

based on a separate batch of pixels in each training iteration, which can be sampled outside of disoccluded regions of the plurality of warped image frames. As another example, the computer system can include additional loss functions in the combined loss function, such as a foreground reinforcement loss function [symbol] . In some embodiments, the foreground reinforcement loss function can comprise a combination of a custom alpha loss function [symbol] and a foreground loss function [symbol] , e.g., [symbol] . In some embodiments, the foreground reinforcement loss function [symbol] can be included in the combined loss function during a foreground reinforcement phase at the end of the training process (e.g., comprising the last 10,000 to 20,000 iterations of the training process).

In general terms, the computer system can calculate the custom alpha loss function [symbol] based on disoccluded pixels from the vicinity of foreground objects in each training iteration. The computer system can use the mapping network to determine alpha values corresponding to these disoccluded pixels, then reward or penalize the mapping machine learning model based on the difference between the squared norm of the alpha values and zero (e.g., rewarding the mapping machine learning model when the distance between the squared norm of the alpha values is close to zero and punishing the machine learning model when the squared norm of the alpha values is far from zero.

In general terms, the computer system can calculate the foreground loss function [symbol] by sampling pixels from the foreground mapping according to input segmentation masks and calculating their alpha values. The foreground loss function [symbol] can penalize the mapping machine learning model for generating alpha values that are close to one. FIG. 35 shows a novel view frame 3502 of a novel view video generated using the foreground reinforcement loss function (in addition to other loss functions described above). The additional foreground reinforcement loss function [symbol] results in less erroneous transparency and higher quality novel view video frames.

Referring back to FIG. 33, at step 3308, the computer system can generate a cumulative disocclusion mask using the plurality of disocclusion masks and the mapping machine learning model. In general terms, the computer system can use the now-trained mapping machine learning model to map the disocclusion mask to the texture mapping. In some embodiments, each disocclusion mask can comprise a plurality of disocclusion mask tuples. Like the video coordinates 3402 of FIG. 34, each disocclusion mask tuple can comprise an x-coordinate, a y-coordinate, and a frame number, (x, y, t). These disocclusion mask tuples can indicate the location of masked pixels in the plurality of warped image frames. For each disocclusion mask tuple in each disocclusion mask, the computer system can use a background coordinate model (e.g., background coordinate model 3404 as described above) to determine a disocclusion background texture map coordinate (u_{bg}, v_{bg}) based on a corresponding x-coordinate, a corresponding y-coordinate, and a corresponding frame number (x, y, t), e.g., by inputting each disocclusion mask tuple into the trained background coordinate model. In this way, the computer system can determine a plurality of background texture map coordinates. The computer system can then generate the cumulative disocclusion mask based on the plurality of disocclusion background texture map coordinates.

In some embodiments, the cumulative disocclusion mask can comprise the plurality of disocclusion background texture map coordinates. In such a case, any disoccluded pixel, in any of the plurality of warped image frames is part of the cumulative disocclusion mask. However, this can result in large cumulative disocclusion masks, which can result in poor inpainting model performance and low-quality novel view image frames. To address this, in some embodiments the computer system can use thresholding to reduce the size of the cumulative disocclusion mask. In such cases, the computer system can add a disocclusion background texture map coordinate to the cumulative disocclusion mask if a pixel corresponding to that disocclusion background texture map coordinate is masked in greater than a threshold fraction of the disocclusion masks. For example, for a threshold fraction of 0.5, if a given pixel in the plurality of warped image frames is masked in half or more of the plurality of disocclusion masks, a corresponding disocclusion background texture map coordinate can be added to the cumulative disocclusion mask. If a given pixel in the plurality of warped image frames is masked in less than half of the plurality of disocclusion masks, the corresponding disocclusion background texture map coordinate may not be added to the disocclusion mask.

In other words, in some embodiments, the computer system can generate the cumulative disocclusion mask by determining, for each disocclusion background texture map coordinate, whether a fraction of (a) disocclusion mask tuples mapped to that disocclusion background texture map coordinate and (b) pixels from a plurality of pixels mapped to a corresponding background texture map coordinate by the mapping machine learning model exceeds a threshold fraction, thereby identifying one or more disocclusion texture map coordinates. The cumulative disocclusion mask can comprise the one or more background texture map coordinates. In some embodiments, the threshold fraction is equal to one, i.e., a pixel coordinate is only mapped to the cumulative disocclusion texture map if that pixel coordinate is disoccluded in every warped image frame of the plurality of warped image frames.

At step 3310, the computer system can combine the cumulative disocclusion mask and the texture map, thereby generating a masked texture map. There are various ways that the computer system can mask the texture map. For example, in some embodiments the computer system can mask the texture map using the cumulative disocclusion mask by combining the texture map and the cumulative disocclusion mask via element-wise multiplication or element-wise conjunction. As another example, the computer system can mask the texture map using the cumulative disocclusion mask by setting one or more pixel color values associated with the disocclusion background texture map coordinates in the texture map to a default value, e.g., associated with a default color, e.g., completely black or completely white. FIG. 36 shows an exemplary masked texture map 3602 masked with cumulative disocclusion mask 3604 (represented using black pixels). FIG. 36 also shows an unmasked texture map 3604, generated, e.g., by inpainting the masked texture map 3602 as described below.

At step 3312, the computer system can generate an unmasked texture map by inpainting the masked texture map using an inpainting machine learning model. In some embodiments, the computer system can inpaint the masked texture map using novel view inpainting methods and machine learning models described above. However, it should be understood that any appropriate method or technique can be used to inpaint the masked texture map, e.g., using a general-purpose SDXL method (e.g., as described in [PEL+23]), or another method. As a more detailed example, In some embodiments, the inpainting machine learning model can comprise a diffusion model. The computer system can generate a noisy embedding, encode the masked texture map (thereby generating a masked texture map embedding), and combine the noisy embedding and the masked texture map embedding, thereby generating a combined embedding. The computer system can then apply the combined embedding to the inpainting machine learning model, thereby generating an output embedding. The computer system can decode the output embedding to generate the unmasked texture map.

In many cases, only pixels corresponding to the background of the input view video may need to be inpainted, as typically background pixels (and not foreground pixels) are disoccluded as a result of warping operations. As such, in some embodiments inpainting the masked texture map can comprise inpainting a background texture map and not inpainting a corresponding foreground texture map.

At step 3314, the computer system can generate the novel view video based on the unmasked texture map. In general terms, the computer system can do so by using the unmasked texture map to determine pixel color values corresponding to each coordinate (x, y, t) in the novel view video, e.g., by combining (inpainted) background texture map color values I_{bg} and foreground texture map color values I_{bg} using alpha values generated using the alpha model. In some embodiments, the unmasked texture map can comprise an unmasked foreground texture map and an unmasked texture map. As such, in some embodiments, for each pixel in each image frame in the plurality of image frames, the computer system can determine an x-coordinate, a y-coordinate, and a frame number corresponding to that pixel. The computer system can determine a foreground texture map coordinate based on the x-coordinate, the y-coordinate, and the frame number using the foreground coordinate model. Likewise, the computer system can determine a background texture map coordinate based on the x-coordinate, the y-coordinate and the frame number using the background coordinate model. The computer system can additionally determine an alpha value based on the x-coordinate, the y-coordinate, and the frame number using the alpha model. The computer system can determine a foreground texture map pixel in the unmasked foreground texture map based on the foreground texture map coordinate. Likewise, the computer system can determine a background texture map pixel in the unmasked background texture map based on the background texture map coordinate. The computer system can combine the foreground texture map pixel and the background texture map pixel based on the alpha value, thereby generating a novel view pixel. By performing this process for each pixel in each image frame in the plurality of image frames, the computer system can generate a plurality of novel view image frames, each comprising a plurality of novel view pixels. The novel view video can comprise the plurality of novel view image frames.

### VII. Experiments and Visual Results

Some methods according to embodiments were used in various experiments relating to NVS tasks, including single-view NVS, sparse-view NVS, and stereo video conversion. These experiments (described in more detail below) demonstrate the versatility and state-of-the-art performance of some methods according to embodiments.

As described above, in some embodiments, a pre-trained diffusion model can be used to perform inpainting as part of NVS. In some experiments, the open-source video diffusion model DynamicCrafter [Xing et al., 2025] was used as the pre-trained diffusion model. The pre-trained diffusion model weights were initialized with ViewCrafter weight initialization [Yu et al. 2024]. In these experiments, machine learning models according to embodiments were trained using the AdamW optimizer [Loshvhilov and Hutter 2019] using 320×512 patches and a batch size of 16.

In experiments involving aligned synthesis methods according to embodiments, a pre-trained diffusion model (e.g., comprising a latent u-net) was trained for 1,500 steps with a learning rate of 1×10⁻⁵. In experiments involving texture conditional models according to embodiments, a texture conditional model was trained for 10,000 steps with a learning rate of 1×10⁻⁴. The total training time across all experiments was around two and a half days on a single NVIDIA RTX A6000 GPU. During inference experiments, the DDIM scheduler [Song et al. 2021] was used with 50-step sampling.

The RealEstate10K dataset [Zhou et al. 2018] and the DL3DV-10K dataset [Ling et al. 2024] were used for training and evaluation. An “easy” evaluation set and a “hard” evaluation set was created for each dataset using different baseline ranges. In experiments involving the RealEstate10K dataset, five frames were skipped for the easy evaluation set, and a random ±30 frames were skipped for the hard evaluation set. This is similar to the settings used in experiments involving Flash3D [Szymanowicz et al. 2024a]. In experiments involving the DL3DV-10K dataset, three frames were skipped for the easy evaluation set and six frames were skipped for the hard evaluation set. These lesser frame skip counts are appropriate for the DL3DV-10K dataset, which features faster camera motions and more complex scenes.

In experiments in which the estimated depth was used to perform NVS, the same depth model was used in different trials for fair comparisons. For experiments involving the RealEstate10K dataset, the UniDepth model [Piccinelli et al. 2024] was used. For experiments involving the DL3DV-10K dataset, the DepthSplat model [Xu et al. 2024] was used.

Quantitative evaluations were conducted using pixel-level metrics (PSNR and SSIM), feature-level metrics (LPIPS [Zhang et al. 2018] and DISTS [Ding et al. 2022]), and distribution level metric FID [Heusel et al. 2017]. Further, various qualitive evaluations were conducted with various images captured “in the wild”. These quantitative and qualitative evaluations are discussed below.

### A. Benchmarking

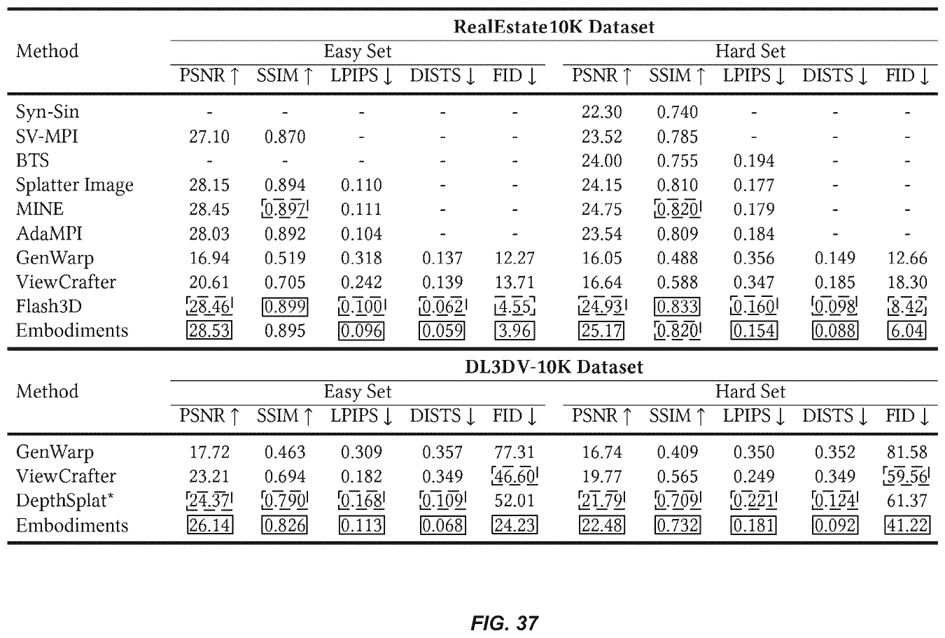

The table of FIG. 37 compares the performance of various methods (including methods according to embodiments) on the easy and hard evaluation sets from the RealEstate10K dataset and the DL3DV-10K dataset for single-view NVS (except for the DepthSplat method, which used two input views). The best and second-best performer in each performance metric is marked using solid boxes and dashed boxes respectively. As indicated by the table, for the RealEstate10K dataset, methods according to embodiments were the best performer for four out of five metrics on the easy evaluation set and the hard evaluation set (PSNR, LPIPS, DISTS, and FID), and were the second-best performer for the SSIM metric on the hard evaluation set. On the DL3DV-10K dataset, methods according to embodiments were the best performers in all metrics for both the easy and the hard evaluation set. In general terms, when better depth maps are available (e.g., on the DL3DV-10K dataset, in which the depth is estimated from two views), methods according to embodiments show much better performance than both diffusion-based and splatting-based. When using aligned synthesis training data generation methods and texture conditional model methods, embodiments even outperform the two-view method DepthSplat and generate better visual results with fine-grained detail.

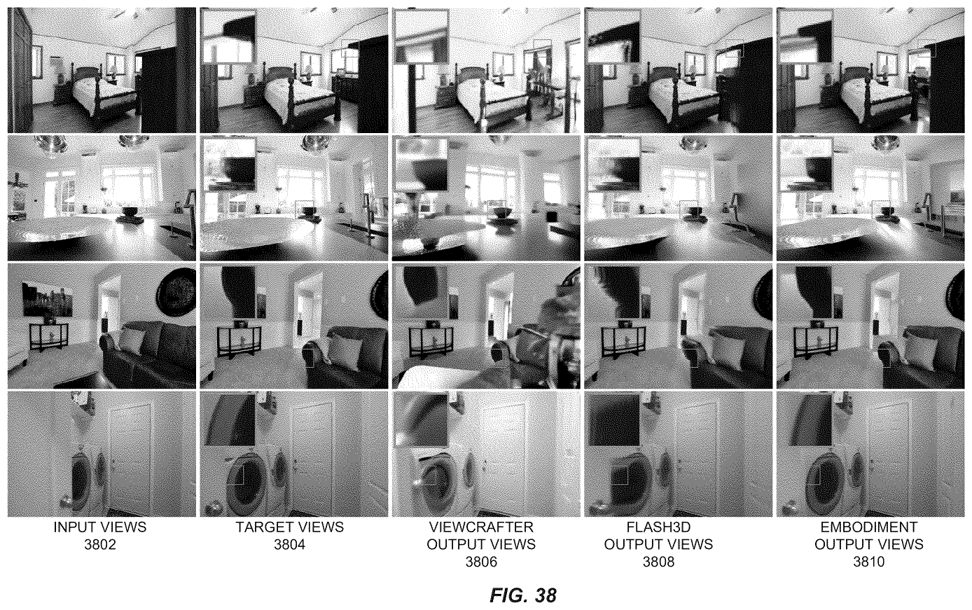

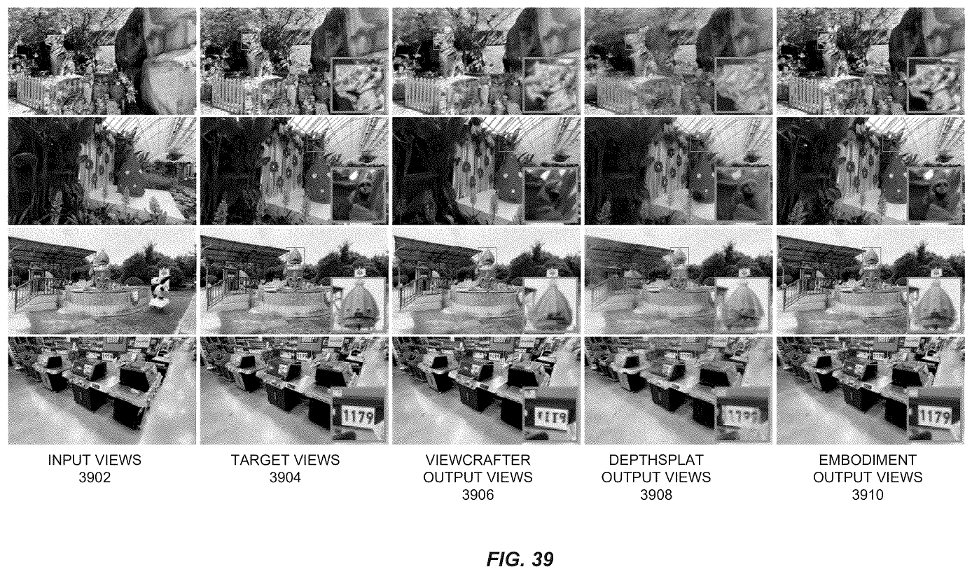

Qualitative comparisons of methods according to embodiments and various other methods on a single-view NVS task are presented in FIGS. 38 and 39. FIG. 38 provides a visual comparison on the RealEstate10K dataset and shows a set of input views 3802, corresponding target views 3804, and output views generated using ViewCrafter, Flash3D, and methods according to embodiments (i.e., ViewCrafter output views 3806, Flash3D output views 3808, and embodiment output views 3810). FIG. 39 provides a visual comparison on the DL3DV-10K dataset, and shows a set of input views 3902, corresponding target views 3904, and output views generated using ViewCrafter, DepthSplat, and methods according to embodiments (i.e., ViewCrafter output views 3906, DepthSlat output views 3908, and embodiment output views 3910).

Previous diffusion-based NVS methods, such as ViewCrafter, generally failed to achieve good metrics due to hallucinated geometry and texture (as shown in ViewCrafter output views 3806). While splatting-based methods like Flash3D can better preserve texture from input views, the generated novel views often suffer from geometry distortions due to splatting errors (as shown in Flash3D output views 3808). By contrast, methods according to embodiments produce the highest-quality output views with both consistent geometry and high-fidelity texture (as shown in embodiment output views 3810). The advantages of methods according to embodiments over the ViewCrafter method and DepthSplat method are similarly shown in the qualitative comparison of FIG. 39.

### B. Ablation Study

Various ablation studies were conducted using methods according to embodiments. As described above, embodiments are directed to various methods related to NVS, including methods for performing NVS, methods for generating training data to perform NVS, methods for using a texture conditional model to preserve texture during image-to-image diffusion, etc. While such methods can be performed together, they can also be performed independently, e.g., methods according to embodiments for performing NVS can be performed without using a texture conditional model. In general terms, the ablation studies evaluated the contribution of various methods according to embodiments to the quality of generated novel view images, e.g., in view of some of the metrics described above. These methods include training pair alignment (TPA), splatting error simulation (SES), the use of a texture conditional model (or “texture bridge”—TB), and the use of texture degradation (TD) when training a texture conditional model according to embodiments.

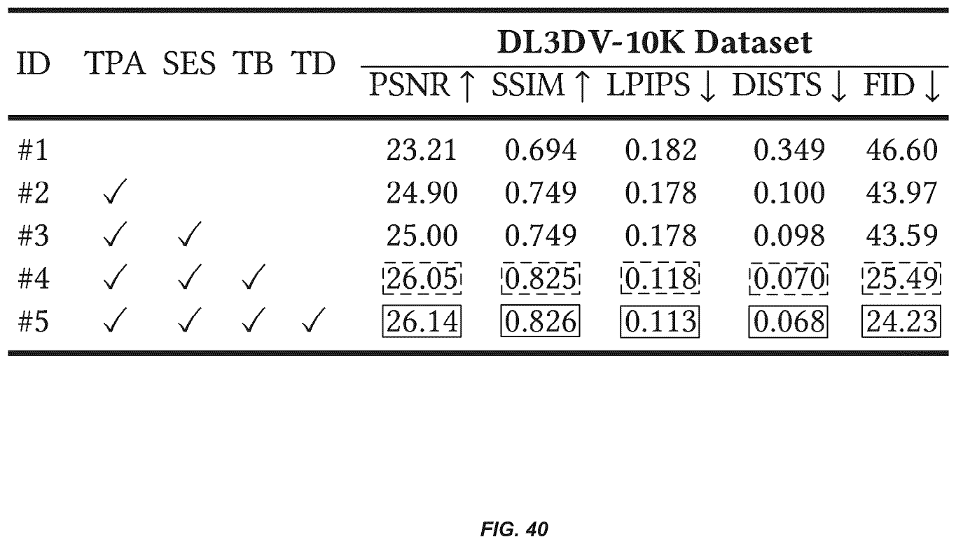

FIG. 40 shows a table summarizing the result of some ablation studies performed using the DL3DV-10K dataset. A baseline model (ID #1) and various combinations of methods according to embodiments were tested on a single-view NVS task, and the best and second-best performers for each performance metric are marked with a solid boxes and dashed boxes respectively. As indicated by the table, using methods according to embodiments in combination generally improves performance metrics, with a combination of training pair alignment (TPA), splatting error simulation (SES), texture conditional model (or “texture bridge”—TB), and texture degradation (TD) methods resulting in the best performance.

Compared with the baseline model (ID #1), a diffusion model trained using training pair alignment methods according to embodiments (ID #2) had better performance (shown by, e.g., 1.69 dB of PSNR gain) due to increased consistency between conditioned and generated views. With the addition of splatting error simulation (ID #3), the diffusion model saw further improvement by correcting splatting errors using geometric priors. The addition of a texture conditional model (ID #4) saw large improvement over all metrics by aggregating multi-scale features from the splatted view and the diffusion output, thereby handling texture information and improving feature fusion for better synthesis. The further addition of texture degradation (TD) methods in training the texture conditional model (ID #5) resulted in the best overall performance, demonstrating the effectiveness of methods according to embodiments.

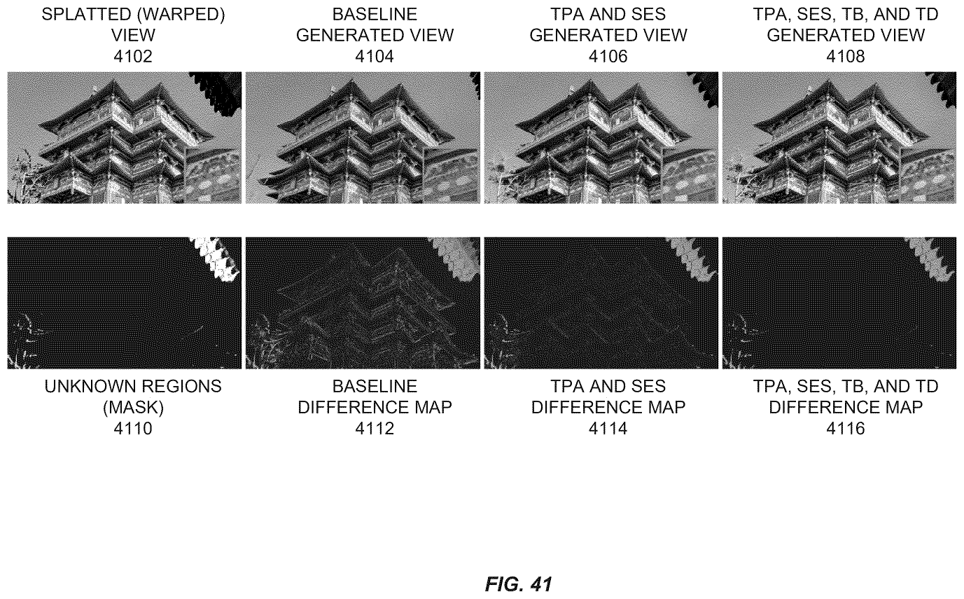

FIG. 41 provides a visual comparison for the ablation studies described above. FIG. 41 shows a splatted (or “warped”) view 4102 and three novel views generated using a baseline model and various combinations of methods according to embodiments, more specifically a baseline generated view 4104 (generated using a baseline model, i.e., corresponding to ID #1 in the table of FIG. 40), a TPA and SES generated view 4106 (generated using methods corresponding to ID #3 in the table of FIG. 40), and a TPA, SES, TB, and TD generated view 4108 (generated using methods corresponding to ID #5 in the table of FIG. 40).

FIG. 41 also shows unknown regions 4110, e.g., corresponding to a disocclusion mask corresponding to a warping operation used to generate splatted view 4102. FIG. 41 further shows a baseline difference map 4112, a TPA and SES difference map 4114, and a TPA, SES, TB, and TD difference map 4116, corresponding to baseline generated view 4104, TPA and SES generated view 4106, and TPA, SES, TB, and TD generated view 4108 respectively. These difference maps show the absolute difference between the splatted view and each corresponding generated view. In general, the difference maps improve as more methods according to embodiments are incorporated into the NVS task.

Generally, the baseline model synthesizes misaligned novel views and produces hallucinated texture, leading to difference regions across the entire baseline generated view 4104, as shown in baseline difference map 4112. Incorporating training pair alignment and splatting error simulation methods according to embodiments improves the results (as shown by TPA and SES generated view 4106 and corresponding TPA and SES difference map 4114). The further inclusion of texture conditional model methods according to embodiments and texture degradation methods according to embodiments further improve performance by synthesizing geometrically-aligned novel views while recovering high-fidelity texture, as shown by TPA, SES, TB, and TD generated view 4108 and corresponding TPA, SES, TB, and TD difference map 4116.

### C. Application Experiments

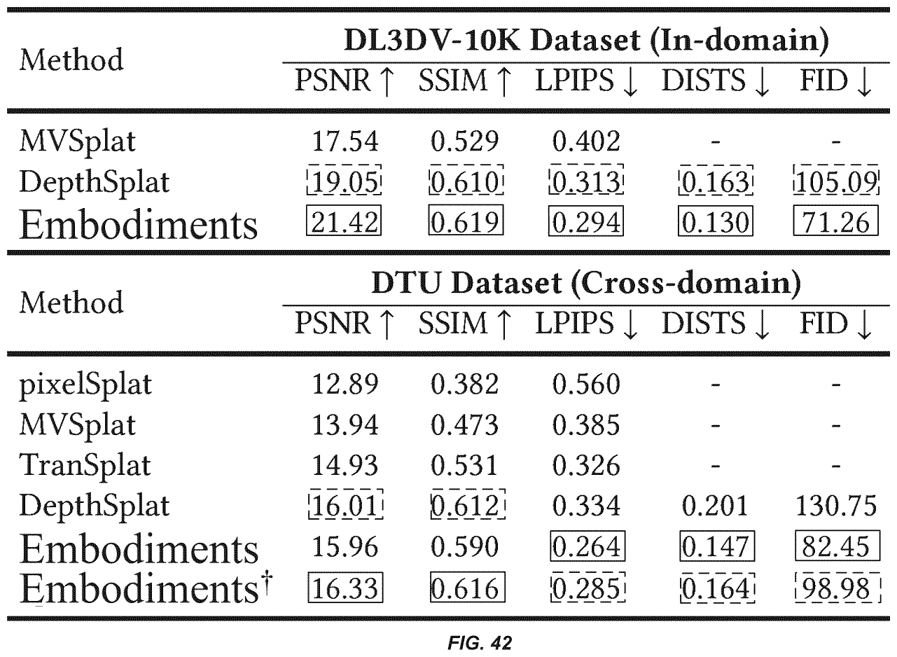

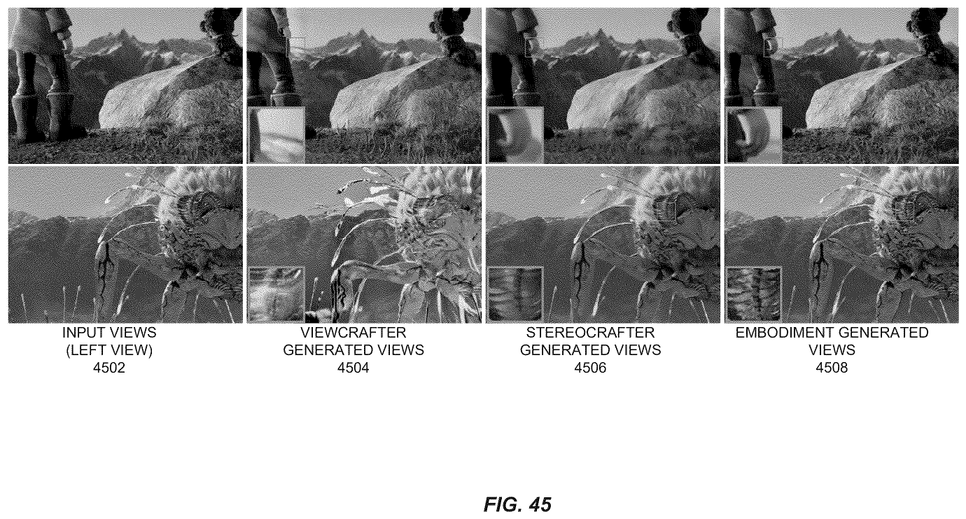

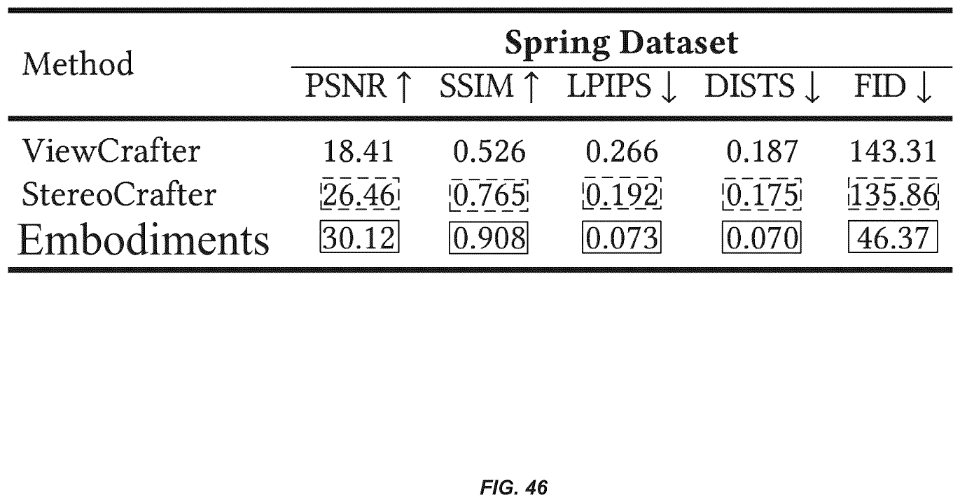

Various experiments were conducted involving applying methods according to embodiments to various NVS tasks, including sparse-view NVS and stereo video conversion. As shown in the table of FIG. 42 and the visual comparisons of FIGS. 43 and 44, methods according to embodiments show strong in-domain and cross-domain performance on sparse-view NVS tasks. As shown in the table of FIG. 46 and the visual comparisons of FIGS. 45, 47, and 48, methods according to embodiments achieve the best stereo video conversion performance out of all tested methods.

### 1. Sparse-View Novel View Synthesis

The table of FIG. 42 summarizes a qualitative evaluation of various methods on sparse-view NVS tasks (including methods according to embodiments). In-domain evaluation was performed using the DL3DV-10K dataset and cross-domain evaluation was performed using the DTU dataset [Jensen et al. 2014]. In these experiments, sparse-view NVS performance was evaluating two input views. Two splatted views were generated, and the splatted view with fewer unknown regions was selected as the primary input. The other splatted view was used to fill the unknown regions with a blurred blending mask. The best and second-best results in each performance metric are indicated with solid boxes and dashed boxes respectively.

Under limited observations, it can be challenging to estimate accurate parameters for 3D Gaussians. As a result, methods that use 3D Gaussians can produce “cloudy” novel view images. This phenomenon can be seen in FIG. 43, which provides a visual comparison of sparse-view NVS results from the in-domain evaluation on the DL3DV-10K dataset. FIG. 43 shows input views 4302, corresponding target views 4304, DepthSplat generated views 4306 (generated using DepthSplat methods) and embodiment generated views 4308 (generated using methods according to embodiments). As shown in FIG. 43, DepthSplat generated views 4306 are cloudy due to the challenges associated with estimating accurate parameters for 3D Gaussians. As evident by comparing DepthSplat generated views 4306 and embodiment generated views 4308, and as shown in the table of FIG. 42, methods according to embodiments achieve better visual quality and achieve better performance metrics on the DL3DV-10 in-domain evaluation.

For the cross-domain evaluation on the DTU dataset [Jensen et al. 2014], estimated depth is less accurate due to the domain gap. This leads to misalignment between the splatted view and the target view, which can result in lower pixel-level evaluation metrics relative to Gaussian splatting approaches (e.g., DepthSplat), which often blur details to handle misalignment. However, visual comparison shows that methods according to embodiments achieve better visual quality with better fine-grained detail. This is shown in FIG. 44, which provides a visual comparison of sparse-view NVS results from the cross-domain evaluation on the DTU dataset. FIG. 44 shows input view 4402, corresponding target views 4404, DepthSplat generated views 4406 (generated using DepthSplat methods) and embodiment generated views 4408 (generated using methods according to embodiments). As evident by comparing DepthSplat generated views 4406 and embodiment generated views 4408, embodiment generated vies 4408 are less blurry, have higher texture resolution, and are more accurate to the target views 4404. To mitigate some misalignment issues, in some experiments, the novel views generated from two splatted views were averaged. These are reported in the table of 42 as “Embodimentst”, which outperform DepthSplat across all metrics.

### 2. Stereo Video Conversion

Stereo video conversion is an often-performed task in movie production. As such, experiments were performed to evaluate and demonstrate the effectiveness of methods according to embodiments on this task. In some experiments, the Spring dataset [Mehl et al. 2023] was used for evaluation, which features high-resolution stereo videos from the Blender movie “Spring”. Methods according to embodiments were used to generate right-eye views from input left-eye videos, and the ground-truth disparity was used to evaluate performance. FIG. 45 provides a visual comparison of views generated using methods according to embodiments and various other methods on a stereo video conversion task for the Spring dataset. Specifically, FIG. 45 shows input views 4502 (corresponding to left-eye views from the Spring dataset), ViewCrafter generated views 4504 (generated using ViewCrafter methods), StereoCrafter generated views 4506 (generated using StereoCrafter methods), and embodiment generated views 4508 (generated using methods according to embodiments), each corresponding to ground-truth right-eye views from the Spring dataset.

As shown in FIG. 45, ViewCrafter had difficulties handling dynamic scenes, resulting in generated views that were very different from corresponding input views. StereoCrafter was able to generate novel views that were more consistent with input views, but such novel views often suffered from texture hallucination and blurry detail. By contrast, methods according to embodiments were used to generate high-quality, high-fidelity novel view image frames. This is further evidenced by the table of FIG. 46, which provides a quantitative evaluation of stereo video conversion experiments, in which the best and second-best results in each performance metric are indicated using solid boxes and dashed boxes respectively. As indicated by the table, methods according to embodiments performed the best in all five performance metrics.

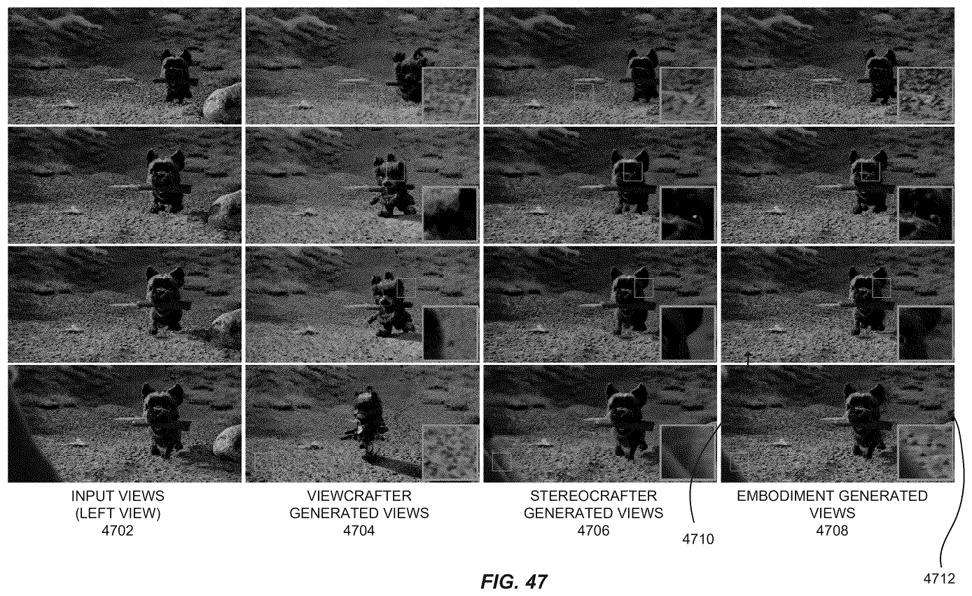

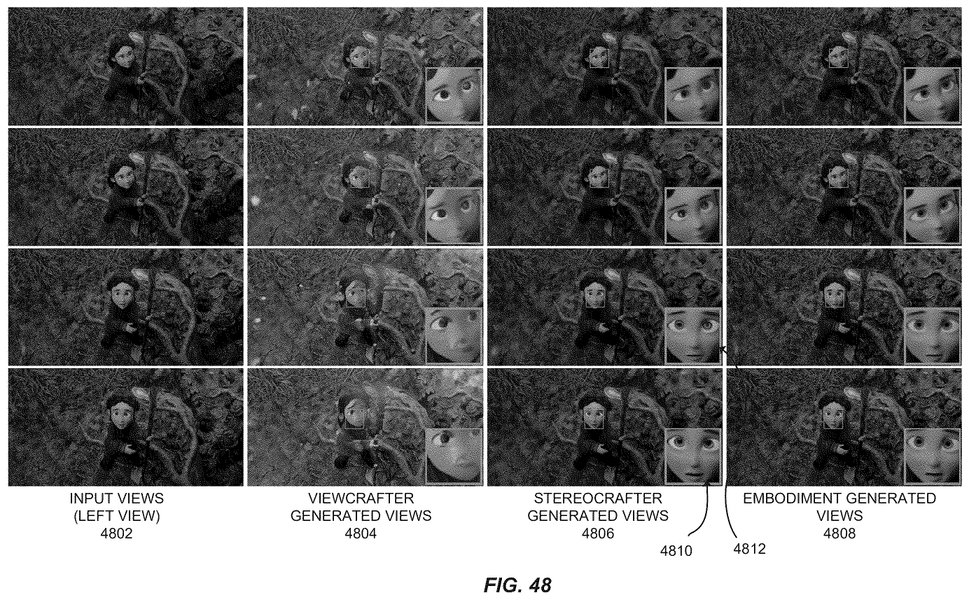

Further stereo video conversion results on the Spring dataset [Mehl et al. 2023] are shown in FIGS. 47 and 48. FIG. 47 shows input views 4702 (corresponding to left-eye views from the Spring dataset), ViewCrafter generated views 4704 (generated using ViewCrafter methods), StereoCrafter generated views 4706 (generated using StereoCrafter methods), and embodiment generated views 4708 (generated using methods according to embodiments). Likewise, FIG. 48 shows input views 4802 (corresponding to left-eye views from the Spring dataset), Viewcrafter generated views 4804 (generated using ViewCrafter methods), StereoCrafter generated views 4806 (generated using StereoCrafter methods), and embodiment generated views 4808 (generated using methods according to embodiments. As with FIG. 45, each generated view corresponds to ground-truth right-eye views from the Spring dataset.

As shown in FIG. 47, methods according to embodiments exhibit good zero-shot performance in dynamic scenes. Texture conditional model methods according to embodiments effectively leverage splatted views to maintain motion consistent with input view videos. Further, aligned synthesis methods according to embodiments lead to reasonable inpainting in disocclusion regions, e.g., in embodiment generated views 4710 and 4712, achieving high-quality stereo video synthesis. Methods according to embodiments outperform ViewCrafter, which has difficulty handling dynamic inputs and producing severe content hallucinations, as shown in ViewCrafter generated views 4704. Even when compared to StereoCrafter [Zhao et al. 2024], which is designed specifically for stereo video conversion, methods according to embodiments still show superior performance in novel view image quality and consistency. As shown in StereoCrafter generated views 4706, StereoCrafter tends to produce novel views with smoothed details (e.g., the rock on the road) and fills blurred content for disocclusion regions. Further, StereoCrafter can generate inconsistent details, e.g., the girl's eyes in zoom-in regions 4810 and 4812 of FIG. 48. As shown by FIGS. 45, 46, 47, and 48, methods according to embodiments produce better stereo conversion results than previous state-of-the-art methods, producing novel view images with consistent geometry and realistic details, verifying the effectiveness and versatility of methods according to embodiments.

### 3. Zero-Shot Comparison

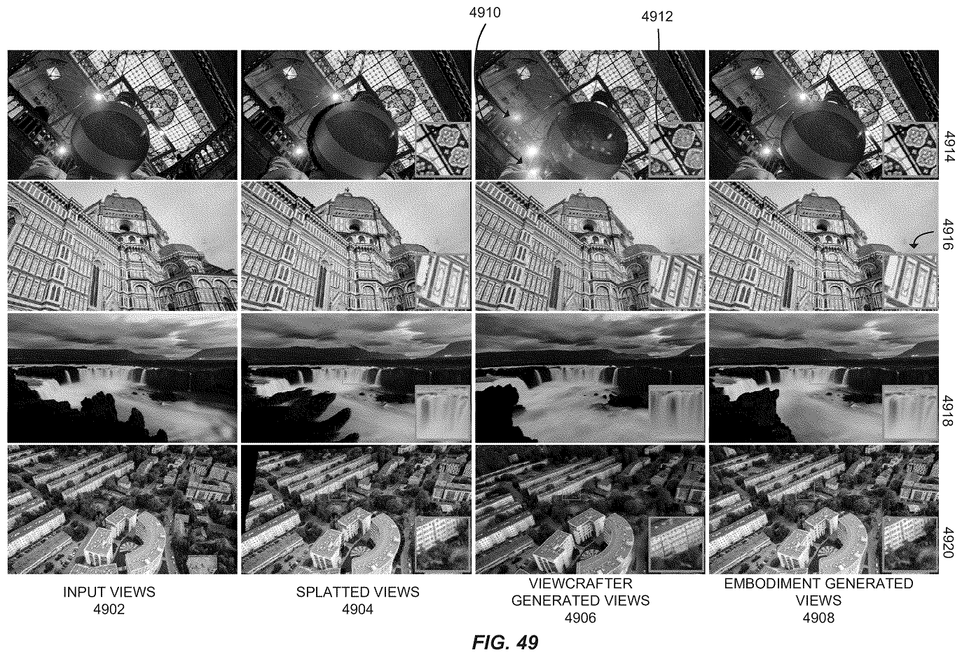

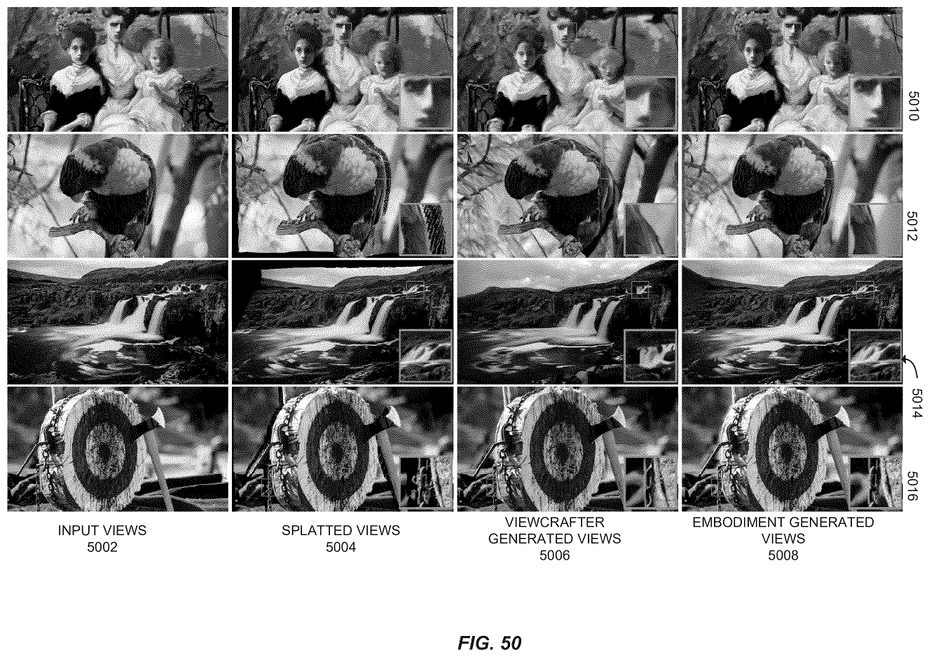

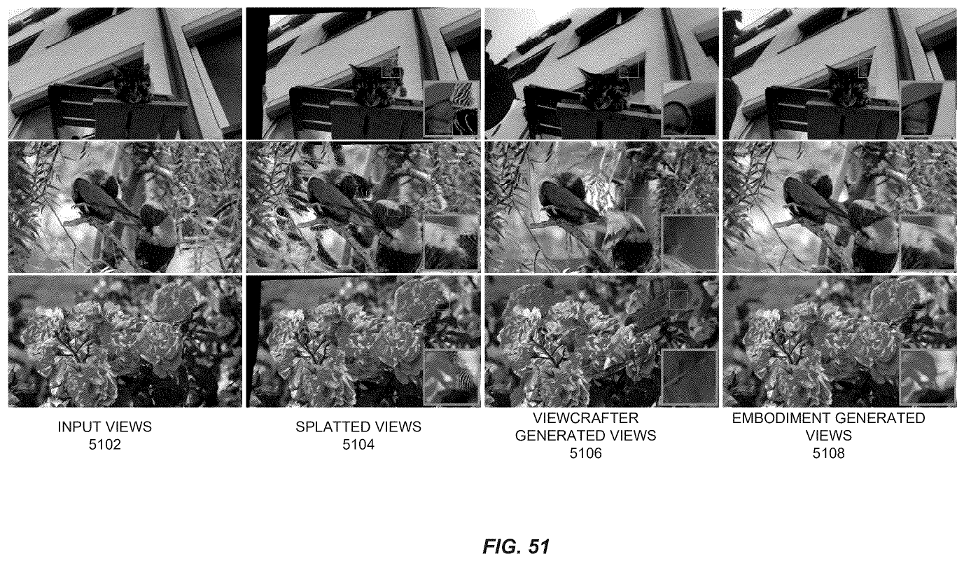

Further qualitative comparisons of zero-shot performance of methods according to embodiments and ViewCrafter methods were performed on diverse “in-the-wild” sample images, including high resolution (576×1024 pixels) sample images, including landscapes, buildings, animals, and paintings. These qualitative comparisons are shown in FIGS. 49, 50, and 51. FIG. 49 shows input views 4902, splatted views 4904, ViewCrafter generated views 4906 (generated using ViewCrafter methods), and embodiment generated views 4908 (generated using methods according to embodiments). Likewise, FIG. 50 shows input views 5002, splatted views 5004, ViewCrafter generated views 5006 (generated using ViewCrafter methods), and embodiment generated views 5008 (generated using methods according to embodiments). As shown in ViewCrafter generated views 4906 and 5006, previous approaches such as ViewCrafter [Yu et al. 2024] often generate image content that is different from input images, e.g., hallucinated lights 4910 and hallucinated rooftop texture 4912. By contrast, methods according to embodiments preserve geometric layouts while recovering fine-grained detail, as shown in zoom-in regions 4914-4920 of FIG. 49 and zoom-in regions 5010-5016 of FIG. 50. In addition, due to aligned synthesis methods according to embodiments, embodiment generated views correct splatting errors presented in splatted views 4904 and 5004 and generate reasonable contents for the unknown regions, as shown in zoom-in regions 5012 and 5016 in FIG. 50. FIG. 51 shows further qualitive comparisons of methods according to embodiments and ViewCrafter, specifically showing input views 5102, splatted views 5104, ViewCrafter generated views 5106 (generated using ViewCrafter methods) and embodiment generated views 5108 (generated using methods according to embodiments). These zero-shot comparisons, as well as various other comparisons and experiments described in this section, demonstrate the effectiveness and versatility of methods according to embodiments.

### VIII. Computer Systems

FIG. 52 is a simplified block diagram of system 5200 for creating computer graphics imagery (CGI) and computer-aided animation that may implement or incorporate various embodiments. In this example, system 5200 can include one or more design computers 5210, object libraries 5220, one or more object modeling systems 5230, one or more object articulation systems 5240, one or more object animation systems 5250, one or more object simulation systems 5260, and one or more object rendering systems 5270. Any of the systems 5230-5270 may be invoked by or used directly by a user of the one or more design computers 5210 and/or automatically invoked by or used by one or more processes associated with the one or more design computers 5210. Any of the elements of system 5200 can include hardware and/or software elements configured for specific functions.

The one or more design computers 5210 can include hardware and software elements configured for designing CGI and assisting with computer-aided animation. Each of the one or more design computers 5210 may be embodied as a single computing device or a set of one or more computing devices. Some examples of computing devices are PCs, laptops, workstations, mainframes, cluster computer system, grid computer systems, cloud computer systems, embedded devices, computer graphics devices, gaming devices and consoles, consumer electronic devices having programmable processors, or the like. The one or more design computers 5210 may be used at various stages of a production process (e.g., pre-production, designing, creating, editing, simulating, animating, rendering, post-production, etc.) to produce images, image sequences, motion pictures, video, audio, or associated effects related to CGI and animation.

In one example, a user of the one or more design computers 5210 acting as a modeler may employ one or more systems or tools to design, create, or modify objects within a computer-generated scene. The modeler may use modeling software to sculpt and refine a neutral 3D model to fit predefined aesthetic needs of one or more character designers. The modeler may design and maintain a modeling topology conducive to a storyboarded range of deformations. In another example, a user of the one or more design computers 5210 acting as an articulator may employ one or more systems or tools to design, create, or modify controls or animation variables (avers) of models. In general, rigging is a process of giving an object, such as a character model, controls for movement, therein “articulating” its ranges of motion. The articulator may work closely with one or more animators in rig building to provide and refine an articulation of the full range of expressions and body movement needed to support a character's acting range in an animation. In a further example, a user of design computer 5210 acting as an animator may employ one or more systems or tools to specify motion and position of one or more objects over time to produce an animation.

Object libraries 5220 can include elements configured for storing and accessing information related to objects used by the one or more design computers 5210 during the various stages of a production process to produce CGI and animation. Some examples of object libraries 5220 can include a file, a database, or other storage devices and mechanisms. Object libraries 5220 may be locally accessible to the one or more design computers 5210 or hosted by one or more external computer systems.

Some examples of information stored in object libraries 5220 can include an object itself, metadata, object geometry, object topology, rigging, control data, animation data, animation cues, simulation data, texture data, lighting data, shader code, or the like. An object stored in object libraries 5220 can include any entity that has an n-dimensional (e.g., 2D or 3D) surface geometry. The shape of the object can include a set of points or locations in space (e.g., object space) that make up the object's surface. Topology of an object can include the connectivity of the surface of the object (e.g., the genus or number of holes in an object) or the vertex/edge/face connectivity of an object.

The one or more object modeling systems 5230 can include hardware and/or software elements configured for modeling one or more objects. Modeling can include the creating, sculpting, and editing of an object. In various embodiments, the one or more object modeling systems 5230 may be configured to generate a model to include a description of the shape of an object. The one or more object modeling systems 5230 can be configured to facilitate the creation and/or editing of features, such as non-uniform rational B-splines or NURBS, polygons and subdivision surfaces (or SubDivs), that may be used to describe the shape of an object. In general, polygons are a widely used model medium due to their relative stability and functionality. Polygons can also act as the bridge between NURBS and SubDivs. NURBS are used mainly for their ready-smooth appearance and generally respond well to deformations. SubDivs are a combination of both NURBS and polygons representing a smooth surface via the specification of a coarser piecewise linear polygon mesh. A single object may have several different models that describe its shape.

The one or more object modeling systems 5230 may further generate model data (e.g., 2D and 3D model data) for use by other elements of system 5200 or that can be stored in object library 5220. The one or more object modeling systems 5230 may be configured to allow a user to associate additional information, metadata, color, lighting, rigging, controls, or the like, with all or a portion of the generated model data.

The one or more object articulation systems 5240 can include hardware and/or software elements configured to articulating one or more computer-generated objects. Articulation can include the building or creation of rigs, the rigging of an object, and the editing of rigging. In various embodiments, the one or more articulation systems 2140 can be configured to enable the specification of rigging for an object, such as for internal skeletal structures or eternal features, and to define how input motion deforms the object. One technique is called “skeletal animation,” in which a character can be represented in at least two parts: a surface representation used to draw the character (called the skin) and a hierarchical set of bones used for animation (called the skeleton).

The one or more object articulation systems 5240 may further generate articulation data (e.g., data associated with controls or animations variables) for use by other elements of system 5200 or that can be stored in object libraries 5220. The one or more object articulation systems 5240 may be configured to allow a user to associate additional information, metadata, color, lighting, rigging, controls, or the like, with all or a portion of the generated articulation data.

The one or more object animation systems 5250 can include hardware and/or software elements configured for animating one or more computer-generated objects. Animation can include the specification of motion and position of an object over time. The one or more object animation systems 5250 may be invoked by or used directly by a user of the one or more design computers 5210 and/or automatically invoked by or used by one or more processes associated with the one or more design computers 5210.

In various embodiments, the one or more animation systems 5250 may be configured to enable users to manipulate controls or animation variables or utilized character rigging to specify one or more key frames of animation sequence. The one or more animation systems 5250 generate intermediary frames based on the one or more key frames. In some embodiments, the one or more animation systems 5250 may be configured to enable users to specify animation cues, paths, or the like according to one or more predefined sequences. The one or more animation systems 5250 generate frames of the animation based on the animation cues or paths. In further embodiments, the one or more animation systems 5250 may be configured to enable users to define animations using one or more animation languages, morphs, deformations, or the like.

The one or more object animations systems 5250 may further generate animation data (e.g., inputs associated with controls or animations variables) for use by other elements of system 5200 or that can be stored in object libraries 5220. The one or more object animations systems 5250 may be configured to allow a user to associate additional information, metadata, color, lighting, rigging, controls, or the like, with all or a portion of the generated animation data.

The one or more object simulation systems 5260 can include hardware and/or software elements configured for simulating one or more computer-generated objects. Simulation can include determining motion and position of an object over time in response to one or more simulated forces or conditions. The one or more object simulation systems 5260 may be invoked by or used directly by a user of the one or more design computers 5210 and/or automatically invoked by or used by one or more processes associated with the one or more design computers 5210.

In various embodiments, the one or more object simulation systems 5260 may be configured to enables users to create, define, or edit simulation engines, such as a physics engine or physics processing unit (PPU/GPGPU) using one or more physically-based numerical techniques. In general, a physics engine can include a computer program that simulates one or more physics models (e.g., a Newtonian physics model), using variables such as mass, velocity, friction, wind resistance, or the like. The physics engine may simulate and predict effects under different conditions that would approximate what happens to an object according to the physics model. The one or more object simulation systems 5260 may be used to simulate the behavior of objects, such as hair, fur, and cloth, in response to a physics model and/or animation of one or more characters and objects within a computer-generated scene.

The one or more object simulation systems 5260 may further generate simulation data (e.g., motion and position of an object over time) for use by other elements of system 5200 or that can be stored in object libraries 5220. The generated simulation data may be combined with or used in addition to animation data generated by the one or more object animation systems 5250. The one or more object simulation systems 5260 may be configured to allow a user to associate additional information, metadata, color, lighting, rigging, controls, or the like, with all or a portion of the generated simulation data.

The one or more object rendering systems 5270 can include hardware and/or software element configured for “rendering” or generating one or more images of one or more computer-generated objects. “Rendering” can include generating an image from a model based on information such as geometry, viewpoint, texture, lighting, and shading information. The one or more object rendering systems 5270 may be invoked by or used directly by a user of the one or more design computers 5210 and/or automatically invoked by or used by one or more processes associated with the one or more design computers 5210. One example of a software program embodied as the one or more object rendering systems 5270 can include PhotoRealistic RenderMan, or PRMan, produced by Pixar Animations Studios of Emeryville, California.

In various embodiments, the one or more object rendering systems 5270 can be configured to render one or more objects to produce one or more computer-generated images or a set of images over time that provide an animation. The one or more object rendering systems 5270 may generate digital images or raster graphics images.

In various embodiments, a rendered image can be understood in terms of a number of visible features. Some examples of visible features that may be considered by the one or more object rendering systems 5270 may include shading (e.g., techniques relating to how the color and brightness of a surface varies with lighting), texture-mapping (e.g., techniques relating to applying detail information to surfaces or objects using maps), bump-mapping (e.g., techniques relating to simulating small-scale bumpiness on surfaces), fogging/participating medium (e.g., techniques relating to how light dims when passing through non-clear atmosphere or air) shadows (e.g., techniques relating to effects of obstructing light), soft shadows (e.g., techniques relating to varying darkness caused by partially obscured light sources), reflection (e.g., techniques relating to mirror-like or highly glossy reflection), transparency or opacity (e.g., techniques relating to sharp transmissions of light through solid objects), translucency (e.g., techniques relating to highly scattered transmissions of light through solid objects), refraction (e.g., techniques relating to bending of light associated with transparency), diffraction (e.g., techniques relating to bending, spreading and interference of light passing by an object or aperture that disrupts the ray), indirect illumination (e.g., techniques relating to surfaces illuminated by light reflected off other surfaces, rather than directly from a light source, also known as global illumination), caustics (e.g., a form of indirect illumination with techniques relating to reflections of light off a shiny object, or focusing of light through a transparent object, to produce bright highlights on another object), depth of field (e.g., techniques relating to how objects appear blurry or out of focus when too far in front of or behind the object in focus), motion blur (e.g., techniques relating to how objects appear blurry due to high-speed motion, or the motion of the camera), non-photorealistic rendering (e.g., techniques relating to rendering of scenes in an artistic style, intended to look like a painting or drawing), or the like.

The one or more object rendering systems 5270 may further render images (e.g., motion and position of an object over time) for use by other elements of system 5200 or that can be stored in object libraries 5220. The one or more object rendering systems 5270 may be configured to allow a user to associate additional information or metadata with all or a portion of the rendered image.

FIG. 53 is a block diagram of computer system 5300. FIG. 53 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 5300 and any of its components or subsystems can include hardware and/or software elements configured for performing methods described herein.

Computer system 5300 may include familiar computer components, such as one or more one or more data processors or central processing units (CPUs) 5305, one or more graphics processors or graphical processing units (GPUs) 5310, memory subsystem 5315, storage subsystem 5320, one or more input/output (I/O) interfaces 5325, communications interface 5330, or the like. Computer system 5300 can include system bus 5335 interconnecting the above components and providing functionality, such connectivity and inter-device communication.

The one or more data processors or central processing units (CPUs) 5305 can execute logic or program code or for providing application-specific functionality. Some examples of CPU(s) 5305 can include one or more microprocessors (e.g., single core and multi-core) or micro-controllers, one or more field-gate programmable arrays (FPGAs), and application-specific integrated circuits (ASICs). As user herein, a processor includes a multi-core processor on a same integrated chip, or multiple processing units on a single circuit board or networked.

The one or more graphics processor or graphical processing units (GPUs) 5310 can execute logic or program code associated with graphics or for providing graphics-specific functionality. GPUs 5310 may include any conventional graphics processing unit, such as those provided by conventional video cards. In various embodiments, GPUs 5310 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 5310 may include any number of registers, logic units, arithmetic units, caches, memory interfaces, or the like.

Memory subsystem 5315 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 5315 can include data and program code 5340.

Storage subsystem 5320 can also store information using machine-readable articles, information storage devices, or computer-readable storage media. Storage subsystem 5320 may store information using storage media 5345. Some examples of storage media 5345 used by storage subsystem 5320 can include floppy disks, hard disks, optical storage media such as CD-ROMS, DVDs and bar codes, removable storage devices, networked storage devices, or the like. In some embodiments, all or part of data and program code 5340 may be stored using storage subsystem 5320.

The one or more input/output (I/O) interfaces 5325 can perform I/O operations. One or more input devices 5350 and/or one or more output devices 5355 may be communicatively coupled to the one or more I/O interfaces 5325. The one or more input devices 5350 can receive information from one or more sources for computer system 5300. Some examples of the one or more input devices 5350 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 5350 may allow a user of computer system 5300 to interact with one or more non-graphical or graphical user interfaces to enter a comment, select objects, icons, text, user interface widgets, or other user interface elements that appear on a monitor/display device via a command, a click of a button, or the like.

The one or more output devices 5355 can output information to one or more destinations for computer system 5300. Some examples of the one or more output devices 5355 can include a printer, a fax, a feedback device for a mouse or joystick, external storage systems, a monitor or other display device, a communications interface appropriately configured as a transceiver, or the like. The one or more output devices 5355 may allow a user of computer system 5300 to view objects, icons, text, user interface widgets, or other user interface elements. A display device or monitor may be used with computer system 5300 and can include hardware and/or software elements configured for displaying information.

Communications interface 5330 can perform communications operations, including sending and receiving data. Some examples of communications interface 5330 may include a network communications interface (e.g., Ethernet, Wi-Fi, etc.). For example, communications interface 5330 may be coupled to communications network/external bus 5360, such as a computer network, a USB hub, or the like. A computer system can include a plurality of the same components or subsystems, e.g., connected together by communications interface 5330 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

In various embodiments, methods may involve various numbers of clients and/or servers, including at least 10, 20, 50, 100, 200, 500, 1000, or 10,000 devices. Methods can include various numbers of communication messages between devices, including at least 100, 200, 500, 1,000, 10,000, 50,000, 100,000, 500,000 or one million communication messages. Such communications can involve at least 1 MB, 10 MB, 100 MB, 1 GB, 10 GB, or 100 GB of data.

Computer system 5300 may also include one or more applications (e.g., software components or functions) to be executed by a processor to execute, perform, or otherwise implement techniques disclosed herein. These applications may be embodied as data and program code 5340. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 5315 and/or storage subsystem 5320. Any operations performed with a processor (or applications executed by a processor) may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

All patents, patent applications, publications, and descriptions mentioned herein are incorporated by reference in their entirety for all purposes. None is admitted as prior art. Where a conflict exists between the instant application and a reference provided herein, the instant application shall dominate.

### IX. REFERENCES

[JGG+14] Ran Ju, Ling Ge, Wenjing Geng, Tongwei Ren, and Gangshan Wu. Depth saliency based on anisotropic center-surround difference. In 2014 IEEE International Conference on Image Processing (ICIP), pages 1115-1119, 2014.
[JLW+24] Xuan Ju, Xian Liu, Xintao Wang, Yuxuan Bian, Ying Shan, and Qiang Xu. Brush-net: A plug-and-play image inpainting model with decomposed dual-branch diffusion, 2024.
[JZL+23] Yutao Jiang, Yang Zhou, Yuan Liang, Wenxi Liu, Jianbo Jiao, Yuhui Quan, and Shengfeng He. Diffuse3d: Wide-angle 3d photography via bilateral diffusion. In Proceedings of the IEEE/CVF International Conference on Computer Vision, pages 8998-9008, 2023.
[KOWD21] Yoni Kasten, Dolev Ofri, Oliver Wang, and Tali Dekel. Layered neural atlases for consistent video editing. ACM Transactions on Graphics (TOG), 40(6):1-12, 2021.
[MBGS24] Lukas Mehl, Andrés Bruhn, Markus Gross, and Christopher Schroers. Stereo conversion with disparity-aware warping, compositing and inpainting, 2024.
[PEL+23] Dustin Podell, Zion English, Kyle Lacey, Andreas Blattmann, Tim Dockhorn, Jonas Müller, Joe Penna, and Robin Rombach. Sdxl: Improving latent diffusion models for high-resolution image synthesis, 2023.
[RLH+20] René Ranftl, Katrin Lasinger, David Hafner, Konrad Schindler, and Vladlen Koltun. Towards robust monocular depth estimation: Mixing datasets for zero-shot cross-dataset transfer. IEEE Transactions on Pattern Analysis and Machine Intelligence (TPAMI), 2020.
[WFJB24] Lezhong Wang, Jeppe Revall Frisvad, Mark Bo Jensen, and Siavash Arjomand Bigdeli. Stereodiffusion: Training-free stereo image generation using latent diffusion models. In Proceedings of the IEEE/CVF Conference on Computer Vision and Pattern Recognition, pages 7416-7425, 2024.
[YKH+24] Lihe Yang, Bingyi Kang, Zilong Huang, Zhen Zhao, Xiaogang Xu, Jiashi Feng, and Hengshuang Zhao. Depth anything v2. arXiv:2406.09414, 2024.
[ZRA23] Lvmin Zhang, Anyi Rao, and Maneesh Agrawala. Adding conditional control to text-to-image diffusion models, 2023.
Ang Cao, Chris Rockwell, and Justin Johnson. 2022. Fwd: Real-time novel view synthesis with forward warping and depth. In CVPR. 15713-15724.
Eric R Chan, Koki Nagano, Matthew A Chan, Alexander W Bergman, Jeong Joon Park, Axel Levy, Miika Aittala, Shalini De Mello, Tero Karras, and Gordon Wetzstein. 2023. Generative novel view synthesis with 3d-aware diffusion models. In ICCV. 4217-4229.
David Charatan, Sizhe Lester Li, Andrea Tagliasacchi, and Vincent Sitzmann. 2024. pixelsplat: 3d gaussian splats from image pairs for scalable generalizable 3d reconstruction. In CVPR. 19457-19467.
Yuedong Chen, Haofei Xu, Chuanxia Zheng, Bohan Zhuang, Marc Pollefeys, Andreas Geiger, Tat-Jen Cham, and Jianfei Cai. 2025. Mvsplat: Efficient 3d gaussian splatting from sparse multi-view images. In ECCV. Springer, 370-386.
Keyan Ding, Kede Ma, Shiqi Wang, and Eero P. Simoncelli. 2022. Image quality assessment: Unifying structure and texture similarity. IEEE TPAMI 44, 5 (2022), 2567-2581. https://doi.org/10.1109/TPAMI.2020.3045810
Xiao Fu, Wei Yin, Mu Hu, Kaixuan Wang, Yuexin Ma, Ping Tan, Shaojie Shen, Dahua Lin, and Xiaoxiao Long. 2025. Geowizard: Unleashing the diffusion priors for 3d geometry estimation from a single image. In ECCV. Springer, 241-258.
Ruiqi Gao, Aleksander Holynski, Philipp Henzler, Arthur Brussee, Ricardo Martin-Brualla, Pratul Srinivasan, Jonathan T Barron, and Ben Poole. 2024. Cat3d: Create anything in 3d with multi-view diffusion models. In NeurIPS.
Yuxuan Han, Ruicheng Wang, and Jiaolong Yang. 2022. Single-View View Synthesis in the Wild with Learned Adaptive Multiplane Images. In ACM SIGGRAPH 2022 Conference Proceedings (Vancouver, BC, Canada) (SIGGRAPH '22). Association for Computing Machinery, New York, NY, USA, Article 14, 8 pages. https://doi.org/10. 1145/3528233.3530755
Kaiming He, Xiangyu Zhang, Shaoqing Ren, and Jian Sun. 2016. Deep residual learning for image recognition. In CVPR. 770-778.
Martin Heusel, Hubert Ramsauer, Thomas Unterthiner, Bernhard Nessler, and Sepp Hochreiter. 2017. Gans trained by a two time-scale update rule converge to a local nash equilibrium. NeurIPS 30 (2017).
Jonathan Ho, Ajay Jain, and Pieter Abbeel. 2020. Denoising diffusion probabilistic models. In NeurIPS, Vol. 33. 6840-6851.
Rasmus Jensen, Anders Dahl, George Vogiatzis, Engin Tola, and Henrik Aanos. 2014. Large scale multi-view stereopsis evaluation. In CVPR. 406-413.
Yutao Jiang, Yang Zhou, Yuan Liang, Wenxi Liu, Jianbo Jiao, Yuhui Quan, and Shengfeng He. 2023. Diffuse3D: Wide-Angle 3D Photography via Bilateral Diffusion. In ICCV. 8998-9008.
Bingxin Ke, Dominik Narnhofer, Shengyu Huang, Lei Ke, Torben Peters, Katerina Fragkiadaki, Anton Obukhov, and Konrad Schindler. 2024a. Video Depth without Video Models. arXiv preprint arXiv:2411.19189 (2024).
Bingxin Ke, Anton Obukhov, Shengyu Huang, Nando Metzger, Rodrigo Caye Daudt, and Konrad Schindler. 2024b. Repurposing diffusion-based image generators for monocular depth estimation. In CVPR. 9492-9502.
Bernhard Kerbl, Georgios Kopanas, Thomas Leimkiihler, and George Drettakis. 2023. 3D Gaussian Splatting for Real-Time Radiance Field Rendering. ACM Trans. Graph. 42, 4 (July 2023). https://repo-sam.inria.fr/fungraph/3d-gaussian-splatting/
Numair Khan, Lei Xiao, and Douglas Lanman. 2023. Tiled multiplane images for practical 3d photography. In ICCV. 10454-10464.
Jiaxin Li, Zijian Feng, Qi She, Henghui Ding, Changhu Wang, and Gim Hee Lee. 2021. Mine: Towards continuous depth mpi with nerf for novel view synthesis. In ICCV. 12578-12588.
Lu Ling, Yichen Sheng, Zhi Tu, Wentian Zhao, Cheng Xin, Kun Wan, Lantao Yu, Qianyu Guo, Zixun Yu, Yawen Lu, et al. 2024. D13dv-10k: A large-scale scene dataset for deep learning-based 3d vision. In CVPR. 22160-22169.
Fangfu Liu, Wenqiang Sun, Hanyang Wang, Yikai Wang, Haowen Sun, Junliang Ye, Jun Zhang, and Yueqi Duan. 2024. Reconx: Reconstruct any scene from sparse views with video diffusion model. arXiv preprint arXiv:2408.16767 (2024).
Ruoshi Liu, Rundi Wu, Basile Van Hoorick, Pavel Tokmakov, Sergey Zakharov, and Carl Vondrick. 2023. Zero-1-to-3: Zero-shot one image to 3d object. In ICCV. 9298-9309.
Ilya Loshchilov and Frank Hutter. 2019. Decoupled Weight Decay Regularization. In ICLR.
Lukas Mehl, Andr6s Bruhn, Markus Gross, and Christopher Schroers. 2024. Stereo Conversion with Disparity-Aware Warping, Compositing and Inpainting. In WACV. 4260-4269.
Lukas Mehl, Jenny Schmalfuss, Azin Jahedi, Yaroslava Nalivayko, and Andr6s Bruhn. 2023. Spring: A high-resolution high-detail dataset and benchmark for scene flow, optical flow and stereo. In CVPR. 4981-4991.
Ben Mildenhall, Pratul P. Srinivasan, Matthew Tancik, Jonathan T. Barron, Ravi Ramamoorthi, and Ren Ng. 2020. NeRF: Representing Scenes as Neural Radiance Fields for View Synthesis. In ECCV.
Simon Niklaus and Feng Liu. 2020. Softmax splatting for video frame interpolation. In CVPR. 5437-5446.
Luigi Piccinelli, Yung-Hsu Yang, Christos Sakaridis, Mattia Segu, Siyuan Li, Luc Van Gool, and Fisher Yu. 2024. UniDepth: Universal Monocular Metric Depth Estimation. In CVPR. 10106-10116.
Chris Rockwell, David F Fouhey, and Justin Johnson. 2021. Pixelsynth: Generating a 3d-consistent experience from a single image. In ICCV. 14104-14113.
Robin Rombach, Andreas Blattmann, Dominik Lorenz, Patrick Esser, and Bjorn Ommer. 2022. High-resolution image synthesis with latent diffusion models. In CVPR. 10684-10695.
Robin Rombach, Patrick Esser, and Bjorn Ommer. 2021. Geometry-free view synthesis: Transformers and no 3d priors. In ICCV. 14356-14366.
Kyle Sargent, Zizhang Li, Tanmay Shah, Charles Herrmann, Hong-Xing Yu, Yunzhi Zhang, Eric Ryan Chan, Dmitry Lagun, Li Fei-Fei, Deqing Sun, et al. 2024. ZeroNVS: Zero-Shot 360-Degree View Synthesis from a Single Image. In CVPR. 9420-9429.
Junyoung Seo, Kazumi Fukuda, Takashi Shibuya, Takuya Narihira, Naoki Murata, Shoukang Hu, Chieh-Hsin Lai, Seungryong Kim, and Yuki Mitsufuji. 2024. GenWarp: Single Image to Novel Views with Semantic-Preserving Generative Warping. In NeurIPS.
Meng-Li Shih, Shih-Yang Su, Johannes Kopf, and Jia-Bin Huang. 2020. 3d photography using context-aware layered depth inpainting. In CVPR. 8028-8038.
Jiaming Song, Chenlin Meng, and Stefano Ermon. 2021. Denoising diffusion implicit models. In ICLR.
Stanislaw Szymanowicz, Eldar Insafutdinov, Chuanxia Zheng, Dylan Campbell, Joio F Henriques, Christian Rupprecht, and Andrea Vedaldi. 2024a. Flash3D: Feed-Forward Generalisable 3D Scene Reconstruction from a Single Image. arXiv preprint arXiv:2406.04343 (2024).
Stanislaw Szymanowicz, Chrisitian Rupprecht, and Andrea Vedaldi. 2024b. Splatter image: Ultra-fast single-view 3d reconstruction. In CVPR. 10208-10217.
Richard Tucker and Noah Snavely. 2020. Single-view view synthesis with multiplane images. In CVPR. 551-560.
Olivia Wiles, Georgia Gkioxari, Richard Szeliski, and Justin Johnson. 2020. Synsin: End-to-end view synthesis from a single image. In CVPR. 7467-7477.
Felix Wimbauer, Nan Yang, Christian Rupprecht, and Daniel Cremers. 2023. Behind the scenes: Density fields for single view reconstruction. In CVPR. 9076-9086.
Rundi Wu, Ben Mildenhall, Philipp Henzler, Keunhong Park, Ruiqi Gao, Daniel Watson, Pratul P Srinivasan, Dor Verbin, Jonathan T Barron, Ben Poole, et al. 2024. Reconfusion: 3d reconstruction with diffusion priors. In CVPR. 21551-21561.
Jinbo Xing, Menghan Xia, Yong Zhang, Haoxin Chen, Wangbo Yu, Hanyuan Liu, Gongye Liu, Xintao Wang, Ying Shan, and Tien-Tsin Wong. 2025. Dynamicrafter: Animating open-domain images with video diffusion priors. In ECCV. Springer, 399-417.
Haofei Xu, Songyou Peng, Fangjinhua Wang, Hermann Blum, Daniel Barath, Andreas Geiger, and Marc Pollefeys. 2024. Depthsplat: Connecting gaussian splatting and depth. arXiv preprint arXiv:2410.13862 (2024).
Haofei Xu, Jing Zhang, Jianfei Cai, Hamid Rezatofighi, Fisher Yu, Dacheng Tao, and Andreas Geiger. 2023. Unifying flow, stereo and depth estimation. IEEE TPAMI (2023).
Alex Yu, Vickie Ye, Matthew Tancik, and Angjoo Kanazawa. 2021. pixelnerf: Neural radiance fields from one or few images. In CVPR. 4578-4587.
Wangbo Yu, Jinbo Xing, Li Yuan, Wenbo Hu, Xiaoyu Li, Zhipeng Huang, Xiangjun Gao, Tien-Tsin Wong, Ying Shan, and Yonghong Tian. 2024. Viewcrafter: Taming video diffusion models for high-fidelity novel view synthesis. arXiv preprint arXiv:2409.02048 (2024).
Chuanrui Zhang, Yingshuang Zou, Zhuoling Li, Minmin Yi, and Haoqian Wang. 2025. Transplat: Generalizable 3d gaussian splatting from sparse multi-view images with transformers. In AAAI.
Richard Zhang, Phillip Isola, Alexei A Efros, Eli Shechtman, and Oliver Wang. 2018. The unreasonable effectiveness of deep features as a perceptual metric. In CVPR. 586-595.
Xiang Zhang, Bingxin Ke, Hayko Riemenschneider, Nando Metzger, Anton Obukhov, Markus Gross, Konrad Schindler, and Christopher Schroers. 2024. Betterdepth: Plug-and-play diffusion refiner for zero-shot monocular depth estimation. In NeurIPS.
Sijie Zhao, Wenbo Hu, Xiaodong Cun, Yong Zhang, Xiaoyu Li, Zhe Kong, Xiangjun Gao, Muyao Niu, and Ying Shan. 2024. Stereocrafter: Diffusion-based generation of long and high-fidelity stereoscopic 3d from monocular videos. arXiv preprint arXiv:2409.07447 (2024).
Chuanxia Zheng and Andrea Vedaldi. 2024. Free3d: Consistent novel view synthesis without 3d representation. In CVPR. 9720-9731.
Tinghui Zhou, Richard Tucker, John Flynn, Graham Fyffe, and Noah Snavely. 2018. Stereo magnification: learning view synthesis using multiplane images. ACM Trans. Graph. 37, 4, Article 65 (July 2018), 12 pages. https://doi.org/10.1145/3197517.3201323

What is claimed is:

1. A method for generating a novel view image corresponding to an input view image using a machine learning model comprising a pre-trained diffusion model comprising one or more diffusion model layers including an input diffusion model layer, and a conditional model comprising one or more conditional model layers, the method performed by a computer system and comprising:
generating, based on the input view image, a depth map;
warping the input view image based on the depth map, thereby generating a warped image and a disocclusion mask;
masking the warped image using the disocclusion mask, thereby generating a warped and masked image;
generating a noisy embedding;
encoding the warped and masked image, thereby generating a warped and masked embedding;
encoding the depth map, thereby generating a depth map embedding;
encoding the disocclusion mask, thereby generating a disocclusion mask embedding;
combining the noisy embedding, the warped and masked embedding, the depth map embedding, and the disocclusion mask embedding, thereby generating a combined embedding;
applying the combined embedding to the conditional model, thereby generating one or more conditional model layer outputs corresponding to the one or more conditional model layers;
applying the noisy embedding to the input diffusion model layer and the one or more conditional model layer outputs to the one or more diffusion model layers, thereby generating an output embedding; and
decoding the output embedding, thereby generating the novel view image.

2. The method of claim 1, wherein encoding the depth map, thereby generating the depth map embedding comprises:
warping the depth map, thereby generating a warped depth map; and
encoding the warped depth map, thereby generating the depth map embedding.

3. The method of claim 1, wherein:
the computer system encodes the warped and masked image using a variational autoencoder encoder;
the computer system encodes the depth map using a convolutional encoder comprising a convolution layer, a rectified linear unit layer, and a max pooling layer;
the computer system encodes the disocclusion mask using the convolutional encoder; and
the computer system decodes the output embedding using a variational autoencoder decoder.

4. The method of claim 1, wherein generating the output embedding further comprises applying a text embedding to the one or more diffusion model layers in addition to the one or more conditional model layer outputs.

5. The method of claim 1, wherein the one or more conditional model layer outputs are applied to the one or more diffusion model layers via one or more zero-convolution adaptors.

6. The method of claim 1, wherein the pre-trained diffusion model is defined by a set of pre-trained diffusion model parameters, wherein the conditional model is defined by a set of conditional model parameters, and wherein the method further comprises, prior to generating the depth map:
initially setting the set of conditional model parameters equal to the set of pre-trained diffusion model parameters; and
training the conditional model by iteratively updating the set of conditional model parameters based on a training dataset.

7. The method of claim 1, wherein the input view image comprises an image frame in an input view video, wherein the input view video comprises one or more additional image frames, wherein the novel view image comprises a novel view image frame in a novel view video, and wherein the method further comprises:
generating, based on the one or more additional image frames, one or more additional depth maps;
warping the one or more additional image frames based on the one or more additional depth maps, thereby generating one or more additional warped images and one or more additional disocclusion masks;
masking each additional warped image using a corresponding disocclusion mask, thereby generating one or more additional warped and masked images;
generating one or more additional noisy embeddings;
encoding the one or more additional disocclusion masks, thereby generating one or more additional disocclusion mask embeddings;
combining each additional noisy embedding with a corresponding additional warped and masked embedding, a corresponding additional disocclusion mask embedding, and a corresponding depth map embedding, thereby generating one or more additional combined embeddings;
applying the one or more additional combined embeddings to the conditional model, thereby generating one or more sets of additional conditional model layer outputs corresponding to the one or more conditional model layers;
applying the one or more additional noisy embeddings to the input diffusion model layer and the one or more sets of additional conditional model layer outputs to the one or more diffusion model layers, thereby generating one or more additional output embeddings;
decoding the one or more additional output embeddings, thereby generating one or more additional novel view image frames; and
generating the novel view video by combining the novel view image frame and the one or more additional novel view image frames.

8. The method of claim 1, wherein the depth map comprises a disparity map comprising a plurality of disparity values corresponding to a plurality of pixels in the input view image, and wherein generating the depth map comprises:
generating, based on the input view image, an initial depth map using a monocular depth estimation process, wherein the initial depth map comprises a plurality of depth values corresponding to the plurality of pixels in the input view image; and
inverting each depth value of the plurality of depth values based on a first disparity parameter and a second disparity parameter, thereby generating the plurality of disparity values.

9. The method of claim 8, wherein warping the input view image based on the depth map comprises:
for each pixel of the plurality of pixels in the input view image, determining a warped pixel coordinate in the warped image based on a corresponding disparity value in the disparity map, thereby determining a plurality of warped pixel coordinates;
determining one or more warped pixel coordinates that do not correspond to the plurality of pixels in the input view image, wherein the one or more warped pixel coordinates that do not correspond to the plurality of pixels in the input view image comprise the disocclusion mask; and
for each warped pixel coordinate, assigning a pixel in the input view image with a highest corresponding disparity value from one or more pixels in the input view image corresponding to that warped pixel coordinate to the warped image at that warped pixel coordinate, thereby generating the warped image.

10. A method for generating a novel view video corresponding to an input view video comprising a plurality of image frames using a mapping machine learning model and an inpainting machine learning model, the method performed by a computer system and comprising:
warping each image frame of the plurality of image frames, thereby generating a plurality of warped image frames and a plurality of disocclusion masks corresponding to the plurality of warped image frames;
training the mapping machine learning model to map pixels from the plurality of warped image frames to a texture map, thereby generating the texture map;
generating a cumulative disocclusion mask using the plurality of disocclusion masks and the mapping machine learning model;
combining the cumulative disocclusion mask and the texture map, thereby generating a masked texture map;
generating an unmasked texture map by inpainting the masked texture map using the inpainting machine learning model; and
generating the novel view video based on the unmasked texture map.

11. The method of claim 10, further comprising prior to training the mapping machine learning model:
performing framewise inpainting on the plurality of warped image frames using a framewise inpainting model.

12. The method of claim 10, wherein warping each image frame of the plurality of image frames comprises, for each image frame:
generating a depth map based on the image frame; and
warping the image frame based on the depth map, thereby generating a corresponding warped image frame and a corresponding disocclusion mask, thereby generating the plurality of warped image frames and the plurality of disocclusion masks.

13. The method of claim 10, wherein the inpainting machine learning model comprises a diffusion model, and wherein inpainting the masked texture map comprises:
generating a noisy embedding;
encoding the masked texture map, thereby generating a masked texture map embedding;
combining the noisy embedding and the masked texture map embedding, thereby generating a combined embedding;
applying the combined embedding to the inpainting machine learning model, thereby generating an output embedding; and
decoding the output embedding, thereby generating the unmasked texture map.

14. The method of claim 10, wherein:
the texture map comprises a foreground texture map corresponding to objects in a foreground of the input view video and a background texture map corresponding to objects in a background of the input view video;
the unmasked texture map comprises an unmasked foreground texture map and an unmasked background texture map;
the mapping machine learning model comprises a foreground coordinate model, a background coordinate model, an alpha model, and a color model;
the foreground texture map is generated using the foreground coordinate model and the color model; and
the background texture map is generated using the background coordinate model and the color model.

15. The method of claim 14, wherein the foreground coordinate model comprises a foreground neural network, the background coordinate model comprises a background neural network, the alpha model comprises an alpha neural network, and the color model comprises a color neural network.

16. The method of claim 14, wherein generating the novel view video based on the unmasked texture map comprises, for each pixel in each image frame in the plurality of image frames:
determining an x-coordinate, a y-coordinate, and a frame number corresponding to the pixel;
determining a foreground texture map coordinate based on the x-coordinate, the y-coordinate, and the frame number using the foreground coordinate model;
determining a background texture map coordinate based on the x-coordinate, the y-coordinate, and the frame number using the background coordinate model;
determining an alpha value based on the x-coordinate, the y-coordinate, and the frame number using the alpha model;
determining a foreground texture map pixel in the unmasked foreground texture map based on the foreground texture map coordinate;
determining a background texture map pixel in the unmasked background texture map based on the background texture map coordinate; and
combining the foreground texture map pixel and the background texture map pixel based on the alpha value, thereby generating a novel view pixel, thereby generating a novel view image frame comprising a plurality of novel view pixels, thereby generating a plurality of novel view image frames, wherein the novel view video comprises the plurality of novel view image frames.

17. The method of claim 14, wherein training the mapping machine learning model comprises training the foreground coordinate model, the background coordinate model, the alpha model, and the color model in a concurrent self-supervised training process based on a combined loss function, wherein the combined loss function comprises a combination of one or more of the following:
a color loss function;
a local rigidity loss function;
an optical flow loss function;
a sparsity loss function;
an alpha loss function;
a global rigidity loss function; and
a foreground loss function.

18. The method of claim 14, wherein each disocclusion mask comprises a plurality of disocclusion mask tuples, wherein each disocclusion mask tuple comprises an x-coordinate, a y-coordinate, and a frame number, and wherein generating the cumulative disocclusion mask comprises:
for each disocclusion mask tuple in each disocclusion mask, determining, using the background coordinate model, a disocclusion background texture map coordinate based on a corresponding x-coordinate, a corresponding y-coordinate, and a corresponding frame number, thereby determining a plurality of disocclusion background texture map coordinates; and
generating the cumulative disocclusion mask based on the plurality of disocclusion background texture map coordinates.

19. The method of claim 18, wherein generating the cumulative disocclusion mask based on the plurality of disocclusion background texture map coordinates comprises:
for each disocclusion background texture map coordinate, determining whether a fraction of (a) disocclusion mask tuples mapped to that disocclusion background texture map coordinate and (b) pixels from a plurality of pixels mapped to a corresponding background texture map coordinate by the mapping machine learning model exceeds a threshold fraction, thereby identifying one or more disocclusion texture map coordinates, wherein the cumulative disocclusion mask comprises the one or more disocclusion texture map coordinates.

20. A computer system comprising:
one or more processors; and
a non-transitory computer readable medium coupled to the one or more processors, the non-transitory computer readable medium comprising instructions that, when executed by the one or more processors, cause the one or more processors to perform a method for generating a novel view image corresponding to an input view image using a machine learning model comprising a pretrained diffusion model comprising one or more diffusion model layers including an input diffusion model layer, and a conditional model comprising one or more conditional model layers, the method comprising:
generating, based on the input view image, a depth map;
warping the input view image based on the depth map, thereby generating a warped images and a disocclusion mask;
masking the warped image using the disocclusion mask, thereby generating a warped and masked image;
generating a noisy embedding;
encoding the warped and masked image, thereby generating a warped and masked embedding;
encoding the depth map, thereby generating a depth map embedding;
encoding the disocclusion mask, thereby generating a disocclusion mask embedding;
combining the noisy embedding, the warped and masked embedding, the depth map embedding, and the disocclusion mask embedding, thereby generating a combined embedding;
applying the combined embedding to the conditional model, thereby generating one or more conditional model layer outputs corresponding to the one or more conditional model layers;
applying the noisy embedding to the input diffusion model layer and the one or more conditional model layer outputs to the one or more diffusion model layers, thereby generating an output embedding; and
decoding the output embedding, thereby generating the novel view image.
